(19) United States
(12) Patent Application Publication
(10) Pub. No.: US 2026/0197179 A1
(43) Pub. Date: Jul. 9, 2026

(54) FULL-FLEDGED SMART CONTRACTS FOR UTXO BASED BLOCKCHAINS

(71) Applicant: Stanislav TROCK, Givat Shmuel (IL)

(72) Inventor: Stanislav TROCK, Givat Shmuel (IL)

(21) Appl. No.: 19/133,725

(22) PCT Filed: Nov. 29, 2023
(86) PCT No.: PCT/IB2023/062026

§ 371 Date: May 29, 2025

Related U.S. Application Data
(60) Provisional application No. 63/428,426, filed on Nov. 29, 2022.

(51) Int. Cl. H04L 9/32; H04L 9/00

(52) U.S. Cl. CPC H04L 9/3239; H04L 9/3218; H04L 9/3252; H04L 9/50; H04L 2209/56

(57) ABSTRACT

There is described a method of implementing a full-fledged smart contact on unspent transaction output, UTXO, based blockchains, the method relying on a combination of mathematical induction with Succinct Non-interactive Argument of Knowledge, SNARK, and/or Scalable Transparent Argument of Knowledge, STARK, technology.

### FIELD OF INVENTION

The present invention relates to a method, in particular a computer-implemented method, of providing full-fledges smart contracts on a UTXO Based Blockchain.

### BACKGROUND

Satoshi Nakamoto is the pseudonymous creator of Bitcoin, the creator of the original UTXO-based model of Bitcoin or simply UTXO blockchain of Bitcoin. The following are quotations of his statements from the early days of his creation:

On Apr. 12, 2009 at 10:44 PM (a letter to Mike Hearn):
“The existing Visa credit card network processes about 15 million Internet purchases per day worldwide. Bitcoin can already scale much larger than that with existing hardware for a fraction of the cost. It never really hits a scale ceiling.”

On 2010 Jun. 17 18:46:08 UTC, on https://bitcointalk.org/:
(https://bitcointalk.org/index.php?topic=195.msq1611 #msg1611)

“The nature of Bitcoin is such that once version 0.1 was released, the core design was set in stone for the rest of its lifetime. Because of that, I wanted to design it to support every possible transaction type I could think of. The problem was, each thing required special support code and data fields whether it was used or not, and only covered one special case at a time. It would have been an explosion of special cases. The solution was script, which generalizes the problem so transacting parties can describe their transaction as a predicate that the node network evaluates. The nodes only need to understand the transaction to the extent of evaluating whether the sender's conditions are met. The script is actually a predicate. It's just an equation that evaluates to true or false. Predicate is a long and unfamiliar word so I called it script.

The receiver of a payment does a template match on the script. Currently, receivers only accept two templates: direct payment and Bitcoin address. Future versions can add templates for more transaction types and nodes running that version or higher will be able to receive them. All versions of nodes in the network can verify and process any new transactions into blocks, even though they may not know how to read them.

The design supports a tremendous variety of possible transaction types that I designed years ago. Escrow transactions, bonded contracts, third party arbitration, multi-party signature, etc. If Bitcoin catches on in a big way, these are things we'll want to explore in the future, but they all had to be designed at the beginning to make sure they would be possible later.

I don't believe a second, compatible implementation of Bitcoin will ever be a good idea. So much of the design depends on all nodes getting exactly identical results in lockstep that a second implementation would be a menace to the network. The MIT license is compatible with all other licenses and commercial uses, so there is no need to rewrite it from a licensing standpoint.”

It is clear from the above excerpts that the original design of Satoshi's UTXO-based model of Bitcoin or simply UTXO blockchain of Bitcoin has the following pillars:
1. It was designed to be scalable as much as needed.
2. It must have set in stone core design aka base-protocol (we be called just the protocol), namely no redesign should take place in the future.
3. To whatever extent Satoshi could think of, he implemented in the original Bitcoin core design a support for “smart” transactions.
4. Any future invented/implemented “smart” transactions should not affect the original set-in-stone core design (the protocol) and must be implemented on it natively, namely they should be created according to original set of rules (without interruption in and violation of the initial base-protocol aka core-design), all in appliance with what was determined and assigned by Satoshi in original Bitcoin 0.1 version release.

The following shrewd publications of ZeMing M. Gao elaborate in-depth the meaning and importance of: “locked” (set-in-stone) protocol/core-design of original Bitcoin model and its economic and legal impacts, read:

“The Locked Protocol” (https://zemgao.com/the-locked-protocol) and “Most cryptos are securities according to the Howey test” (https://www.linkedin.com/pulse/pow-pos-howey-test-zeming-m-gao)

It makes obvious the fact that, immutable core design doesn't mean avoiding any miner node software upgrades, as upgrades that e.g. fix bugs or purely technically contribute to scaling etc. do not affect any of algorithmic, economic and legal aspect of original protocol aka original core design.

As each transaction may consist of multiple outputs, each holding/carrying its locking script. The logic implemented in those scripts is what dictates the conditions for spending their corresponding transaction outputs, making the scripts a contracts for spending. Sometimes these contracts are casually defined as a “smart” contracts to highlight that the logic they “carry” is to-some-degree complex.

In reality the original range of functionally of smart transactions (smart-contracts) on Bitcoin was quite limited. On that premise alternative system emerged providing full-fledged smart-contracts functionality-Ethereum.

“The biggest structural and elemental difference between Bitcoin and Ethereum is that the former uses Unspent Transaction Output (UTXO) while the latter uses an account-based model.

UTXO is like cash, in that every bill or coin is independent from each other. As long as a dollar bill itself is authentic, the validity of a transfer is absolute and not contingent upon a separate accounting.

In contrast, account-based system is like bank credit money. Parties recognize the nominal validity of the credit, but a transaction is not settled until all accounts in the system have been reconciled.” (https://zemgao.com/more-proof-that-utxo-is-superior-to-account-based-systems/)

“Counterintuitively, people tend to think that the bank account system is a more modern and advanced one compared to the cash system which may be convenient on the spot but is incompatible with the modem digital systems. But that is precisely one of the reasons why the invention of Bitcoin as “electronic peer-to-peer cash system” is such a big deal. Bitcoin is cash, but also electronicat the same time. It is cash because the design of Bitcoin, especially the prevention of double-spend, confers a unique “physicality” to Bitcoin so that it is close to traditional cash bearer instrument; but at the same time it is electronic, and therefore potentially enjoys all the powers of the modern digital technologies. The combining of the best features of two different worlds-physical and digital-makes Bitcoin uniquely powerful” (https://zemgao.com/more-proof-that-utxo-is-superior-to-account-based-systems/)

The following article succinctly but accurately elaborates the main trade-off between these two models:
https://word.site/2019/11/20/utxo-vs-global-state/In other words, Ethereum choice of its structural and elemental model allowed it to create what was (at that time) to-some-extent “missing” in Bitcoin, namely-full-fledged smart-contracts, but it came at a cost-lack of true native scalability, while Bitcoin UTXO model is being maximally scalable by design.

Despite the assertion of Satoshi Nakamoto on immutability of original core design/protocol, namely an obligatoriness of it being set-in-stone, not all UTXO-based blockchains existing today follow this assertion. Specifically, policies of someof the blockchains allow protocol modifications, each to its degree of deviation from the original rules/design.

Some of these blockchains have a common original ancestor blockchain (usually it is the original Bitcoin blockchain launched by Satoshi himself at 2009) which got split/forked at some stage; others created completely afresh (from the very first block) new UTXO blockchains with modifications and/or completely new features in them.

We can very-roughly divide the whole range of all possible (existing currently or potentially in the future) UTXO blockchains into the following categories (from strict to loose policy):
1. UTXO blockchain/s that follow original core design/protocol.
2. UTXO blockchain/s that follow original core design/protocol, but allow only optimizations, e.g. packing script-code of multiple opcodes (aka functions, commands) into single/several newly defined opcode/s, that is in order to save time/space.
3. UTXO blockchain/s that intend or may potentially intend having set-in-stone protocol, but upon creation/launch of their new UTXO blockchains introduce single or several modifications and/or completely new features in relation to original Satoshi's blockchain.
4. UTXO blockchain/s that have policy which is totally indifferent to introducing any desired number of modifications/new-features, namely dynamically changing protocol over time.

Quoting the publication “Most cryptos are securities according to the Howey test” (https://www.linkedin.com/pulse/pow-pos-howey-test-zeming-m-gao) of ZeMing M. Gao: “A vast majority of crypto assets (coins or tokens) are securities, and illegal ones at that, as they meet the Howey test and have not been issued/distributed in compliance with the securities law. The only exception is one that satisfies both the following two conditions: (1) is based on genuine Proof-of-Work (PoW); and (2) has a locked base protocol according to the law”.

In other words, introduction of modifications and new features to already functioning base protocol potentially compromises it from legal perspective. The meaning of a ‘locked protocol’ is thoroughly scrutinized in another ZeMing M. Gao publication “The Locked Protocol”.

Moreover, original protocol aka original core design of Satoshi's UTXO model is highly subtly balanced algorithmically and economically. Moreover, its security and reliability is tested over period of time of its functioning. Thus even the categories of UTXO blockchains that allow introduction of protocol changes (categories (3) and (4)) do it with highest caution and as minimal as possible, since any modification of the protocol may potentially (in a short or long term) have a negative impact on any of its technical and/or economic (and/or legal) aspects, putting at risk assets and liabilities of its users or even the whole project.

The vivid example is the case of UTXO blockchain called Zcash that was launched in 2016 and introduced a new feature of private ownership and transfer of data. The blockchain was designed in a way that the details of some transactions to be seen only by the transaction participants:

“On Mar. 1, 2018, an employee of the Zcash Company discovered a critical bug which could have allowed an attacker to create an infinite amount of counterfeit Zcash. The employee shared this discovery with three other employees, including CEO Zooko Wilcox. On Oct. 28, 2018, the fix for this issue was covertly included in the Sapling network upgrade to the Zcash network.” (https://en.wikipedia.org/wiki/Zcash).

“The vulnerability had existed for years, but was undiscovered by numerous expert cryptographers, scientists, third-party auditors, and third-party engineering teams who initiated new projects based upon the Zcash code.” See the full description https://electriccoin.co/blog/zcash-counterfeiting-vulnerability-successfully-remediated/.

This vulnerability potentially could have compromised the whole project. Moreover, even though the vulnerability was patched, the company felt that an overarching solution is essential because Zcash's robust privacy protection features make it difficult for anyone to detect counterfeiting directly (https://www.cryptonewsz.com/zcash-to-enforce-turnstile-effect-against-counterfeiting/). Therefore in update (called Sapling) that included vulnerability fix/patch, users were required to go through a process of turnstiling. Specifically, users were required to send funds held in old (Sprout) shielded addresses to transparent addresses before sending to new (Sapling) shielded addresses. There was no way to send ZEC directly between old and new shielded addresses, see https://electriccoin.co/blog/sapling-addresses-turnstile-migration/.

Later, a professional analysis conclusion for the project was:

“On May 19, 2020, a paper titled “Alt-Coin Traceability” investigated the privacy of both Zcash and Monero. This paper concluded that “more academic research is needed in Zcash overall” and that the privacy guarantees of Zcash are “questionable”. The paper claimed that since the current heuristics from a 2018 Usenix Security Symposium paper entitled “An Empirical Analysis of Anonymity in Zcash” still continue today that the result is making Zcash less anonymous and more traceable.” (https://en.wikipedia.org/wiki/Zcash).

Ultimately, all the above blockchain categories, except for (1), at the moment of modifications of the protocol of underlying UTXO blockchain are prone to destabilizing/disrupting businesses building their projects over them. Even the second (2) category which may arguably be not considered as a protocol-modifying for strictly allowing only optimizations rather than core design change—may still potentially risk existing businesses which count on underlying blockchain software stability.

As a simplest example, consider a business building hardware ASICs for expediting executions of specific set of commands/opcodes that “caught on in a big way” and became widely used by the whole ecosystem, clearly even in the case of category (2) UTXO blockchain the optimization of packing multiple opcodes into single/several one/s would instantly annihilate such a project.

In analogy to internet that functions over locked TCP/IP protocols-were the TCP/IP modifiable, it would disrupt numerous projects being built over it.

### Definition of Nativeness

In the light of everything elaborated above, the perfect fit for smart contracts realization for all of the above categories of UTXO blockchains (including those that do not follow a policy of set-in-stone core design) is one, which requires no modification of and has no effect at all on underlying base protocol, that is-is implemented on UTXO blockchain natively, namely—the smart contracts should be created according to original set of rules (without interruption in and violation of the initial base-protocol aka core-design), all in appliance with what is determined and assigned by UTXO blockchain creators, e.g. Satoshi Nakamoto in case of original Bitcoin 0.1 version release. Conclusion 1.

That is for the following multiple apparent reasons:
1) It is requiring literally zero effort and/or work for its integration, as method's realization is detached from realization of underlying UTXO blockchain itself and has no effect on its software. In other words, from underlying blockchain perspective there is no integration process at all.
2) Native realization of smart contract has no effect on underlying base protocol, thus the protocol may remain to be locked, by that avoiding appearance of risk of a possibility of meeting Howey test, to be classified as a security (https://www.cryptonewsz.com/zcash-to-enforce-turnstile-effect-against-counterfeiting/).
3) No risk of compromising the project and users assets by introducing modifications and new features, which potentially interfere with time-tested known subtle algorithmic and economic balance of the UTXO models.
4) No risk of disruption/destabilization of businesses building their projects on UTXO blockchains of all of the above categories (following any base protocol modification policy).
5) Independency of the underlying UTXO blockchain functionality from specific algorithm (particularly: SNARK/STARK-“Succinct Non-interactive ARgument of Knowledge”/“Scalable Transparent ARgument of Knowledge”) and/or implementation of smart contract.

For example, If in future SNARK/STRAK algorithm with better performance is discovered and its integration would be advantageous over current one, then changing the algorithm has no effect on underlying UTXO blockchain, namely no process similar to turnstiling must take place (e.g. as happened in Zcash, when they had to change one SNARK system to another) for users in order to make corresponding upgrade, since the new solution is just an assignment of different verification code and parameters (working on/with new SNARK/STARK algorithm) into locking/unlocking scripts of transactions fields.

The method disclosed in this document-is disclosing native-full-fledged (NFF) smart contracts realization, which doesn't require any base-protocol/core-design changes, and therefore suites all the four of above categories of UTXO blockchains, namely (categories of policies of protocol modification and introduction of new features to it). In addition to that, importantly, for a method to be rightfully defined as full-fledged it must be ‘practically feasible’ namely, having a workable size of scripts (and their related parameters) carried by transactions of the blockchains (on-chain scripts and parameters), as well as workable time of their creation and execution (broader definition of ‘practically feasible’ will be given below).

Otherwise stated, the proposed NFF smart-contracts creation method unfolds the holy grail of what has been sought-after by quite a few industries for quite some time—the combination of smart contracts functionality, which is (1) native and (2) full-fledged, with (3) maximal possible scalability (provided by UTXO model by design), and importantly (4) which is-practically implementable/feasible.

For the vast majority of existing UTXO blockchains and specifically for all UTXO blockchains that were originated, forked or split from the very first Bitcoin blockchain, which was launched in 2009—native smart contracts creation means-according to original set of rules and in appliance with what was determined by Satoshi Nakamoto in Bitcoin 0.1 version Bitcoin release.

Which means—the realization of smart contracts must be achieved through Bitcoin-script (sometime called just-script), the feature designated by Satoshi precisely for that purpose (creation of smart contracts/transactions on Bitcoin).

Bitcoin uses a scripting system for transactions. Being a derivative of Forth (https://en.wikipedia.org/wiki/FORTH) programming language, Bitcoin script is just a mini programming language used in Bitcoin to provide the locking mechanism for outputs. It is simple, stack-based, and processed from left to right as a series of sequential instructions. Data is pushed onto the stack and opcodes (commands/functions) are used to perform operations on the items on the stack.
Every transaction output is given a “locking script”.
Then every transaction that spends existing output provides an “unlocking script” in one of its inputs, through which that output is being spent.

When a node (a miner) receives the spending transaction, it will combine both of these scripts together and run them. If a ‘TRUE’ is left on the top of the stack after the script execution is completed, then the script is valid and the output can be spent. While ‘TRUE’ is anything other than zero, negative zero (using any number of bytes) or an empty array.

Note, the naming is often confusing here, as both locking and unlocking scripts are written with Bitcoin script language, which in turn is often also called just a “script”).

The following definitions may be used for the terms disclosed herein, see FIG. 1:
UTXO—an Unspent Transaction (TX) Output: transaction output holding a locking script and zero or more of its native tokens (e.g. satoshis in case of Bitcoin), where the UTXO must be unlocked in order to be spent and in order to spend the tokens (if any exist) associated with this UTXO. The locking script of the output of the UTXO dictates conditions for the tokens of the output to be spent. The code inside a UTXO is executed only once, when it is spent.
COIN—an Unspent Transaction (TX) Output: transaction output holding a non-zero amount of its native tokens and a locking script, where the UTXO must be unlocked in order to spend the native tokens associated with this UTXO. The locking script of the output of the UTXO dictates conditions for the tokens of the output to be spent. The code inside a coin is executed only once, when it is spent.
Smart Contract (SC)—a UTXO/coin is locked based on a locking script, which locking script comprises a smart contract. The locking script of UTXO/coin, at the time of an attempt to spend the UTXO, is executed during validation/evaluation of a transaction. The execution occurs for each of a transaction's inputs independently, which inputs spend the outputs of previous transaction/s with locking scripts (which locking script is being executed). Unlocking scripts, placed in each of the inputs, usually only pass necessary for the execution parameters for those locking script executions. Note, for some modified UXTO-based blockchain models, the script being executed may partially constitute part of unlocking script spending that UTXO (as in e.g. P2SH of BTC modified UTXO blockchain model (https://github.com/bitcoin/bips/blob/master/bip-0016.mediawiki).
ON-COIN SC—smart contract (SC) validation of which is done only by miners, namely not requiring any other than regular validation functionality of miners for spending of UTXOs on blockchain.
ON-CHAIN SC—smart contract validation of which is done by miners, but may require additional validation based on some data from the UTXO blockchain only, e.g. checking transactions history backtrail to some specific past genesis transaction over blockchain DAG. On-chain differs from on-coin only by optionally allowing additional validation based on data extracted entirely from blockchain, meaning no third party data is involved in transaction validation, only data from the blockchain.
L2 or Non-on-chain smart contracts—are smart contracts that run on layer 2 solutions, namely overlaid to blockchain (being layer 1 in that sense). L2 smart contracts enable the execution of complex logic on layer 2 solutions, while ‘pecking’ the blockchain with some time-stamped proof (e.g. a hash digest) serving for validation and coordination of these contracts executions on layer 2-outside of blockchain.
OFF-CHAIN execution—execution of a software program that takes place outside of blockchain, in current context, the goal is to verify on-coin correctness of such an off-chain execution.

For smart contracts to be native, they typically are of an on-coin nature.

### SUMMARY OF THE DISCLOSURE

Aspects and embodiments of the present invention are set out in the appended claims. These and other aspects and embodiments of the invention are also described herein.

### BRIEF DESCRIPTION OF THE DRAWINGS

FIG. 1 illustrates the meanings of certain terms used in this disclosure.

FIG. 2 shows the evolution of smart-contracts on UTXO-based blockchains.

FIG. 3 shows a sequence of transactions.

FIG. 4 shows the internal fields of a general Bitcoin transaction, used in UTXO-based blockchains.

FIG. 5 shows a simplified specific structure of a single input and single output transaction of a transaction such as that of FIG. 4.

FIG. 6 shows another sequence of transactions.

FIG. 7 shows another sequence of transactions (associated with a 4 witness implementation).

FIG. 8 shows another sequence of transactions (associated with a 5 witness implementation).

FIG. 9 shows a typical structure of sequential smart contract.

FIG. 10 shows a train of non-persistent sequential transactions.

FIG. 11 shows an interaction between distinct smart contracts—an atomic swap.

### DETAILED DESCRIPTION OF THE EMBODIMENTS

### Introduction

With a blockchain based on Unspent Transaction Output (UTXO), the verification is normally done within execution of a smart-contract script of UTXO (at the time of an attempt to spend the UTXO), whereas parameters necessary for the execution are passed in unlocking script residing in specific corresponding input of transaction spending that UTXO. However note, the script being executed may reside inside UTXO itself or, for some modified UXTO-based models, it may partially constitute part of unlocking script spending that UTXO (as in e.g. P2SH of BTC modified UTXO model). To avoid unnecessary text repetitions, we will refer during this disclosure to the original version, in which the executed script resides fully in UTXO itself, but the method is equally valid for models assigning partially the executed script into unlocking script of spending transaction's input.

For the UTXO-based original model to have full-fledged smart-contracts, this model may have 1) a capability of an interaction between the UTXOs (carrying those contracts) in a form of exerting on each other enforcement of conditions and rules of spending of those UTXOs (which requires successful execution of the UTXOs' locking scripts constituting the smart contracts), and moreover 2) the interaction should typically not be limited to be only among UTXOs, but rather also have an ability to be based on any data substituting past transactions fromthat UTXO blockchain (from now and on just-a blockchain) history as well as based on ability dictate the scripts/logic and data of future transactions.

Alternatively stating, while UTXO blockchain forms Direct-Acyclic-Graph (from now and on called-DAG), for full-fledged smart-contracts this interaction must be possible in forward, backward and sideways directions on the blockchain, whereas in this context the following definitions may be used:
Forward—means for successful spending of existing UTXOs, having an ability of dictating conditions to be met (and rules enforced) on a fields of current spending transaction (e.g, particularly its newly created outputs) and/or other transactions following it in the future through any possible continuous future path/s of the blockchain DAG.
Backward—means for successful spending of existing UTXOs, requiring conditions to be met (and rules enforced) in past transactions of blockchain's history, which includes the transaction that created the current UTXO (being spent) and/or other past transactions preceding such a transaction (that created UTXO being spent) through any continuous path/s of the blockchain DAG.
Sideward—means for successful spending of existing UTXOs, requiring conditions to be met (and rules enforced) in blockchain history of a past transaction/s, which is/are the transaction/s that created the UTXOs that are being spent through any input/s of current transaction, but which is/are other than the current input (in context of which the script execution occurs).

Moreover, smart contracts implemented on a blockchain often need on-chain verification of various types of consistency.

Such a consistency in many cases is a requirement/enforcement of rules and conditions only for a singleton interaction (single transaction or part of it, occurring only in its single specific input context) and is totally unrelated to other interactions, which could: (1) happen in the past, (2) be occurring in parallel (meaning transaction/s′ UTXO/s is/are spent by current transaction) or (3) will take place in the future. But the main challenge is to exert various consistencies and logic enforcement over sequences of interactions (sequences of blockchain events of spending UTXOs) and to be able to do it to any required length of such a sequences.

Needless to say, that if the disclosed method provides a solution for sequential interactions of any needed length, such a method would cover the singleton case too, for the fact of it being nothing but a special case of the sequential one.

Note, a special case of such a sequential interactions consistency is a persisting smart-contract, meaning smart-contract's enforcement of its own script code immutability over locking script/s from one transaction to another in any of the forward, backward and sideward directions.

Furthermore persistence in itself could also be distinguished as fullor partial. The following are an examples with only partial persistence:
i. Smart contract with appendable (append-only) data attachment-data fields are immutable throughout contract's life and can't be modified, but may be appended with more data.
ii. Malleable smart contract e.g. more iterations of some unrolled loop (there are no loops per se in Bitcoin script, instead all the known-in-advance number of iterations is being unrolled) are allowed in next outputs of the smart contract sequence of iterations.
iii. Smart contract with mutable data, where the script code is persisted as constant, but the data fields (unexecuted script parts, e.g. located behind OP_RETURN opcode) are allowed to be different from one transaction to another.

Note, in addition to the fact that sequential smart contract data fields attachments may be of various nature over transactions sequences of events-constant/immutable, append-able and fully-mutable etc.; the data attachments may also come in various ways of script implementation, e.g.:

1. OP_RETUN <data>
2. OP_PUSHDATAx <data> OP_DROP
3. OP_FALSE OP_IF <data> OP_ENDIF

As being said, sequential contracts may also be of a non-persistent nature, namely involving arbitrary smart contracts (meaning, completely different scripts from one interaction to another, which fully or partially known in advance) along the sequence of their interactions, while such a sequence may be in backward or/and forward or/and sideward directions.

A technique enabling non-persistent sequential interactions will be described further below in the document. It will be cleared up that everything described in the document with relation to abilities of the feature of persisting sequential interactions of full-fledged smart contract is applicable for non-persisting sequential interactions through script-hash technique. The method is equally implementable for features of sequential interactions for both persisting and non-persisting types.

The first breakthrough over the original Satoshi's limited smart contracts capability was a development/invention of OP_PUSH_TX method shortly defined below. This method enabled relatively simply achieving realization of the forward sequential (persistent or not) interaction of smart contracts of any length.

The following section (‘token’) will elaborate why smart contract must be capable of realizations of sequential (partially persistent, fully persistent or non-persistent at all) interactions in all three directions (including sideward and backward) in order to be full-fledged (FF).

### Token:

Smart contract may include a ‘token’in it. A ‘token’ constitutes or represents some digital or physical asset. It may be created and redeemed/destroyed on the UTXO blockchain network, and for majority of token types may also be transferred, or even split, merged, atomically swapped etc.

A token functionality in smart contract (for any of its types: L2, on-chain or on-coin) may be implemented either 1) based on values of some data fields inside smart-contract's script, in which case it is distinct from the underlying native tokens of UTXO blockchain (e.g. ‘satoshi's in case of Bitcoin or ‘zatoshi's in case of Zcash); or alternatively 2) it may be implemented by encumbering native UTXO blockchain tokens with specific meaning corresponding to an asset they constitute or represent, that is through enforcing rules and conditions over native tokens actions (spendings) according to logic of ‘token’ smart contracts. Example of past on-chain implementation based on encumbering of native UTXO blockchain tokens—e.g. as in WO 2022/118263, another example of past on-chain implementation based on values of some data fields inside contract's smart script-https://xiaohuiliu.medium.com/utxo-based-layer-1-tokens-on-bitcoin-sv-f5e86a74c1e1. From now and on these implementations will be called as data-fields-based and native-token-based respectfully.

An Important distinction is the data-fields-based (DFB) token implementation type has an capacity of unlimited token supply, while native-token-based (NTB) implementation type has a limit of the supply of underlying native tokens it's utilizing. In some intricate cases, smart contracts may combine multiple token systems, some based on former implementation while others on the latter, and all in the same smart contract.

In a very rough manner, token smart contracts may be divided into fungible (FT) and non-fungible (NFT) main types (each type has more categories and each category itself has sub-categories etc.). “Fungible refers to any digital asset that can be exchanged for another asset of equal value. Fungible tokens are interchangeable and have no unique characteristics, meaning that they are completely interchangeable with each other.

On the other hand, non-fungible tokens, also known as NFTs, are unique. See: “FT vs. NFT, we explore the differences”. (https://www.nfttrends.app/note/dictionary/ft-vs-nft-we-explore-the-differences.html).

In case of FTs aka fungible tokens, individual tokens are undifferentiated, as a result groups of fungible tokens can be freely divided and merged without tracking the identity of individual tokens (much like the native tokens of UTXO blockchain, e.g. satoshis, zatoshis etc.). In the vast majority of cases, NFTs aka non-fungible tokens cannot be merged of divided.

Some smart contracts include the ‘token’ implementation as one of their features, while others are made solely for the purpose of the ‘token’ feature realization, thus may be rightfully called smart contracts of token type or just-token smart contracts.

In general, the ‘Token’ feature itself is independent (orthogonal so to say) to a feature/s of ability of smart contract to perform sequential/persistent interactions in any direction.

The ‘token’ is evidently and clearly the most sought after feature or type of smart-contracts (from here and on, will be called simply a token collectively).

The following publication is a good description of a method of an on-chain (but not on-coin) solution of a token smart contract, which is achieved due to OP_PUSH_TX technique, the token implementation in the method is native-token-based (specifically in the “WO 2022/118263” it is-satoshis-based), and is defined/described as substantiation of native UTXO blockchain tokens (e.g. as described in WO 2022/118263).

Following is a more palpable description of the token functionality demonstrating the necessity of ability of sequential interactions in backward direction, based on slight paraphrasing of a relevant essential parts of the publication.

As a token by its definition means connecting the token to a real world asset (in order the formerto represent the latter), this connection must happen through identified trusted entity, which is trusted to issue the token in return for some real world actions e.g. assets deposition, and then trusted to provide a service (e.g. cinema entry ticket) or give the assets out (redemption) when specific contract conditions are met. Such an entity identification may be accomplished by e.g. its association with cryptographic keys, specifically used for the purpose of such an identification.

If an intermediary such as a bank, an airline company or the securities exchange are trusted to broker the value of the assets that the token may represent. e.g. if they are trusted on the redemption of the assets they issued tokens for earlier, then they, instead of open market, may peg the value of the token to specific real world assets.

The token feature or entire smart contract (locking script) is what makes it possible. As it provides desired control over issued tokens on the script evaluation level. Namely, tokens can NOT be spent to a new output with any arbitrary locking script in it, instead, the spending is possible only if a specific conditions set immutably in that contract are met, that is, the token script of unspent token output (UTXO) dictates (for the spending to take place) the form of the next output's (or outputs') script format (which is achieved through OP_PUSH_TX technique), created by transaction which is spending that UTXO.

For example, if redemption condition (hardcoded in token smart contract script) is met, then token smart contract ‘allows’ assignment of a regular ‘standard’ output script format (e.g. P2PKH, P2PK etc.) in next UTXO created by current spending transaction. Otherwise, token smart contract spending is possible, if and only if, the next UTXO has exactly the same token locking-script as the UTXO being spent has, sometimes with an exception of some small part of it, e.g.—address field, which is allowed to be updated with new owner address.

There is only one technical issue, which is a counterfeit. Legally issued tokens are secured and governed on the script level, but since the ledger (blockchain) may be seen by other parties (in most cases it's just publicly open to anyone), those parties can see the token script template and create counterfeit tokens with exact same output locking script (token smart contract), then maliciously use it as representatives of a real assets at his will. To be more specific, even though spendings of created token UTXOs (counterfeit or legal) will be correctly governed by their scripts, there is nothing controlling their very first creation on the script level.

For that reason, the second part of this on-chain substantiated token protocol (described in the above-mentioned WO 2022/118263 application) provides so called authenticity verification, which validates that the token UTXO is not a counterfeit by checking on the blockchain level its transactions traceback to its very first issuance (genesis) transaction, where the token should be legally created.

In short, in order to validate toke″s authenticity, the path of its ancestor transactions on the global ledger (blockchain) should be checked (through input index—0), leading to the issuance transaction, performed by spending UTXO with same address identical to token's immutable asset ID field, which is hardcoded in token's smart contract code. Which indicates that only the owner of the private keys corresponding to this specific address, which is also token/asset ID, could make the issuance.

In more detailed manner, a first field of token data part (part of the token script, which is not executed, due to being next after OP_RETURN opcode) is an asset/token ID, which is also an address that should be associated/identified with the real world issuer. This address should be the one which is included in the standard locking script of the output which the very first token/s issuance transaction spends. Spending of this transaction standard output demands knowledge of private key corresponding to the public-key/address with which the issuer is associated/identified. Therefore authenticity verification may be achieved by tracking trail of transactions outputs with substantiated tokens locking scripts back to this initial output spent by issuance transaction, and that for the following reasons:
a) Only genuine issuer could spend it in order to issue the tokens.
b) Once the token is issued, its substantiated state preservation is guaranteed by its smart locking script (with OP_PUSH_TX help) wrapping the tokens in transactions outputs. This preservation, among other things, includes preservation of issuer's hardcoded public key/address in it.

Thus the whole process constitutes simple mathematical induction and by that achieves token smart contract implementation. Check WO 2022/118263 for more in-detail elaboration.

But clearly since the method involves performance of verifications through transactions history traceback on the blockchain level, in addition to verifications achieved by script execution (by miners), the method is of on-chain type but not of on-coin one (as described above).

Therefore, it appears that on-chain verification of tracing a transaction backward to a particular ancestor transaction (called genesis transaction, e.g. issuance in above token example case) on a blockchain is a much solicited feature to ensure the integrity of the transaction and/or authenticity of an asset (such as a token) involved with the transaction.

In other words, “Substantiated tokens” (being forward-persisting smart contract and locking in it underlying native tokens of the blockchain) described in WO2022118263A1 is a good example to demonstrate the demand for back-to-genesis solution presented in current document, which massively facilitates its ‘Authenticity verification’ solution presented in WO2022118263A1.

The past proposals to achieve such a backward tracing without introducing base protocol changes, either caused an exponential growth surge of the size of transactions throughout the chain of transactions trail, as described in:
“Peer-to-peer Tokens-Back To the Genesis Problem” (https://xiaohuiliu.medium.com/peer-to-peer-tokens-6508986d9593); or alternatively, proposals as “Solving Back-to-Genesis Using a Transaction Chain Proof” (https://nchain.com/solving-back-to-genesis-using-a-transaction-chain-proof/) were not capable of implementation of sequential interactions of advanced structures (funnel-shape or full-DAG); as well as 2) have had unnecessary computational overheads, most critical of which—an impractically large time of generating proof parameters in transaction chain, since the usage of IVC recursion (Incrementally Verifiable Computation https://iacr.org/archive/tcc2008/49480001/49480001.pdf) in SNARK/STARK protocols requires arithmetization of the verifier side program (https://dev.risczero.com/reference-docs/about-arithmetic-circuits), in addition to naturally arithmetized prover side logic.

Which in turn, inflates the circuit size, and as a result eventually is expressed in inflation of time required to create such a proof (passed to unlocking script as parameter for execution of smart-contract script of the UTXO being spent). Even though the complexity time of proof generation (which takes place off-chain) with IVC recursion throughout the tracing chain of transactions is roughly constant, yet as stated, it's still too large to have a practical implementation for the vast amount of (or even all) use-cases.

Thus despite of using SNARK/STARK protocols, which inherently have a feature of “compression” for succinct verification on-chain, an implementation of sequential interactions of advanced structures (such as funnel-shape, full-DAG) is extremely-complex or simply impossible, and that in addition to the time required by this solution (with IVC recursion) for creation of a proof still makes it not ‘practically feasible’ today, and hence the solution is not to be used if smart contract method claims to be full-fledged.

The same is correct for another IVC technique—the a so-called ‘folding’ (or ‘proof composition’), which is another IVC family of protocols (e.g. Nova, its generalization—SuperNova, Sangria—Nova for PLONKish circuits, HyperNova, ProtoStar and many others), which in addition to recursion disadvantages is complex and not time/battle-tested yet, e.g. see recent example: https://www.zksecurity.xyz/blog/posts/nova-attack/as well as, is not really suitable to be combined with FRI commitment.

But even if any of these IVC techniques will become practically feasible in the future when computation abilities will significantly improve, it is very limited for implementation of arbitrary shape sequential interactions of smart contracts as well as it would still always carry unnecessary redundant computational overheads relatively to the method disclosed below in this application/document, since the disclosed method may be used to achieve any solution achieved with the help of the IVCs.

Therefore it's important to note that, our definition of being ‘practically feasible’ through this document, implies enabling flexible implementation of sequential interactions of any required shape, as well as—not only being ‘practically feasible’ to be implemented today, but also avoiding usage of SNARK/STARK IVC techniques (recursion, folding etc), since (as already stated) even if these techniques will become practically feasible in the future, they will still be very limited and have unnecessary redundant implementation complexity and computational overheads relatively to the method disclosed here

A necessity of an ability of sideward interactions (in order for a smart contract to be full-fledged); In order to enforce any spending conditions from contract execution in context of one input of transaction to execution in context of another input (within the same transaction), the whole data (or significant fragments-constituting majority of transaction data) of preceding transactions of UTXOs being spent through “mate” inputs of that sametransaction should be pushed into unlocking script of an input, in context of which execution takes place.

For example, a merging of two unspent outputs with the same fungible token locking scripts, requires pushing into unlocking script of each of them the significant fragments of serialized previous transaction, output of which, the other ‘mate’ input participating in merging spends, thus causing significant increase in transaction size and cost. As a result, the size of the spending transaction is increased by the sizes of both transactions, outputs of which current transaction is spending.

That is because for validation of authenticity of a UTXO being spent by mate-input inside execution of current input context of transaction, the whole preceding transaction that includes this UTXO should be hashed and compared to TXID from outpoint field corresponding to that mate-input, while the outpoints values of mate inputs are provided as parameters in current input unlocking script for OP_PUSH_TX realization. After such validation occurs, this whole preceding transaction may be parsed in order to extract from it any desired fields for further enforcement of some rules/conditions on those fields, e.g. that same UTXO script field.

This makes the number of such sideward inter-input interactions very limited and totally unfeasible for more than a few interaction in a sequence, since the complexity of a total size (of memory) of transaction grows parabolically as a function of a number of its inputs (n) participating in such a sideward activity, and is multiplied by a size of preceding transactions.

To be more precise, for average size X of preceding transaction and n inputs requiring such interactions between them, for each input n−1 number of the whole preceding transactions of mate inputs (each of size X on average), should be provided as parameters, that is n*(n−1) total of preceding transactions are inserted into unlocking scripts of all such inputs of current spending transaction, making the total average size of current spending transaction n*(n−1)*X.

Moreover, if the sideward direction is combined with e.g. forward one, the growth becomes exponential because of the following transactions in forward chain, as each forward step parabolically enlarges already parabolic growth. Namely, fort such a forward steps average transaction size becomes (n^{t})*((n−1)^{t})*X.

As a simplest practical example, for fungible token features/smart-contracts case there must be an ability of merging, requiring realization of a sideward persistent smart contracts interactions.

In other words, we can see that in order for a smart-contract to be full-fledged the realization of sideward sequential/persistent smart contracts interactions is an obligatory.

The currently available and suggested in the past methods for backward and sideward sequential interactions realization are 1) either not on-coin or 2) on-coin but not ‘practically feasible’ for vast majority (most probably all) of use-cases.

Generally, on-coin realization of such smart contract functionality of sequential interactions in sideward and backward directions has been the most sought after and challenging until today.

Basically, in order to be of on-coin nature, all categories and types of token features/smart-contracts (with an exception of types requiring only one-time usage/spending/action, e.g. non-transferable ticket) require sequential smart-contract of a persisting type in at least forward and backward directions (NFT), while for others, sideward persistence is required as well, e.g. for fungible token type implementation of its obligatory ‘merging’ feature.

Conclusions 1, 2, 3. Therefore it may be concluded so far that for a smart contract to be ‘full-fledged’:
1. It must be of on-coin implementation, in order to be native to suit all existing UTXO blockchain categories of modification policies (as described in the background section).
2. It must include an ability of realization of sequential interactions (and most importantly, of its persistent type) in any desired direction and any needed combination of directions.
3. It must be ‘practically feasible’ to implement.

### ‘Vertical/Orthogonal’ Smart Contract Features:

Permissioned smart contract-constituting a locking script of UTXO, which requires for verification of legitimacy of all or some of its spending types involvement of a party other than the blockchain and the owner/s of that UTXO, namely-some third party. Simply put, permissioned means-involving any degree of control/interruption by third party, while the degree of control may vary from being full (required for any spending of UTXO with specific smart contract) to minimal (required only for some specific marginal spending type, out of all existing spending types allowed by that smart contract). For example, 1) smart contract requiring co-signing from some oracle or external validator for any spending of its UTXO (making it fully controlled by third party) and that is in addition to a signing by the owner of that UTXO; or 2) smart contract, that in addition to regular spending without any third party (permission-less spending), allows another type of spending where a third party (e.g. government) may interrupt ownership and confiscate or freeze assets (e.g. tokens) entrusted into specific smart contract.

There are multiple other cases where real world businesses are interested in various permissioned types of smart contracts to be able to have different extents of control (e.g. over the token smart contracts they issue) through various features like-expiration, whitelisting, freezing, blacklisting, dividend-payout, demurrage-payout, cancellation, callability (e.g. for bond tokens).

Permissionless smart contract-a smart contract which UTXO spending is controlled only by its possessor that is without any third party involvement or ability to interrupt. As example, in persistent smart contract of digital-cash token type, once the token is issued the issuer (or any other than possessor entity) has no effect on token's further spendings, done for transfers of the token between users, moreover even in order to end such a token existence by redemption (e.g. sending to specific address, hard coded immutably in token contract as a condition for redemption), the redemption is still done solely by last token possessor.

For permissioned and permissionless features there have been already an ability of native implementation, which was achieved due to OP_PUSH_TX technique.

But in order to be full-fledged smart contracts need another two important features, which are—“succinctness” and “zero-knowledge”.

### Succinctness:

Regardless of having or not token, sequential and permissioned features, a smart contract may be additionally required to verify on-coin a correctness of an execution of a very abundant computation performed off-chain.

For example, (1) “delegation of computation” smart contract, which means-paying to someone with sufficient computational resources for “on-coin verifiable” computation executed off-chain. For example, the delegated computation could be training some complex machine-learning model on a given data; moreover, for such a delegated computation to be discrete and private, the computation should involve FHE (full homomorphic encryption) which is further enlarging the already significantly abundant computation; or (2) native implementation of private-data feature (encryption) of smart contract (see description of a non-native attempt of such implementation using PGP encryption-https://bitcoindev.network/using-gpg-as-a-bitcoin-address/), namely—the public key used for UTXO ownership (namely, a public key of a receiver of transaction) on the blockchain is additionally used for PGP encryption (by transaction sender) of some data fields of newly created UTXO by transaction (assuming both utilize the same elliptic curve, e.g. secp256k1 elliptic curve used for both Bitcoin's ECDSA and for GnuPGP realization), meaning only the possessor of the corresponding private key is able to decrypt the data fields assigned into this UTXO, as well as to further spend the UTXO.

In other words, for UTXO-based blockchain model to have a practically-feasible full-fledged smart-contracts, the smart contracts must include an ability to “compress” verification of computation, or more precisely—an ability for computation performed off-chain to have succinct on-coin verification (or simply put, for on-coin verification time to be much less than off-chain computation time). Conclusion 4.

### Zero Knowledge:

Another feature necessary to have in order for smart-contract to be full-fledged is zero-knowledge (or just ZK). Smart contract may be required to verify on-coin a correctness of execution of a computation performed off-chain on hidden (private) inputs of data. As example, given known (to both prover and verifier) output result of hashing, proving knowledge (of prover) of hash preimage while keeping it secret from the verifier (that is, without disclosing it to a verifier of disclosing zero of knowledge of preimage). Conclusion 5.

The article “17 misconceptions about SNARKs (and why they hold us back)” (https://a16zcrypto.com/posts/article/17-misconceptions-about-snarks) clears up all the subtle differences and confusions between definitions of SNARK, STARK, ZK and others.

All the described above—token, permissioned vs permissionless, compressing/succinctness and zero-knowledge features aren't dependant on sequence of other outputs/transactions other than the one involved in current spending, namely—they are self-contained per UTXO spending, therefore if a an ability of a native realization of “succinctness” and “zero-knowledge” features would be provided, these features (along with already-existing native realization capacity for permissioned features realization, achieved through OP_PUSH_TX) would be independent (orthogonal so to say) to natively implemented feature/s of ability of smart contracts to perform sequential interactions in any direction over blockchain DAG.

For this reason we will symbolically collectively call them as vertical features, because of being orthogonal/independent relatively to sequential interactions features of forward, backward and sideward directions over blockchain DAG.

This orthogonality (independency) assures that nothing can hinder/impede combining these vertical features with sequential/persistent interactions features (if both are realized natively). And this ability of frictionless combining of these two types of features, is necessary for smart contracts to be full-fledged as it must be capable of including any desired composite of any features. Conclusion 6.1.

Note these token, permissioned vs permissionless, compressing/succinctness and zero-knowledge features aren't dependant on each other as well. Thus in the same way, nothing can hinder/impede combining them with each other regardless of presence of sequential/persistent interactions features in the same smart contract. Conclusion 6.2.

Or it may be alternatively stated that, the two features of “succinctness” and “zero-knowledge” are independent of, and therefore may be compounded with no hindrance with: 1) permissioned and permission-less features of smart-contracts, as well as 2) token smart-contracts features, and 3) features of any sequential/persistent interactions and their combinations of any directions.

### Conclusion (all 1 to 6):

As stated above, for smart contract to be full-fledged, in addition to having practically feasible on-coin implementation with sequential interactions in all directions (and any possible combinations of the three directions) over blockchain DAG-it must have an ability of on-coin and practically feasible realization of these two features of “compression”/“succinctness” and of ZK as well as an ability of freely combining any of the features by demand.

### SUMMARY OF INVENTION

In the light of everything elaborated above (in preceding Background and Introduction sections of this further disclosure section) it has become clear that for a smart contract to be full-fledged:
1. It must include an ability to propagate and contain a logic enforcement from any sequence (and of any sequence length) of outputs/transactions to/from any direction (forward, backward, sideward), namely an ability of realization of sequential interactions (and importantly, of its persistent type) in any desired direction and any needed combination of directions.
2. It must have an ability of realization of “compression”/“succinctness” feature, namely to be able to succinctly verify on-coin a correctness of an execution of a very abundant computation performed off-chain; in other words, for such on-coin verification to have i) much less time than the time needed to perform its corresponding off-chain computation and to have a relatively small size proof needed for this verification. Simply put, succinct refers to proof systems with a short proof and fast verifier.
3. It must have an ability of realization of “Zero Knowledge” (https://en.wikipedia.org/wiki/Zero-knowledge_proof) feature in order to be able to keep private (to conceal) data of input/output parameters of off-chain computation being verified succinctly on-coin.
4. It must have an ability of combining without hindrance all vertical/orthogonal features implementations inside smart-contract, as well as combining them with sequential interactions features implementations of any direction/s and combinations of directions.
5. All the features, abilities and their combinations must be ‘practically feasible’ to implement, meaning, to have practical time of: i) proof-creation and proof-verification-execution and ii) practical size of the proof and of the on-chain/on-coin verification scripts involved. Importantly, memory/space complexity (https://en.wikipedia.org/wiki/Space_complexity) of size of scripts and parameters, responsible for sequential/persistent interactions implementation, must be O(1) (meaning, it constitutes a constant average memory usage) throughout/along the sequence of transactions interactions; since growing size of such a scripts/parameters throughout/along a sequence of ‘long enough’ length at some step may eventually become not ‘practically feasible’ to implement.

Also note that, as stated above, ‘practically feasible’ through this document, will not only mean being ‘practically feasible’ to be implemented today, but will also imply avoiding usage by SNARK/STARK protocols of implementations of any IVC techniques (recursion or folding), since these techniques highly limit sequential interactions implementations ability and even if they will become practically feasible in the future, they will still have unnecessary redundant implementation complexity and computational overheads relatively to the method disclosed here.
6. All the features, abilities and their combinations must be of on-coin realization, in order to be native. That is for: (1) avoiding any effect on its original legal definition (see “The Locked Protocol” and “Most cryptos are securities according to the Howey test”); and preserving its features of being (2) maximally possibly parallel by design and (3) highly secure (which is field-tested by time); and thus (4) to suit all existing UTXO blockchain categories of modification policies (as described in the Background section).

The core structure of the disclosed method is a mathematical induction, which achieves realization of sequential interactions (and most importantly, of its persistent type) in any desired direction and any needed combination of directions.

The method combines SNARK/STARK (“Succinct Non-interactive Argument of Knowledge”/“Scalable Transparent Argument of Knowledge”) technology and smart-contract scripts (locking scripts, residing in transaction outputs) with “smart” parameters (residing in unlocking scripts of transaction inputs) provided to the smart contracts for their execution during script validation by miners.

As it will be elaborated in-detail in the following document sections, usage of SNARK/STARK techniques with simple mathematical induction allows to avoid usage of SNARK/STARK IVCs (recursion, folding etc), and therefore provide flexible implementation of sequential interactions of funnel-shape or full-DAG types and avoid unnecessary redundant computational overheads of SNARK/STARK IVCs (most disturbing of which is-excessive time required for proof creation by SNARK/STARK IVC solutions), therefore achieving today's practically-feasible implementation of flexible unlimited sequential/persistent interactions of any length (and in any direction and combination of directions) and providing minimal-overhead solution for such implementation in the future.

And since the mathematical induction method is SNARK/STARK based, the method naturally provides the feature of succinctness/compression, embedded in it.

Moreover, since every SNARK/STARK algorithm/protocol inherently coupled with zero-knowledge feature as an option, the option of the zero-knowledge feature (ZK) is naturally supplied by the method as well.

Therefore, the method covers all the requirements for a full-fledged smart contract solution.

In order to demonstrate that the invention satisfies all the conditions for being full-fledged and not limited from any aspect of its realization, in the course of this document the method elaboration will be accompanied by presentation of palpable examples (from relatively simple to more complex ones). The key smart-contract features and types to be covered by the examples, in order to demonstrate that smart-contract method is full-fledged, are:

non-sequential and sequential interactions; non-persistent and persistent interactions; fully and partially persistent interactions; capability of interacting with other sequential interactions smart-contracts which are either known or unknown beforehand; zero-knowledge, succinctness.

While clearly, the examples should include a demonstration of an ability of implementation of smart contract sequential interactions in any possible direction and any possible combination of directions over blockchain DAG.

Therefore each of the below examples will demonstrate method's coverage of either some of the conditions required for being full-fledged or some specific key aspects of these conditions, while at the same time being able to be implemented natively and in practically feasible manner:
1. One-to-one (linear) persisting smart-contracts-presents capability of forward-only sequential interaction, implemented with bare scripts and based on OP_PUSH_TX technique (even though it could be implemented by—demand based on SNARK/STARK techniques too).
2. One-to-one (linear) persisting smart-contract-presents capability of forward and backward interactions.
3. Many-to-one persisting smart-contract-presents capability of forward, backward and sideward interactions.
4. Many-to-many persisting smart-contract-presents capability of forward, backward and sideward interactions, combining non-persistent sequential features inside the persisting smart contract.
5. Arbitrary sequential non-persisting smart-contract example while smart-contract “knows” beforehand its adjacent in the sequence of interactions expected/enforced smart-contracts
presents capability of arbitrary forward, sideward and backward interactions.
6. Sequential/persisting smart-contract capable interacting with others (different form it) and not-known-beforehand counterparties' sequential smart-contracts-presents capability of full-fledged smart contracts to interact with each other.

The majority of sequential interactions examples are using persisting smart-contracts since those are best to demonstrate the limitless interaction-ability (to be of any required sequence length) of the described method (note, a smart-contract for a single, double or maybe several interaction/s chain events could probably be done without the current disclosed method, but it would be achieved in a highly limited and non-effective way), but it will be cleared up in the course of the document that the sequential interactions could in the same manner be implemented among full-fledged smart-contracts which are of partially-persisting or arbitrary non-persisting types, namely a smart-contract of UTXO may require for its spending any other (than its own) script in adjacent UTXOs in an interaction sequence in any direction over blockchain DAG and so on for the next UTXO in that interaction sequence chain.

As stated above, the method provides a solution for any combinations of sequential and various ‘vertical’/‘orthogonal’ smart contracts features, many of which (as (a) succinctness and zero-knowledge vertical features and (b) backward/sideward sequential features) were previously considered impossible to implement natively and that is within today's practically feasible time and size (and minimal-overhead time and size in the future) of creation and execution of the smart contracts scripts involved.

Note, all the examples (among other things) are involving interactions of persisting scripts also include interaction with non-sequential/non-persisting UTXO scripts, e.g. standard P2PKH, used for change output or funding input (namely, UTXO spent by funding input) scripts.

Also note that values of other than scripts fields of transaction may be involved in all those interactions too, e.g. nLocktime, nSequence, Version and any other.

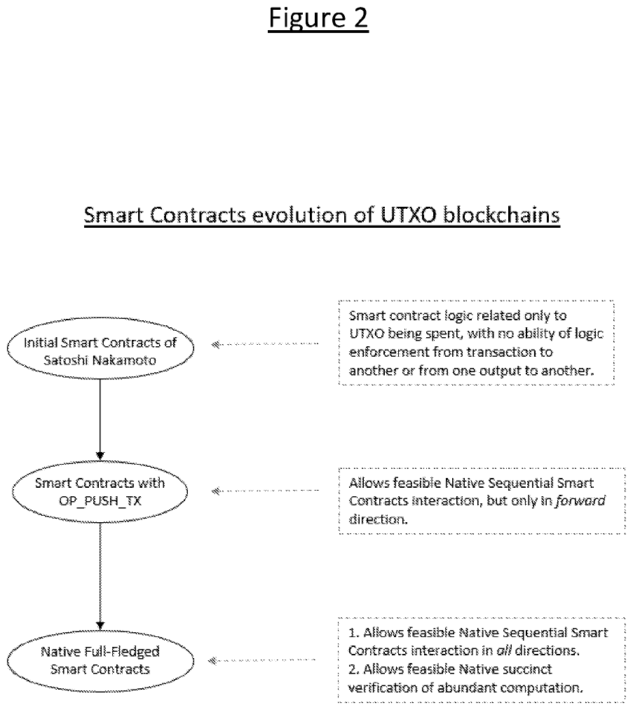

The evolution of smart-contracts on UTXO-based blockchains is traced on FIG. 2.

Some additional (to already-defined until now) terms and abbreviations that may be used throughout this document include:
Substantiated (transformed) tokens-tokens native to the blockchain (such as native Bitcoin tokens—satoshis, or native Zcash tokens—zatoshis) that are attached to (or constituting/representing) specific real world (e.g. digital or physical) assets, it is another definition for native-token-based (NTB) implementation of tokens.
TX—a transaction.
TXID—is a hash of a transaction's data. A TXID (Transaction ID) is basically an identification number for a transaction. In other words, an identifier used to uniquely identify a particular transaction; e.g. specifically in case of Bitcoin, the double sha256 hash of the transaction.
Outpoint—a data structure used to refer/point to a particular transaction output, usually consisting of a 32-byte TXID and a 4-byte _‘output index’ number (sometimes called-vout).
PKH aka “raw address”—Public Key put through usually the SHA256 and RIPEMD 160 hash functions.
P2PKH—“Pay To Public Key Hash”: transaction output script (locking script) type considered for many years as “standard” for Bitcoin implementations.

With Bitcoin implementations, the P2PKH script pattern typically contains a hashed public key (PKH) surrounded by ‘OP_DUP OP_HASH160’ and ‘OP_EQAULVERIFY OP_CHECKSIG’ opcodes (before and after it respectively).

In its raw hex script form is: “0x76a914”+PKH+ “0x88ac”, and in raw (hex) transaction is preceded by VarInt 0x19 due to its 25 bytes length.
SNARK—“Succinct Non-interactive Argument of Knowledge” family of cryptographic protocols/algorithms, all coupled with option of “zero-knowledge”.
STARK—“Scalable Transparent Argument of Knowledge” cryptographic protocol/algorithm, coupled with option of “zero-knowledge”.
In-circuit—(aka in SNARK/STARK circuit) off-chain implementation of a program using any existing SNARK/STARK algorithms, which involves arithmetization (translation of the program into an arithmetic circuit) methods, which execution generates a relatively small proof, which together with corresponding public (known to prover and verifier) parameters may be used by smart contract for succinct on-coin verification of the correctness the off-chain execution of this program.
In-script—part of smart contract program/code directly implemented in its script language and not responsible for verifications of any in-circuit implemented programs.
OP_RETURN—a command/function/opcode of script used in UTXO-based blockchains smart contracts in order to terminate the whole smart contract script execution.

### Preliminary General Background Technology Relevant to the Method:

### Elliptic-Curve Cryptography and OP_PUSH_TX Method:

Example of signing/signature formula of ECDSA (https://en.wikipedia.org/wiki/Elliptic Curve_Digital Signature Algorithm):

$$PubKey = PrivKey * GenPoint$$

$$( x 1 , y 1 ) = RandNum * GenPoint$$

$$r = x 1 ( mod n )$$

$$s = ( HashOfMsg + r * PrivKey ) * {RandNum}^{- 1} ( mod n )$$

The signature is (r, s)

In the case of Bitcoin (including its variations and derivatives), the HashOfMsg (hash of the message, called also sighash-https://github.com/libbitcoin/libbitcoin-system/wiki/Sighash-and-TX-Signing) parameter is a result of a double SHA256 of the serialization of the sighash preimage, construction of which occurs in two variations, which can be defined as the legacy variation and the optimized variation.

The legacy variation works as follows (and as described in detail in https://en.bitcoin.it/wiki/OP_CHECKSIG):
1. the public key and the signature are popped fromthe stack, in that order. Signature format is [<DER signature><1 byte hash-type>]. Hashtype value is last byte of the sig.
2. A new 22atoshi22t is created from the scriptCode (the scriptCode is the actually executed script-either the scriptPubKey for non-segwit, non-P2SH scripts, or the redeemscript in non-segwit P2SH scripts). The script from the immediately after the most recently parsed OP_CODESEPARATOR to the end of the script is the 22atoshi22t. If there is no OP_CODESEPARATOR the entire script becomes the 22atoshi22t
3. Any occurrences of sig are deleted from 22atoshi22t, if present (it is not standardto have a signature in an input script of a transaction)
4. Any remaining OP_CODESEPARATORS are removed from 22atoshi22t
5. The hashtype is removed from the last byte of the sig and stored
6. A copy is made of the current transaction (hereby referred to txCopy)
7. The scripts for all transaction inputs in txCopy are set to empty scripts (exactly 1 byte 0x00)
8. The script for the current transaction input in txCopy is set to 22atoshi22t (lead in by its length as a var-integer encoded!)

By this approach the message for those hashes was unnecessary large for a big number of signature checkings in a transaction, and it made the hash function take unnecessary long time. It was historically called quadratic hash solution, even though in reality it's just an optimisation of hashing time.

As a result, certain implementations of Bitcoin use the following optimized way (termed BIP 0143), which is described in more detail in https://en.bitcoin.it/wiki/BIP_0143 and https://github.com/bitcoin-sv/bitcoin-sv/blob/master/doc/abc/replay-protected-sighash.md #digest-algorithm).

The optimized preimage construction consists of the following current (the one attempting to spend) and previous (the one, output/UTXO of which is being attempted to be spent) transaction/s fields/parts:
1. nVersion of the transaction (4-byte)
2. hashPrevouts (32-byte hash)—the double SHA256 of the serialization of the outpoints (transaction IDs and output indices) being spent by this transaction
3. hashSequence (32-byte hash)
4. outpoint (32-byte hash+4-byte)-transaction ID and index of output being spent by this input
5. scriptCode of the input (serialized)-previous transaction's output locking script, includes prefix carrying its length (called Varint)
6. value of the output spent by this input (8-byte little endian)-previous transaction's output amount of Bitcoin (in 23atoshi units)
7. nSequence of the input (4-byte)
8. hashOutputs (32-byte hash)—the double SHA256 of the serialization of all current transaction's outputs that is, amounts with their corresponding locking scripts
9. nLocktime of the transaction (4-byte)
10. sighash type of the signature (4-byte)

Apart from the optimization, there is one structural difference between these two sighash preimage variations, namely the legacy variation does not include the value/amount field (6) of output/UTXO that current input spends.

The invention disclosed herein is applicable to both variations of sighash preimage construction (legacy and optimized).

The description below first addresses the optimized version as it may be ported to the legacy one in a more trivial manner (than the other way around).

The description then addresses the modification needed for the legacy case, which is compensating lack of value/amount field (of output being spent) in the sighash preimage (ignoring the needed removal/modification of some implementation steps in/from the optimized variation, as this is obvious and trivial).

### Sighash Flags:

The Bitcoin operation code (opcode) CHECKSIG verifies signatures together with a non-script one-byte sighash flag/type argument, which indicates which part of the transaction the signature specifically endorses.

The input signature can endorse an entire transaction with a fixed set of inputs and outputs. The signature can also be selectively applied to specific outputs, so the transaction can include further outputs not endorsed by the signature.

| Sighash Type | Marker | Description |
|---|---|---|
| ALL | 0x01 | Signs all inputs and outputs |
| NONE | 0x02 | Signs all inputs, outputs modifiable |
| SINGLE | 0x03 | Signs all inputs and single output, other outputs |
| | | modifiable |

Selectively endorsing inputs is done with the ANYONECANPAY sighash modifier, which enables inputs to be modified after signing, and can be combined with the previous sighash markers.

| Sighash Type | Marker | Description |
|---|---|---|
| ALL + | 0x81 | Signs single inputs and all outputs, inputs |
| ANYONECANPAY | | modifiable |
| NONE + | 0x82 | Signs single input, inputs & outputs |
| ANYONECANPAY | | modifiable |
| SINGLE + | 0x83 | Signs single input, and single output, other |
| ANYONECANPAY | | inputs & outputs modifiable |

More detail on sighash flags can be found at https://wiki.bitcoinsv.io/index.php/SIGHASH flags.

In the optimized version the following 3 fields of sighash preimage are the ones linking inputs and outputs of the whole transaction, in case of sighash flag ‘ALL’ (without ‘ANYONECANPAY’ one) they are used when creating (signing) and validating the signature:
2. hashPrevouts
3. hashSequence
8. hashOutputs

These fields, unlike the others, only hashes of parameters (and present only in optimized sighash preimage version).

### OP_PUSH_TX:

Each output of a transaction comprises a locking script. In order to enable a script relating to an output to enforce spending conditions based on current transaction fields, it is desirable for the locking script to require from its corresponding subsequent unlocking script to provide information associated with the transaction containing this subsequent unlocking script.

OP_PUSH_TX is a method of accessing fields of current spending transaction within script execution. More precisely, parameter of sighash preimage, which includes data of most current spending transaction fields and locking-script field (in some UTXO blockchains also includes amount/value field) of UTXO which is attempted to be spent, is passed in unlocking script and then verified within script execution as carrying data identical to real transaction fields. Described in detail in WO2018/215871 and WO2018215873. Further relevant methods for referencing information in the transaction in an unlocking script of the transaction are described in applications: WO2019043538; WO2018215876; WO2018215947; WO2019034983; WO2018215875; WO2019034959; WO2018215872; and WO2021224428. The combination of commands or operational codes (opcodes) that achieve this goal is collectively referred to herein as a single pseudo-opcode: OP_PUSH_TX.

OP_PUSH_TX requires:
signing (ECDSA, Schnorr or other) of the sighash, which preimage, corresponding to a current TX spendings, is pushed into ‘unlocking script’ as one of script execution parameters.
calling OP_CHECKSIG opcode for verification of the signature, made over the sighash.
this internal (ECDSA, Schnorr or other) signing is performed with arbitrary private/public key pair which are publicly seen/deduced since they are unrelated to those used for token possession relay.
OP_CHECKSIG in this case functions as a validator, since when called it constructs its own preimage for (ECDSA, Schnorr or other) verification from actual current transaction fields (with 1 or 2 field/s of previous one).

Hence if it will fail or succeed depends on the actual fields being identical (or not) to those pushed into unlocking script.

Example of signature verification formula of ECDSA (link):

$$w = {s}^{- 1} ( mod n )$$

$$u 1 = HashofMsg * w ( mod n )$$

$$u 2 = r * w ( mod n )$$

$$( x 2 , y 2 ) = u 1 * GenPoint + u 2 + PubKey$$

$$If r = x 2 ( mod n ) signature is valid$$

The (ECDSA, Schnorr or other) parameters participating in this signing namely, the private key and ephemeral value k, with respective public key and r, all are part of (explicitly or as a results of math operations over them) and used by the locking script itself of the previous transaction, output of which is being spent. This locking script is the one being executed at the moment of spending.

After creating the signature over the sighash (hash of sighash preimage passed in unlocking script), the executed locking script verifies (by OP_CHECKSIG command call at its end) that the digital signature is valid, against the public key corresponding to private key used for signing. During this verification another sighash preimage is generated during OP_CHECKSIG call, but from the actual data fields of the spending transaction (and 1 or 2 fields of UTXO attempted to be spent). For digital signature to be valid the two sighash preimages must be an exact match.

OP_CHECKSIG command only succeeds (i.e. successfully executes) if the signature was made for the current spending transaction fields (and 1 or 2 fields of UTXO attempted to be spent. Or in other words, only if the sighash preimage passed as parameter to unlocking script was constructed from exactly the same fields of actual transaction (and fields of UTXO attempted to be spent) inside which the script is being executed.

Once it's verified that the sighash preimage (passed as parameter to unlocking script) is identical to the actual spending transaction sighash preimage, meaning its fields are identical to the actual fields of the current spending transaction (and fields of UTXO which is attempted to be spent), the sighash preimage parameter (passed in unlocking script) is further parsed to allow enforcement of conditions (of successful spending) on current transaction fields (and fields of UTXO which is attempted to be spent).

As mentioned above, the all the (ECDSA, Schnorror other) signing parameters are unrelated to those used for UTXO possession relay, and therefore may be considered as a constants publicly seen/deducible without compromising the underlying asset (UTXO) itself.

An example of OP_PUSH_TX code is shown below, written in native Bitcoin scripting language for sighash flag ‘ALL’:

OP_HASH256 OP_16 OP_SPLIT OP_15 OP_SPLIT OP_SWAP OP_14 OP_SPLIT OP_SWAP OP_13
OP_SPLIT OP_SWAP OP_12 OP_SPLIT OP_SWAP OP_11 OP_SPLIT OP_SWAP OP_10 OP_SPLIT
OP_SWAP OP_9 OP_SPLIT OP_SWAP OP_8 OP_SPLIT OP_SWAP OP_7 OP_SPLIT OP_SWAP OP_6
OP_SPLIT OP_SWAP OP_5 OP_SPLIT OP_SWAP OP_4 OP_SPLIT OP_SWAP OP_3 OP_SPLIT
OP_SWAP OP_2 OP_SPLIT OP_SWAP OP_1 OP_SPLIT OP_SWAP OP_CAT OP_CAT OP_CAT
OP_CAT OP_CATOP_CAT OP_CATOP_CAT OP_CAT OP_CAT OP_CATOP_CAT OP_CAT OP_CAT
OP_CAT OP_SWAP OP_15 OP_SPLIT OP_SWAP OP_14 OP_SPLIT OP_SWAP OP_13 OP_SPLIT
OP_SWAP OP_12 OP_SPLIT OP_SWAP OP_11 OP_SPLIT OP_SWAP OP_10 OP_SPLIT OP_SWAP
OP_9 OP_SPLIT OP_SWAP OP_8 OP_SPLIT OP_SWAP OP_7 OP_SPLIT OP_SWAP OP_6 OP_SPLIT
OP_SWAP OP_5 OP_SPLIT OP_SWAP OP_4 OP_SPLIT OP_SWAP OP_3 OP_SPLIT OP_SWAP OP_2
OP_SPLIT OP_SWAP OP_1 OP_SPLIT OP_SWAP OP_CAT OP_CAT OP_CAT OP_CAT OP_CAT
OP_CAT OP_CATOP_CAT OP_CATOP_CAT OP_CATOP_CAT OP_CATOP_CAT OP_CAT OP_CAT
1F OP_SPLIT OP_TUCK OP_CAT 00 OP_CAT OP_BIN2NUM
414136D08C5ED2BF3BA048AFE6DCAEBAFE 00 OP_15 OP_NUM2BIN OP_INVERT OP_CAT 00
OP_CAT OP_DUP OP_2 OP_DIV OP_ROT OP_3 OP_ROLL OP_DUP ff OP_EQUAL OP_SWAP 00
OP_EQUAL OP_BOOLOR OP_TUCK OP_NOTIF OP_1ADD OP_ELSE OP_2 OP_PICK OP_ADD
OP_ENDIF OP_3 OP_ROLL OP_TUCK OP_MOD OP_DUP OP_4 OP_ROLL OP_GREATERTHAN
OP_IF OP_SUB OP_ELSE OP_NIP OP_ENDIF
3044022079BE667EF9DCBBAC55A06295CE870B07029BFCDB2DCE28D959F2815B16F817980220
OP_SWAP OP_16 OP_SPLIT OP_15 OP_SPLIT OP_SWAP OP_14 OP_SPLIT OP_SWAP OP_13
OP_SPLIT OP_SWAP OP_12 OP_SPLIT OP_SWAP OP_11 OP_SPLIT OP_SWAP OP_10 OP_SPLIT
OP_SWAP OP_9 OP_SPLIT OP_SWAP OP_8 OP_SPLIT OP_SWAP OP_7 OP_SPLIT OP_SWAP OP_6
OP_SPLIT OP_SWAP OP_5 OP_SPLIT OP_SWAP OP_4 OP_SPLIT OP_SWAP OP_3 OP_SPLIT
OP_SWAP OP_2 OP_SPLIT OP_SWAP OP_1 OP_SPLIT OP_SWAP OP_CAT OP_CAT OP_CAT
OP_CAT OP_CATOP_CAT OP_CATOP_CAT OP_CATOP_CAT OP_CATOP_CAT OP_CATOP_CAT
OP_CAT OP_SWAP OP_15 OP_SPLIT OP_SWAP OP_14 OP_SPLIT OP_SWAP OP_13 OP_SPLIT
OP_SWAP OP_12 OP_SPLIT OP_SWAP OP_11 OP_SPLIT OP_SWAP OP_10 OP_SPLIT OP_SWAP
OP_9 OP_SPLIT OP_SWAP OP_8 OP_SPLIT OP_SWAP OP_7 OP_SPLIT OP_SWAP OP_6 OP_SPLIT
OP_SWAP OP_5 OP_SPLIT OP_SWAP OP_4 OP_SPLIT OP_SWAP OP_3 OP_SPLIT OP_SWAP OP_2
OP_SPLIT OP_SWAP OP_1 OP_SPLIT OP_SWAP OP_CAT OP_CAT OP_CAT OP_CAT OP_CAT
OP_CAT OP_CAT OP_CAT OP_CATOP_CAT OP_CATOP_CAT OP_CATOP_CAT OP_CAT OP_CAT
OP_CAT 41 OP_CAT OP_SWAP OP_NOTIF

| | |
|---|---|
| 038ff83d8cf12121491609c4939dc11c4aa35503508fe432dc5a5c1905608b9218 | OP_ELSE |
| 023635954789a02e39fb7e54440b6f528d53efd65635ddad7f3c4085f97fdbdc48 | OP_ENDIF |
| OP_CHECKSIGVERIFY | |

The size of OP_PUSH_TX in the above example is 438 bytes. It may be easily noted that it performs twice endian swap, since in e.g. Bitcoin, mathematical functions/opcodes work on little-endian parameters.

Note, Bitcoin scripting language version in this OP_PUSH_TX implementation uses OP_SPLIT opcode, while other versions use OP_SUBSTR, OP_LEFT, and OP_RIGHT opcodes instead.

Also note, what makes the OP_PUSH_TX technique possible is the usage of sighash preimage construction (using fields of spending transaction and UTXO being spent) as a message being signed, meaning OP_PUSH_TX is independent of any specific signing/verification algorithm such as ECDSA (even though it was used by Satoshi Nakamoto in the very first UTXO blockchain) and could use any other e.g. Schnorr, as BTC blockchain currently does (see BIP 340).

### An Example of OP_PUSH_TX Usage for Smart-Contract Persistence Condition

As example, when using OP_PUSH_TX technique, after verifying sighash preimage (passed in unlocking script) fields correctness and then after parsing it in order to set out conditions for spending a coin/UTXO on its specific fields, a special condition may be included which is-to enforce an inclusion of all of the current conditions (including the special condition itself) in the locking script/s of the previous or next descendant transaction outputs.

The inclusion of such a special condition may constitute a smart-contract enforcing its own inclusion in a locking script/s of the output/s from one transaction output to another next transaction output by their spending events (forward persisting condition of smart contract-FPSC).

Every forward-persisting smart contract (based on OP_PUSH_TX) is necessarily configured to generate a digital signature (e.g. an ECDSA, Schnorr signature) using the sighash preimage from the unlocking script (passed to unlocking script as a parameter).

Alternatively a special condition for spending of a UTXO could be a requirement of smart-contract's own inclusion in the past preceding UTXO (backward persisting condition of smart contract-BPSC).

Whereas sideward-persistence defined as—for successful spending of existing UTXO, the UTXO smart-contract is requiring Its own code immutability in other UTXOs that are being spent through any input/s of current transaction, which is/are other than its own current input, in context of which the script execution occurs (sideward persisting condition of smart contract-SPSC).

In persisting smart contract the locking script of a transaction containing the persisting smart contract requires a subsequent unlocking script of an input of a subsequent transaction to provide a proof that the smart-contract has been, is or will be replicated in an output of preceding, parallel or subsequent spending transaction, respectfully depending on the persistence direction.

In general, for transaction's spending to be successful, the persisting smart-contract of its UTXO, being spent by that transaction, enforces:
1. Its own self-code partial orfull immutability in output's locking scriptfrom onetransaction to another in any of the three direction over blockchain DAG
2. Rules by which variable part/s of outputs locking scripts may be changed (e.g. inside immutable locking script some field/part may be still variable, e.g. address field used for ownership relay from one UTXO to another-standard transaction procedure) from one transaction to another in any of the three direction over blockchain DAG.
3. Rules by which transactions fields, other than outputs locking scripts, may or may not be changed (optional part as well) from one transaction to another in any of the three direction over blockchain DAG, e.g. amount/value fields in the new outputs, nLocktime, nSequence etc.

In other words, the technique enables a persisting smart-contract enforcing its own inclusion in a locking script/s of the output/s from one transaction to another as well as within the same transaction when combining several spending events in parallel.

This creates a chain (or a funnel-shape, or a DAG) of transactions necessarily carrying the smart-contracts in their output locking scripts, which termination is possible only when some specific conditions (encoded in the smart-contract too) are met, e.g. conditions for tokens redemption or any other.

In case of legacy sighash preimage construction protocol (as in BTC blockchain), as already mentioned above, apart from the optimization, there is one structural difference between legacy (https://en.bitcoin.it/wiki/OP_CHECKSIG) and optimized sighash preimage construction variations, namely the legacy variation does not include the value/amount of the output that a current input spends.

Below is the modification needed for compensation of lack of value/amount field of UTXO (being spent) inside fields of sighash preimage constructed in a legacy way.

The value/amount of an output should be saved inside the persisting smart-contract/locking-script, similarly to address being a variable field of that contract, the value of each output should be encoded in its locking script itself and should be allowed to vary from one transaction to another.

Basically, an output carries its amount/value in two places:
1. Value field of the output
2. Additional variable value (amount) field inside the locking script of the same output

While the persisting smart-contract script:
1. Enforces the content of these two value fields to be equal for all new outputs (mandatory and optional) created with each transaction. To achieve this it's sufficient to assign the same value to both fields (real output amount one and output amount field within the locking script) when constructing hashOutputs preimage and validating it.
2. Accessing previous (being spent) output value/amount from corresponding output's locking script (by parsing it to read the previous value field), since the previous locking script is a part of the sighash preimage in legacy as in optimized preimage constructions.

The modification is described more in-detail in WO 2022/118263.

(ZK-)SNARK/(ZK-)STARK (“Succinct Non-interactive Argument of Knowledge”/“Scalable Transparent Argument of Knowledge”):

SNARKs and STARK ([BBHR19] “Scalable zero knowledge with no trusted setup”) is a succinct proof that a certain statement is true.

SNARK/STARK format can be used to prove a statement that a computation has occurred with the given input (the input is called a witness in SNARK, because it can be used to demonstrate the computation occurred with that argument).

Succinct Non-interactive Arguments of Knowledge (SNARKs) are non-interactive systems with short proofs (i.e., independent of the size of the witness) that enable verifying computations with substantially lower complexity than that required for classical verification, which is suitable for our case as verification should occur on-coin and thus must be as short and succinct as possible.

Justin Thaler's book “Proofs, Arguments, and Zero-Knowledge” has a comprehensive elaboration of these methods, with all necessary substantiations and explanations of how and why SNARKs work: https://people.csz.georgetown.edu/jthaler/ProofsArgsAndZK.pdf

The following work is a good in-detail description of a particular specific algorithm/approach of SNARK realization “Why and How zk-SNARK Works”: https://arxiv.org/abs/1906.07221

The following publications are less formal but descriptive in a simple way, with palpable examples: “ZK-Snarks and Their Algebraic Structure” http://coders-errand.com/zk-snarks-and-their-algebraic-structure/
“Securing a Blockchain with a Noninteractive Zero-Knowledge Proof” https://www.altoros.com/blog/securing-a-blockchain-with-a-noninteractive-zero-knowledge-proof/*note,
note, the ZK (Zero Knowledge) part is optional addition, which is coupled to SNARK/STARK algorithms.

A SNARK/STARK systems are succinct, complete and knowledge-sound.

“Proofs and arguments of knowledge. The notion of a proof or argument of knowledge is meant to capture situations in which a prover establishes not only that a statement is true, but also that the prover knows a “witness” w to the validity of the statement.”

Formal substantiations are out of the scope of this document, they include a building blocks concepts as circuit-satisfiability, extractability of a polynomial commitment scheme etc., as well as and what makes it complete and knowledge-sound.

All may be found in: “Proofs, Arguments, and Zero-Knowledge” book.

Zero-Knowledge proof or argument—captures the notion that the verifier should learn nothing from the prover other than the validity of the statement being proven. That is, any information the verifier leams by interacting with the honest prover-could be learned by the verifier on its own without access to a prover-“Proofs, Arguments, and Zero-Knowledge” book.

As stated above, the article “17 misconceptions about SNARKs (and why they hold us back)” clears up all the subtle differences and confusions between definitions of SNARK, STARK, ZK and others.

The main conceptual description of an aspect of the methods considered herein:

An aspect of a method described herein (as its basis) requires realization of a three components:
(1) The mathematical induction over sequential interactions among UTXOs/transactions in forward, backward and sideward directions,
(2) The compression/succinctness,
(3) Zero-knowledge.
(4) The mathematical induction component consists of two parts, which are (a) the base/initial case and (b) the induction step.

We will use as example smart contract persisting feature of tracing its transaction path over blockchain DAG to some specific transaction (called genesis transaction), while the path could be required to be through specific single or multiple inputs of transaction.

That being said the method is not limited to this or any other specific use-case (used as example), meaning the condition of tracing back could be any other, e.g. a transactions path could be tracing back to a transaction that spent an output with standard locking script (P2PKH) which was locked to specific address. In such a case the traceback is not to a specific transaction (identified by its TXID) but it rather can be traced to one or multiple transaction sharing the same characteristic (of spending standard UTXO locked to specific address).

In some other examples, the path could be required to go through a transaction that was included in a specific block (or range/set of multiple blocks) or through some output that was spent by transaction included in specific block (or range/set of multiple blocks).

And the transaction path itself may have his own features requirement, e.g. going through specific inputs/outputs of transactions (inputs/outputs of specific indices), or any other.

And so on, meaning the method is not limited to any specific sequential/persisting interactions use-case, but rather may realized any required initial and/or step (subsequent) features.

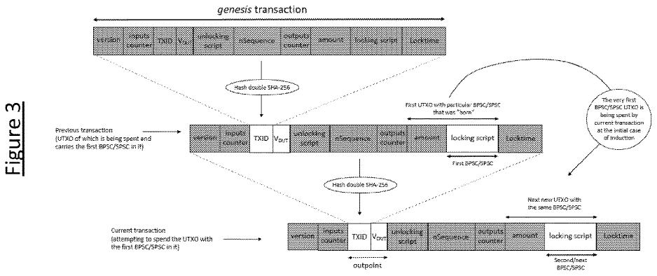

An example of smart contract enforcement of transaction path over blockchain DAG to some specific transaction (called genesis transaction):
I. The initial case contains a proof that the current UTXO, which is being spent, belongs to a transaction that directly spent in the past genesis transaction UTXO or otherwise this current UTXO cannot be spent. Such a transaction may be called ‘an immediate transaction’.
   The initial case may be achieved through either of the following methods:
      1. Through on-chain in-script (inside UTXO locking script) implementation:
         a. OP_PUSH_TX method with providing and verifying “sighash preimage” which then is parsed to extract the transaction ID (TXID) of the UTXO being spent and its internal index (Vₒᵤₜ).
         b. Providing as additional parameter (in unlocking script) the whole preceding transaction (to which belongs the current UTXO, which is being spent) to verify its genuineness through hashing it and comparing to the TXID (of corresponding outpoint-a pointer, carried by any transaction input, to previous UTXO that was spent through that input) extracted from sighash preimage.
         c. Parsing the above verified whole preceding transaction to locate, extract and compare genesis TXID from outpoint of one of its input fields, which constitutes the proof that the preceding transaction had spent a UTXO that belongs to the genesis transaction. QED-it. FIG. 3.
         For in-script implementation of initial step of the induction see: Code Example 1.
      2. Through any of a SNARK/STARK-based methods:
         the initial case could be implemented roughly by creating a proof by (i) having genesis TXID hardcoded in the circuit configuration and (ii) having the rest of the data of the preceding transaction as two witnesses (one part is the transaction data preceding the genesis TXID, the other is following it), in addition having as public inputs (iii) the TXID of transaction to which the UTXO being spent belongs and (IV) the smart script (locking script of that UTXO) code. In addition to these main public and witness parameters and circuit configuration parameters, other per-case conditions should be implemented e.g. of input/output location inside the transactions. Eventually, this generated SNARK proof must be provided as an additional parameter in unlocking script (script Sig) for execution of verification code by that UTXO.
II. The induction step case contains a proof that the current UTXO being spent belongs to a transaction that spent a UTXO which was a descendant of the genesis transaction with a more-than-one transaction distance from the genesis in the chain (namely, any number of transactions in between bigger than one) or otherwise this current UTXO cannot be spent. Such a transaction may be called ‘a subsequent transaction’.
   In case of BPSC, the method enforces its preservation of persistency backward to the previously created outputs in the preceding transaction. Specifically, a UTXO cannot be spent if the preceding UTXO is not the same (except for specific fields that are allowed to be variable, e.g. owner address). Because the method has applied the same BPSC rule in the preceding UTXO, and by that enforced the preservation to its corresponding pre-preceding UTXO, and so on, the self-preservation of the BPSC traces back to the very first BPSC UTXO in the transaction chain. Back-to-Genesis persistency is thus guaranteed.
III. Combining implementations of induction step case with initial base case conditions ensures further that the very first BPSC UTXO was “born” legitimately aka spent some UTXO that belongs to genesis transaction. Specifically, the method enforces two conditions for spending a BPSC UTXO—the preceding transaction before the current transaction either must be the genesis transaction itself or its UTXO that was spent (to create the trace-back transaction chain) must have the same BPSC (except for specific fields that are allowed to be variable, e.g. owner address).

As has been described above, to ensure that the initial case is implemented properly, the genesis TXID may be immutably hardcoded part of either the BPSC itself or the circuit made in SNARK/STARK arithmetization, depending on implementation (either in-script or SNARK/STARK),

The method thus creates BPSC script, in which both parts of the induction (initial and induction step) described above, are implemented with specific genesis TXID hardcoded in it. When a user receives a UTXO with such a BPSC code, which is known-to-users to be properly implemented, it is assured that the UTXO carrying the BPSC is indeed traced back to the genesis transaction (ID of which is hard coded in the BPSC UTXO), or otherwise there is no way of spending such a UTXO (since its locking script would not allow it).

The described backward induction process of the linear chain form may be extended to funnel-shaped one by simply re-iterating the whole backward induction process among inputs of the same transaction (in other words, combining backward and sideward sequential/persistent interactions), that is to prove that multiple (more than one) UTXOs being spent by current transaction are traced back to specific genesis transaction, while these UTXOs may have either completely separate or intersecting (in some past transactions) paths tracing back to the genesis transaction over the blockchain DAG.

The induction assures that a UTXO is being traced back (either linearly or in funnel-shape, using sideward interaction too) to its corresponding genesis transaction, but the traced transactions chain could be terminated voluntarily by the UTXO owner by just spending the UTXO with/by transaction with next newly created output/s not carrying the same UTXO BPSC locking script.

Which may be satisfying for some use-cases, but not for the others e.g. tokens issued for legal representation of monetary units by protocols at which genesis transaction is the issuance transaction and ability to trace back to it constitutes the authenticity of the token, while users shouldn't be able to disrupt the embedded in the tokens authenticity verification capability.

In these cases the BPSC (including or not sideward interactions) script in UTXO should be upgraded to be also Forward Persistent Smart Contract (aka FPSC), which persists itself (to be precise, persists its code to constitute previous and next output/s locking script/s) in backward (and optionally sideward) and forward directions.

As already stated, the forward persistence may be achieved either through SNARK technology or in-script with the help of OP_PUSH_TX method, as described extensively in WO2022118263A1. While, typically, for the backward (and sideward) persistence, the technology of SNARK/STARK is used in order to avoid the problem of transactions increasing substantially in size through a chain of transactions.
(2) Compression/succinctness—as already stated, since the mathematical induction method is SNARK/STARK based, the method naturally provides the feature of succinctness/compression, embedded in it.
(3) Zero-knowledge—and since every SNARK/STARK algorithm/protocol inherently coupled with zero-knowledge feature as an option, the option of the zero-knowledge feature (ZK) is naturally supplied by the method as well.

### Further Detailed Method Description:

Although the method may be implemented for tracing transaction chain going through specific-only, some or all inputs/outputs of transactions, to simplify demonstration of the method we will start from a simple example of transaction of a form carrying single input and single output only (linear case).

Code Example 2 demonstrates a smart contract implementing (through OP_PUSH_TX technique, using only Bitcoin script) enforcement of:
1) forward (only) persistence of smart contract
2) transaction form of single input and single output throughout the chain of its forward transaction events on blockchain

The example uses optimized sighash preimage version.

Note, a token feature may be easily added to this smart-contract example, and that for either token implementation type-native-token-based (NTB) or data-fields-based (DFB).

See previous in-script examples of implementation of both NTB-“WO 2022/118263” and DFB-https://xiaohuiliu.medium.com/non-fungible-tokens-on-bitcoin-sv-4575368 f46a or https://xiaohuiliu.medium.com/utxo-based-layer-1-tokens-on-bitcoin-sv-f5e86a74c1e1.

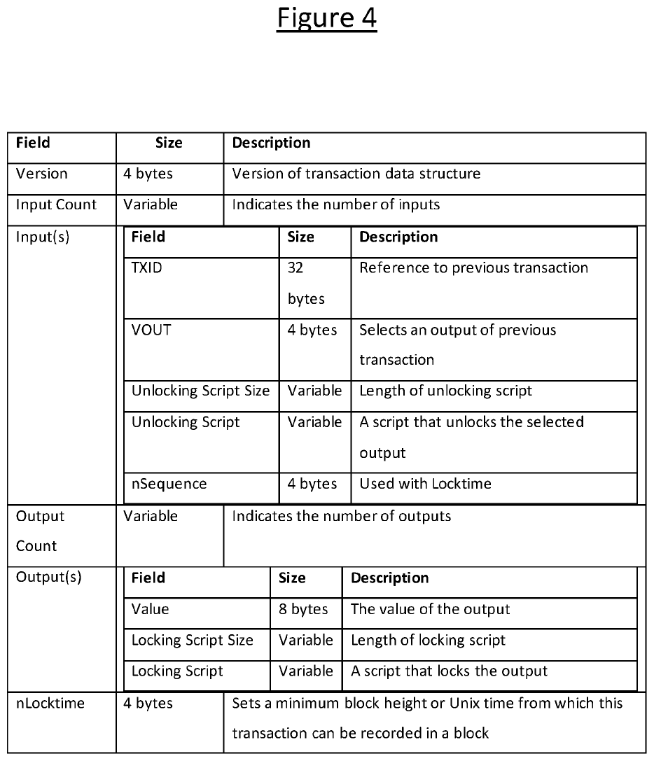

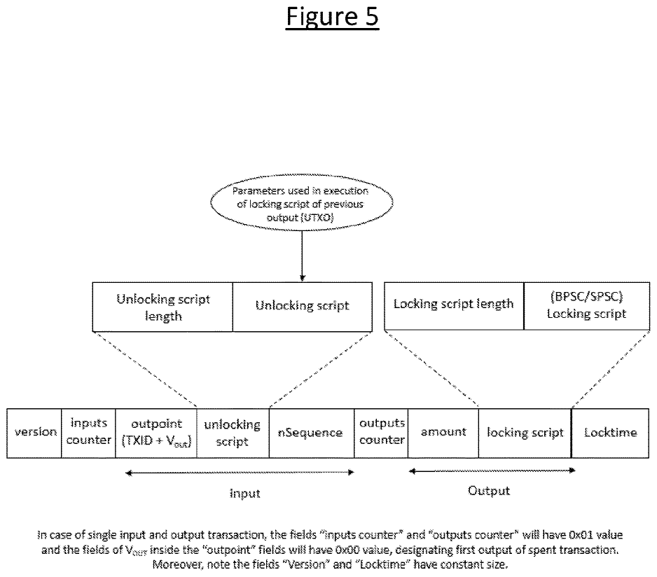

As described above, FIG. 4 depicts the internal fields of general Bitcoin transaction, used in UTXO-based blockchains and FIG. 5 depicts simplified specific structure of single input and single output transaction of such a Bitcoin transaction, used in UTXO-based blockchains.

It can be seen that every input of a transaction contains a reference to previous transaction (TXID) and an index (V_{OUT}) of the output (UTXO, is still unspent) of that previous transaction, which is being spent through this particular input. As already defined, the TXID and the output index are collectively called-outpoint.

In addition, it's seen that every output of such a transaction includes the locking script (which constitutes the smart contract).

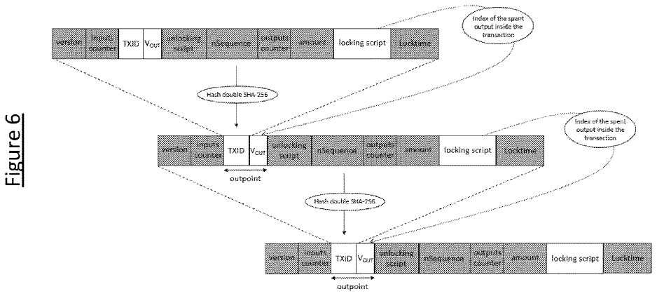

The reference/pointer TXID to previous transaction is calculated by applying double SHA256 hashing algorithm on the whole data of the previous transaction, including (1) locking script/s of its output/s and (2) its own preceding transactions/UTXOs references (TXID+V_{OUT} aka outpoints). FIG. 6 depicts it.

In our example of such a single input and output transaction, the fields “inputs counter” and “outputs counter” will have 0x01 value and the fields of V_{OUT} inside the “outpoint” field will have 0x00 value, designating first output of spent transaction.

Moreover, note the fields “Version” and “nLocktime” have constant size (the fact that may be used for transaction parsing to enforce specific conditions, e.g. to locate specific inputs/outputs of more complex transaction composition).

Using OP_PUSH_TX method we may verify authenticity of the fields of the spending transaction inside execution of the locking script of UTXO, that is being spent by that transaction, while such an execution happens in a context of a specific input, to unlocking script of which the spending transaction fields were passed/provided either as part of sighash preimage or separately (some transaction fields aren't in sighash preimage as they are, but rather present only as their hash digest, against which the fields authenticity may be valid ated if hashed first-next locking script/s, outpoint and nSequence fields of mate inputs) in order to serve as parameters for the execution of the locking script.

Simply put, at the time of evaluation of UTXO's spending validity, we may have an access to the verified fields of the (1) outpoint of the UTXO and (2) its own BPSC/SPSC script code (the locking script) being executed (as both of them constitute parts of sighash preimage, that should be passed in unlocking script as parameter for OP_PUSH_TX realization).

Since a UTXO, carrying locking script with some BPSC/SPSC code by definition can be spent only if its preceding UTXO in the traceback transaction chain had the same BPSC/SPSC code in its locking script, and the same is true for all the preceding UTXOs along the traceback of transaction chain back to its very genesis transaction, our goal is to prove that this current outpoint belongs to transaction that as well (in its turn) spent in the past a UTXO carrying locking script with the same BPSC/SPSC code (except for specific fields that are allowed to be variable, e.g. owner address), which in turn is referred/pointed-out by its own similar outpoint (residing in its own transaction fields). FIG. 6.

If we can prove this (carrying locking script with the same BPSC/SPSC code) regarding the preceding UTXO in the traceback chain, then combining it with implementation of initial case of induction process would yield a complete solution for back-to-genesis transaction trace problem.

Or alternatively put, if a user creates a UTXO containing a BPSC/SPSC while the corresponding direct parent (meaning with no transactions in between in the traceback chain) transaction ID is not identical to the genesis transaction ID that was hardcoded inside that BPSC/SPSC for initial case of the described induction method, this UTXO becomes impossible to spend as it is impossible to fulfil any of the two conditions coded in it for spending: having (i) the same script in preceding UTXO in the traceback chain or (ii) having genesis transaction as direct parent transaction in the traceback chain.

Therefore it may be asserted that for a UTXO carrying BPSC/SPSC in its locking script, which is known to correctly implement these two above conditions (i) and (ii), the fact of its (UTXO's) possibility to be spent per se constitutes a proof of its correct traceback to its genesis (TXID of which is hardcoded in its BPSC/SPSC) transaction on the blockchain, as the same is true for all the UTXOs preceding it in the traceback transaction chain back to their common corresponding genesis transaction.

Note, the genesis TXID (and implementation of verification that this TXID belongs to direct parent transaction-induction's initial case) inside that BPSC/SPSC script may be hardcoded either explicitly in-script or as part of SNARK/STARK circuit configuration. The same is correct to state for forward persisting conditions when the use-case requires bi-directional persisting smart contract features. But the backward (and sideward) persistence implementation requires the use of SNARK/STARK technology.

### SNARK/STARK Realization of Backward Persistence Smart Contract Conditions:

Let us consider the statement being proved to be a knowledge of all the data of some transaction, so that applying double SHA256 hashing algorithm on this transaction data results in specific TXID (while the TXID is known to verifier, but the transaction data is not).

Again—a statement of a prover's (Alice's) knowledge of unknown to the verifier (Bob) transaction data which results in specific TXID when double SHA256 is applied on it.

Furthermore, a statement may be of Alice's knowledge of parts of transaction data unknown to Bob, which when correctly concatenated with known (to Bob and Alice) parts of that same transaction and hashed though double SHA256 result in specific TXID (known to Bob and Alice). The unknown to Bob data inputs would serve as witnesses, as they can be used to demonstrate that the computation occurred with these data inputs as arguments.

Specifically, in our case these known in advance to Alice and Bob (prover and verifier) parts of transaction may be the constant code of BPSC/SPSC, which are immutable along the transactions chain traced back to its origin—the genesis transaction, while other parts of transaction are variable and change at each hop along the transaction chain and would constitute witnesses, whereas the specific TXID constitutes the public (known to prover and verifier) output and is a hashing result parameter of the computation we are proving, this public output parameter is also variable and changes each transaction hop in the chain.

Simply put, there are two public parameters (input and output), one of which is constant through the transactions chain while the other is variable as a function of another variable inputs parameters which are private (witnesses). The public parameters are used by both sides for proof creation and proof verification, while the private ones only for proof creation (by the prover side).

As has been described above, a validating node that is validating a transaction executes the locking scripts (of UTXOs being spent) by combining these locking scripts with corresponding unlocking scripts that have been provided in the inputs of current spending transactions. If for all inputs of the spending transaction the unlocking script parameters are correct then all the executions succeed and the whole transaction is determined as valid (included by miners in the blockchain ledger), otherwise if for any of the inputs the execution fails then the whole transaction is rejected and none of its UTXOs is spent.

Executions happen in a context of a specific inputs of spending (current) transaction, at these executions there are no participants apart from locking and unlocking scripts, while locking scripts belong to UTXOs i.e. to the preceding transactions and unlocking scripts to the inputs of the current transaction, attempting to spend the UTXOs. In a straightforward manner, there is no direct practically feasible access from within those scripts executions to a data on the blockchain of other transactions that precede the current one attempting to do the spending. The previously suggested method https://xiaohuiliu.medium.com/peer-to-peer-tokens-6508986d9593, provides access to the verified data of two transactions preceding the current one, but causes an exponential growth in transaction size along the traceback chain of transactions, thus is not practically feasible. The straightforward use of OP_PUSH_TX technique (as described in WO2022118263A1) provides access (more precisely, parameters are passed in unlocking script but then verified within script execution as identical to real transaction fields) from within script execution only to the verified data of the contents of the UTXOs being spent (the locking script and sometimes the amount, if it's an optimized sighash preimage), which belong to preceding transactions. For our method It's also important to notice that from current transaction the outpoint field of inputs may be accessed from within the executions with the help of the same straightforward use of OP_PUSH_TX technique. The straightforward use of OP_PUSH_TX technique has a constant size cost and doesn't cause growth of transaction size along the chain of transactions.

In the light of the above, in our case we may define as Alice (prover) the user attempting to spend UTXO containing BPSC/SPSC locking script by submitting spending transactions to miners, who may be defined as Bob (the verifier), since they in their turn perform the described above executions of each of the locking scripts of UTXOs that current transaction is attempting to spend.

Note, at the very start of the process there is a pre-processing procedure (setup) which pre-processes a given computational program interpreted in an arithmetic/algebraic circuit, which eventually results in distributing of public verification parameters (usually just called keys) for both prover and verifier. The pre-processing may be with or without trusted setup, which in turn may be per-circuit or universal and updatable, all the depending on the SNARK method of choice.

Informally speaking, public verifier parameters (keys) are “summarizing” the circuit for the verifier, they are needed for the verifier in order to know what computational statement he/she is verifying. The verifier keys may remarkably “condense” huge circuits in a tiny strings (keys) allowing fast and succinct verification that the proof is correct. Once SNARK/STARK circuit is constructed with its general and specific rules to be enforced, it's used by each transaction along the traced back transaction chain.

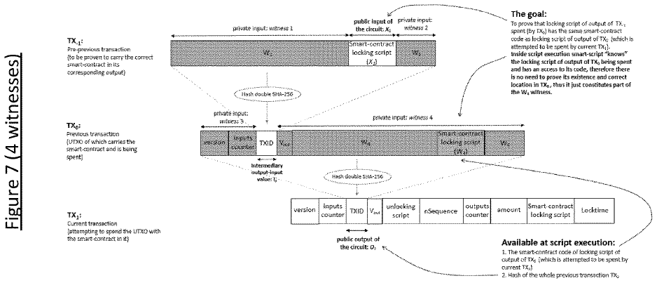

Hereby, we may construct a statement (that needs SNARK/STARK for its realization and verification) of computational relation/function that would satisfy our BPSC/SPSC functionality requirements, using only preceding and pre-preceding transactions data as private and public inputs/outputs of that relation. The flow of the relation/computation is described in FIG. 7. The relation is defined by the verification keys (parameters) generated at pre-processing step and may be used to prove knowledge of all the private witness inputs (grey in FIG. 7), so that given a public input of specific BPSC/SPSC, the flow of concatenations and series of SHA256 hashing described above in relation to FIG. 7, would result in another given public parameter—the TXID from outpoint of UTXO being spent (by TX₁ at FIG. 7).

The parts of the transactions data, involved in our SNARK/STARK circuit flow, may be divided into:
1) Constant along the traceback transaction chain, such as—all BPSC/SPSC constant code parts, (and e.g. genesis TXID, if chosen to be implemented through SNARK and not in-script).
2) Variable along the traceback chain, but known inside each script execution-particular TXID of the outpoint of UTXO being spent;
3) Variable along the traceback chain and unknown to verifier (inside each script execution)-all the data of the two preceding transactions (TX₀ and TX₋₁ in the FIG. 7) apart from BPSC/SPSC constant code parts
there is also fourth internal type-which is intermediary data output-input passed among internal steps of circuit, but it is not used as an external input to the circuit and isn't required to be known by neither prover, nor verifier. In our case-it's an outpoint of BPSC/SPSC UTXO of TX₋₁, stored in input of TX₀.

The first (1) type of data is a public parameter which is used by both sides for proof creation and proof verification (but not genesis TXID) and is immutable along the transactions chain traced back to its origin—the genesis transaction.

The second (2) type of data constitutes a public output (may be called a public statement) of the SNARK circuit, also known-to and used-by both sides for proof creation and its verification (changes at each hop along the transaction chain).

The third (3) type of data constitutes all the witness inputs, known to the creator of the proof (Alice) only (also changes at each hop along the transaction chain). More precisely, (looking at FIG. 7) Alice can prove a statement that-she knows (1) some data (W₁) that if concatenated to (2) known constant smart-contract script code from the left side and she knows (3) another data (W₂) that if concatenated to the previous concatenation result from the right side, then passed through double SHA256 to get (4) some intermediary (I₀) result (which is not necessary for her to know in advance), then if in addition she knows (5 & 6) some third and fourth data (W₃) and (WA) that if concatenated to the intermediary result from the left and right respectively and then passed again through double SHA256-results in public (from outpoint of UTXO being spent, known to verifier) TXID string.

Note, during verification inside script execution smart-script “knows” the locking script of output of TX₀ being spent and has an access to its code (through parsing sighash preimage after OP_PUSH_TX validation), therefore there is no need to prove its existence and correct location in TX₀, thus it just constitutes part of the W₄ witness.

Roughly, as shown in FIG. 7 and as described above, the task constitutes of:
1. a public input surrounded by 2 witnesses-pre-preceding transaction (TX₋₁)
2. an intermediate hash result surrounded by 2 witnesses-preceding transaction (TX₀)
3. a public output-hash result of preceding transaction (TX₀)

In short, for a given two known (to both sides, Alice and Bob) parameters-TXID (from outpoint of UTXO being spent) and BPSC/SPSC script, Alice provides to Bob a proof, which is argument of Alice's knowledge (SNARK) of all the witness parameters that when used together with these two known parameters hold the computational relation/statement (series of concatenations and SHA256 hashing in particular order) described by FIG. 7 as correct (computationally results in Boolean value of TRUE).

Which would basically mean that for a given TXID: 1) transaction data (TX₀) hash of which resulted in this TXID included given BPSC/SPSC script and 2) it in its turn included TXID of its preceding transaction (TX₋₁) which as well included this exact given BPSC/SPSC script in its output.

Reminder, for a UTXO carrying BPSC/SPSC in its locking script, which is known to correctly implement the initial and induction steps of the process, the fact of its (UTXO's) possibility to be spent per se constitutes a proof of its correct traceback to its genesis (TXID of which is hardcoded in its BPSC/SPSC) transaction, thus our goal is nothing more than just to prove that the pre-preceding transaction TX₋₁ contains the same BPSC/SPSC code in its UTXO (which was spent by TX₀) as the UTXO being spent (which belongs to TX₀) at the time of its script execution by TX₁, this would constitute the correct implementation of the induction step (FIG. 7).

The circuit flow described at FIG. 7 satisfies the prove that “pre-preceding transaction TX₋₁ contains the same BPSC/SPSC code in its UTXO (which was spent by TX₀) as the UTXO being spent (which belongs to TX₀) at the time of its script execution by TX₁”, apart from one bit, which is that the internal location of outpoint TXID of TX₀ and outputs with BPSC/SPSC code of TX₋₁ must be proven to be located in their correct corresponding transaction fields, which are input outpoint (of TX₀) and output locking script (of TX₁) respectively.

### Separation of Constant Code and Data Fields:

Important to mention, that implementing initial case of induction in SNARK/STARK circuit would mean that for every new use of genesis transaction (new chain creation) the arithmetization circuit would need to be recreated again, as the hardcoded genesis transaction ID would be expressed in both proving and verifying public parameters created at the time of pre-processing.

Whereas initial case implemented in-script (inside UTXO locking script) would allow use of the same proving and verifying parameters for the same given constant code of (FPSC/)BPSC/SPSC for various genesis transaction IDs. As example, tokens case described in WO2022118263A1-various tokens issued with their own genesis transactions, where tokens authenticity defined by having a transaction traceback to its own corresponding genesis transaction.

As we stated above and as in tokens example in WO2022118263A1, persisting smart contracts execution preferably to be explicitly terminated when it reaches OP_RETURN command/function-call of the script, which serves as protection from appending additional commands to the (FPSC/)BPSC/SPSC by adversary and also allows attachment of data fields behind the OP_RETURN opcode of the script, since the execution flow of the script does not reach the data fields, but the data still may be used by the executed code as parameters. Therefore for some use-cases the constant code of persisting smart contract may be preferred to be considered up-to (and including) OP_RETURN command, because data fields may vary from contract to contract (from one transaction chain to another) and even from transaction to transaction of the same contract (if the smart contract is of appendable or fully-mutable data type). The genesis transaction ID hardcoded in-script should be placed at those data fields as it's a variable parameter for different persisting smart contracts, e.g. tokens.

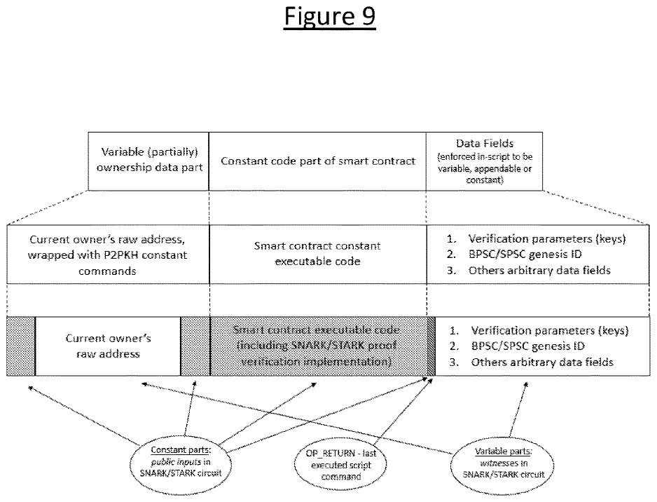

The constant code part of persisting smart contract up-to (and including) OP_RETURN command should be defined as public input of the SNARK/STARK circuit and used for both proof creation and verification, while data fields following OP_RETURN should be part of the adjacent (from the right) witness parameter, FIG. 9. The verifier side (at the time of script execution) has access to the whole script of UTXO it spends (through OP_PUSH_TX) and thus may use only part of it (up to OP_RETURN) for verification purpose.

Moreover, if (FPSC/)BPSC/SPSC is not monolithic and carrying inside its code part variable fields, e.g. current owner address etc., then further additional input parameters should be used in the circuit configuration to introduce that variable fields as additional witnesses. Note, such a witness inputs (if are not located at the very edge of (FPSC/)BPSC/SPSC) may be dividing the (FPSC/)BPSC/SPSC into constant code parts surrounding these witness inputs (e.g. of variable owner address etc.), in this case all surrounding code parts must be defined as separate public inputs of the circuit and therefore used for both proof creation and verification, FIG. 9.

Speaking about ownership relay through addresses, If particular use-case requires to preserve privacy by hiding addresses of newly created UTXOs (by current spending transaction), then the forward persistence may be considered to be implemented in SNARK/STARK circuit and not in-script.

Otherwise the next-UTXOs addresses must be passed as parameter into unlocking scripts, so that the execution would be able to construct (by concatenating the addresses with other parts of their corresponding locking scripts) a complete next UTXOs scripts and validate their forward self-persistence integrity.

### Verification Parameters (Keys):

Verification parameters/keys (such as MethodID/ImageID described below in “Zero Knowledge Virtual Machine (ZKVM)” section) generated at pre-processing step are constant and does not change from one transaction to another along the traceback transaction chain.

Moreover, since they are just a “condensed representation” of specific circuit configuration (which in its turn represents the computational statement), they are independent of the specific (FPSC/)BPSC/SPSC implementation, which may vary as it is just a public input parameter of the configured circuit, and therefore may be used for any correctly implemented (FPSC/)BPSC/SPSC.

The (FPSC/)BPSC/SPSC code includes verification of execution of specific circuit configuration implementation, for which the circuit-representing parameters/keys are necessary data input at the execution time (without them verification does not “know” what computational statement is being verified), along with its own (FPSC/)BPSC/SPSC code and TXID of the outpoint of the UTXO being spent.

Therefore, the (FPSC/)BPSC/SPSC UTXO issuer (that makes the very first such a UTXO), who is spending output of genesis transaction, should preferably assign the verification keys in the data fields (behind OP_RETURN) of the (FPSC/)BPSC/SPSC code in the first UTXO he/she creates.

Especially, when using ZKVM technique, the verification of execution of specific circuit configuration implementation may be similar/identical for distinct SNARK/STARK circuit configurations of various programs used by distinct smart contracts.

To avoid changing of original verification keys by users further down the transaction chain, an enforcement of forward persistence (preferably implemented in-script) must be implemented; the enforcement that includes the required data fields (that include verification keys) behind OP_RETURN, in order to keep verification parameters (keys) immutable along the transaction chain.

To clarify, for proof creation and verification only the SPSC code up-to (including or not, depends on implementation type) OP_RETURN is used as public input in the circuit, while the following data fields behind OP_RETURN belong to the witness inputs of the circuit. Even though the whole witness inputs are variable from hop to hop in the chain and are unknown to the verifier at the time of execution, the constant verification keys may still be part of the witness since their immutability is guaranteed through forward persistence part of the smart contract.

Therefore to summarize, the transaction data participating in verification of correct off-chain execution of in-circuit implemented program should be distributed and located as following:
1. Genesis transaction IDs and verification parameters (keys) made at pre-processing step-despite being constant along the particular transaction chain are placed behind OP_RETURN in (FPSC/)BPSC/SPSC locking script.
2. The variable SNARK/STARK proof-placed in unlocking script passed as parameter for the execution of SPSC.
3. The variable TXID from the outpoint of UTXO being spent-extracted from sighash preimage passed in unlocking script as part of OP_PUSH_TX realization.
4. Self (FPSC/)BPSC/SPSC code of the UTXO locking script, which is being executed (up-to OP_RETURN command)-constant and known in advance, extracted from sighash preimage passed in unlocking script as part of OP_PUSH_TX realization.
The (3) and (4) are public inputs/outputs of the SNARK/STARK circuit, used for both proof creation and its verification.
The verification parameters/keys (1) are used only for verification, inside on-chain script execution.

### Additional Technical Requirements:

Even for our simplest example of single input and single output transaction, if internal locations of the TXID and the BPSC/SPSC code are not enforced, the ad vers ary may put TXID in an input or output of transaction as part of their unlocking/locking scripts or similarly the BPSC/SPSC code may be put in an input as part of its unlocking script. It would get worse for transactions which allow more than one input and/or output, as e.g. the BPSC/SPSC could be part of the TX₋₁, but not in the output the TX₀ spent.

For our simplest transaction form (of single input and single output), in addition to FIG. 7 SNARK/STARK circuit configuration, the following has to be enforced:
1) The intermediate TXID of outpoint which is part of TXois located in its correct place, the witness 3 may be required by the circuit to be of a length 5 (first 4 bytes of version and one byte for inputs counter.
2) In order to enforce for the first output of TX₋₁ to have the smart-contract code in it, one needs to enforce parsing of TX₋₁ with the help of: “inputs/outputs counters” values, fields with fixed length as Version, nSequence, nLocktime and outpoint (32+4 bytes) and fields designating length of following them data or/and prefixes from which length-fields own length may be deduced (see VarInt: https://learnmeabitcoin.com/technical/varint).

For more complex forms of transaction (e.g. with multiple inputs/outputs) and configurations of the trace of chain of BPSC/SPSC UTXOs (allowing merging and/or atomically swapping of BPSC/SPSC UTXOs), depending on their requirements, more sophisticated rules enforcement may be needed in order to coordinate and locate the desired input/s and/or output/s inside the previous TX₀ and pre-previous TX₋₁ transactions (respectively), which in vast majority of cases coming down to parsing the transactions through their fields, such as script (locking and unlocking) length, “inputs/outputs counters” and some of the fields which have fixed specific lengths and values (e.g. “input counter” to carry the value not bigger than two if maximum number of inputs in transaction is not allowed to exceed it).

It is important to note, that for any case (even for the simplest of single input and output transaction) enforcement of the following rules is typically implemented for the method:
1. Internal location of outpoints TXIDs of TX₀ and BPSC/SPSC code of outputs of TX₋₁ (in non-linear cases, that includes BPSC/SPSC code of outputs of TX₀ too) participating in persistence-must be enforced to be located in their corresponding transaction fields, which are their specific input outpoints and output locking scripts fields (respectively). Which involves concordance/mapping of the output indices (Vₒᵤₜ) from outpoints of preceding TX₀ with actual index/location of the outputs (spent through these outpoints) inside TX₋₁ (should be enforced through SNARK/STARK circuit configuration).
2. To avoid from adversary appending unplanned functionality code to known BPSC/SPSC code (e.g. adding more functional code to smart-contract script of TX₋₁, while relating code-addition in SNARK/STARK circuit to private parameter witness 2 (from FIG. 7) instead of ‘script’ public parameter, thus deceiving the verifier with successful proof that TX₋₁ script is the same as in TX₀, while in reality its functionality was extended), the execution termination of code carried by ‘script’ public parameter be must validated inside the SNARK/STARK circuit.

Note, not necessarily all the locking script code may be used as public ‘script’ parameter in SNARK/STARK arithmetic circuits, e.g. the data of the locking script behind OP_RETURN opcode may be enforced by some smart contracts to be constant/fixed, but by others it may be enforced as appendable (e.g. from one TX to another more data can be added to the end of the smart contract, but the already-existing data cannot be removed or modified) or even fully-mutable (so the smart contract is persisting, but only partially-up to OP_RETURN opcode; the rest may be completely different from one TX to another).

There are many ways of validation of execution termination of code carried by ‘script’ public parameter, as example: the last (or earlier than last) command (opcode) of the public input (BPSC/SPSC script parameter) should be enforced to be OP_RETURN by SNARK/STARK circuit definition. Or alternatively, the first byte of witnesses 2 (from FIG. 9) may be enforced to be OP_RETURN, as witness 2 is the one concatenated to the BPSC/SPSC public ‘script’ parameter from the right side (see FIG. 9).

In that case the adversary code addition would not be part of a public input parameter anymore, and since any addition behind OP_RETURN command of the script is not participating in script part executed by miner, the adversary code addition becomes just a data-fields attachment to the script functional code. And as long as it's impossible to tamperthe code of the functional part of the script, the data-fields part is governed by the code of the functional part of the script itself (and, as noted above, could be of any nature-constant, appendable or fully-mutable throughout the chain of transaction events on the blockchain).

### The SHA256 (or Other Collision-Resistant Hashing Algorithms) Properties:

Another point to consider is, if the prover could cheat by finding another data which is not from original preceding transactions (TX₀ and TX₋₁) on blockchain, but has the same TXID outcome when used as input into the same arithmetic circuit. The following addresses this concern:

The SHA256 hashing algorithm is a one-way function known to be a collision-resistant, meaning that:
1. From the given output of SHA256 it's practically impossible to deduce the input of SHA256 that resulted in that output value,
2. It's probabilistically impossible (with today's computation power capability) to find two different inputs that resulted in the same given output SHA256.

Informally put, it is impossible to know preimage of TXID of the current TX₁ transaction input outpoint, if it wasn't available in advance to the transaction spender (e.g. from inspecting preceding transaction on the blockchain).

As well as, practically speaking for each given outcome of SHA256 there is only single unique solution (preimage) that is used as an input for SHA256 to result in that given outcome, meaning it's impossible for adversary to come up with another non-genuine solution.

Therefore, given the above two properties of SHA256 hashing algorithm it may be asserted that Alice, if provides a SNARK/STARK proof which is argument of knowledge of the unknown to Bob witness parameters, knows all the unique data of two preceding transactions (TX₀ and TX₋₁) and both of these transactions have the same given BPSC/SPSC (or at the very least-its functional code part) in corresponding locking scripts of their output. QED-it.

Note, this assertion presumes that Internal location of outpoints TXIDs of TX₀ and BPSC/SPSC code of TX₋₁ are enforced to be in their corresponding transaction fields, which are their specific input outpoints and output locking scripts fields (respectively).

Also note that due to collision resistance property of SHA256—the attack is possible only by creating legal transactions, which is following the defined transaction format.

Namely, it's impossible to come up with some random sequence that if concatenated to script code may be used for the attack. It only possible first to create and transmit transactions, and after their inclusion in blockchain's blocks, use the transactions' TXIDs to try to play/cheat with verification process. More specifically, the only possible way to cheat is to create transaction according to their defined format by misplacing script position within the TX₋₁ transaction, having first and second witnesses covering other than expected parts of that TX₋₁ transaction.

As example, the misplacement may be (1) into some input fields using OP_PUSHDATAx <data>, which is just unused (e.g. dropped by OP_DROP) during execution, or alternatively (2) the script could be placed in an output but being only part of the whole other output script, e.g. not being executed at all (OP_RETURN <data>, or OP_FALSE OP_IF <data> OP_ENDIF) (3) or being an addition to some other script code. The same is relevant for TXID of pre-preceding transaction, which normally is assigned into preceding transaction TX₀ as part of outpoint field of its input, pointing to pre-preceding UTXO being spent. Namely, the TXID may be located in other than first input's outpoint field (e.g. in TX₀ output script just as a code never being executed during script verification, that is serving just as a data attachment: <some other script code> OP_RETURN <data>), so that the format of preceding transaction TX₀ remains to be legal (by defined fields), but the TXID may be pointing to some dummy transaction that was created off-chain (only to determine the TXID) and never was or even could be transmitted (for being completely unrelated to any real past existing TX₋₁ transactions/UTXOs ever happening on the blockchain).

The combination of these two requirements of (1) using collision resistant hashing algorithm and of (2) implementation of the requirements of previous section (“Additional technical requirements”) provides for the method the desired security.

Also note that any hashing algorithm may be used in current full-fledged smart contracts method as long as the algorithm is collision resistant.

As a reminder, SNARK/STARK remarkable feature is that verification part is succinct and doesn't require neither re-application of its computational statement (in our case, including the two double SHA256) nor knowledge of the corresponding witness inputs. The fundamental math reason making this feature possible is that-a univariate polynomial of degree d over finite field has only d roots. Verification time complexity is linear in the size of a public inputs and logarithmic in the size of the circuit. The size of the proof provided for verification is also logarithmic in the size of the circuit.

### Zero Knowledge Virtual Machine (ZKVM):

A SNARK/STARK is a cryptographic concept that allows one party (a prover) to demonstrate succinctly to another party (a verifier) knowledge of a certain fact or statement, while optionally keeping some sensitive input information confidential. The statement usually involves input/output parameters and a computational function (running on these parameters), at a set-up phase the function is arithmetized (translated into an arithmetic circuit) and condensed representation of this arithmetization (which serves as verification parameters/keys) is shared (along with some parameters, which are public and not witnesses) with the verifier side, so that the verifier will be able to know what functionality he/she is verifying (when provided with a proof).

Therefore for every different computational function of such a statement, its representation shared with the verifier side is different too. This different succinct circuit representation eventually is expressed in an each—time-different implementation of verification program on a verifier side.

In our case meaning, every on-coin smart-contract verifying some statement/relation (either a statement/relation of sequential/persisting transaction interactions events on a blockchain or any other arbitrary computation statement/relation which should be succinctly verified on-coin) would be different, which in turn would make it hard for wallets, blockchain browsers, (D) apps etc. to index, sort, identify and trace transactions/outputs by numerous distinct smart-contracts on the blockchain.

While the solution would be for all the smart-contracts to have a common generic shared universal (as much as possible) structure, while the differentiation (between smart contracts) would be realized only through some short parameter used for identification of every specific smart contract, verifying on-coin its specific different computational statement (of a prover).

This is exactly the concept of a Zero Knowledge Virtual Machine (ZKVM), a virtual machine that runs trusted code and generates proofs.

Namely, instead of creating an arithmetized circuit per specific computational statement, the circuit is configured to be generic suiting for general computation (thus it becomes constant), while each program representing specific computational statement of a prover is fed into this generic circuit as a parameter (instead of being arithmetized into its own circuit).

A very good example of such a ZKVM is “RISC Zero”, it's a ZKVM which implements ZK succinct proofs for the RISC-V instruction set, which is standard LLVM-compatible target. Its overview may be found here: https://dev.risczero.com/zkvm/“RISC

“RISC Zero” implemented a RISC-V circuit (https://docs.rs/risc0-circuit-rv32im/0. 16/risc0_circuit_rv32im/), which emulates rv32im. The rv32im circuit receives a RISC-V binary and some user specified inputs, and generates an execution trace (https://dev.risczero.com/proof-system/what is a trace), which is a complete record of the computation or a snapshot of the full state of the machine at each step (clock cycle) of the computation.

This rv32im circuit (in case of “RISC Zero”) is a mathematical construct that acts as the “CPU” of the zkVM in a manner that enables creating proofs, which are a cryptographic arguments that attest to the validity of an execution trace (a complete record of a computation).

“RISC Zero” zkVM application consists of a host program and a guest program. The guest program is the part of the application whose execution will be proven by the zkVM. The host program is responsible for executing and proving the guest program.

First, the code to be proven must be compiled from its implementation language into a method. A method is represented by a RISC-V ELF file with a special entry point that runs the code of the method. For a given method its Image ID/Method ID is computed, which is a specialtype of cryptographic hash of the ELF file, and is required for verification.

Or quoting RISC-Zero system overview of zkVM application (https://dev.risczero.com/zkvm/):

To prove correct execution of a zkVM application:
1. The guest program is compiled to an ELF binary (the executable format for the RISC-V instruction set).
2. The executor (the portion of the zkVM responsible for generating the execution trace) runs the ELF binary and records the execution trace.
3. The prover (the portion of the zkVM that uses the execution trace to construct the seal) checks and proves the validity of the execution trace, outputting a receipt.

A receipt attests to valid execution of a guest program. Verifying the receipt provides cryptographic assurance that the journal was indeed constructed using the expected circuit and the expected imageID (or MethodID). The receipt consists of a journal and a seal. The journal attests to the public outputs of the program, and the seal is the opaque blob that cryptographically attests to the validity of the receipt.
Anyone with a copy of the receipt can verify the guest program's execution and read its publicly shared outputs.

And the “Image ID” (or Method ID) is the small cryptographic identifier (precisely, just 32 bytes hash digest) that indicates the code (or bootimageforzkVM) that run inside the zkVM and produced an execution trace.

This short “Image ID” parameter serves for verifier as indicator of what program (computational statement/relation) he/she is verifying (when provided with a proof) while implementation of verification code on the verifier side may remain constant (as much as possible) for smart contracts that are different, for the reason that it always verifies the same arithmetized rv32im circuit of the “RISC Zero” zkVM.

All the full details of the RISC Zero ZK-STARK are described in RISC Zero “ZKP Whitepaper” (https://www.risczero.com/proof-system-in-detail.pdf) and their “Proof System Sequence Diagram and Spec”: https://dev.risczero.com/proof-system/proof-system-sequence-diagram

In other words, in order to create a whole smart-contracts-based industry, the smart contracts need a certain consistency which may be achieved by a usage of constant arithmetic circuits (as e.g. rv32im circuit of the “RISC Zero” zkVM) with a short smart-contracts identifiers (as e.g. Method-ID/Image-ID, in case of RISC-Zero), used also as verification parameter.

While such a consistency allows:
1. wallets, blockchain browsers, (D) apps etc. have a ‘common language’ used to interact with each other
2. specific smart contracts (or their parts) that their wide common usage turn them into accepted “standard”, to be grouped into a single (or several) newly defined opcode/s (by UTXO blockchains which policy allows it)
3. development of hardware FPGA/ASIC accelerations for such a common widely accepted standard scripts (which are sets of commands/opcodes).

In the light of the above, we will use “RISC Zero” zkVM system to demonstrate implementation of examples of current method use-cases as we expect for such a common generic way of implementation (through zkVM) of smart contracts to be sought by the industry in the future.

In the examples, the relevant code in “RISC Zero” system will be written in Rust language and usually will be spanned over 3 files of—guest, host and general definitions/configurations (core file). The examples will include a proper comments explaining every corresponding step of the programs.

In previous Code Examples 1 and 2 we demonstrated in-script (through OP_PUSH_TX technique, using only Bitcoin script) implementations of enforcement of:
1) initial step of the induction
2) forward (only) persistence of smart contract
3) transaction form of single input and single output throughout the chain of its forward transaction events on blockchain

And other previous works demonstrated an in-script token feature implementation of both types-native-token-based (NTB) and data-fields-based (DFB).

For NTB see WO2022118263A1; for DFB-https://xiaohuiliu.medium.com/non-fungible-tokens-on-bitcoin-sv-4575368f46a or https://xiaohuiliu.medium.com/utxo-based-layer-1-tokens-on-bitcoin-sv-f5e86a74c1e1.

As already mentioned, implementation of these features, along with any other vertical features, may be accomplished either in-script or in-circuit.

While in-circuit SNARK/STARK implementation is unambiguously required for practically feasible native on-coin realization of features of backward and sideward sequential (including persistent) interactions, succinctness and zero-knowledge.

Code Example 3 demonstrates backward persistence implementation, written in Rust language in “RISC Zero” system. All the code is divided into guest, host and definitions (core) files. This in-circuit implementation, if combined with in-script implementations of initial induction step, “linear” (1 input to 1 output) forward persistence (as in Code Examples 1 and 2 respectively) and token feature, may realize a complete linear bi-lateral persistence required for multiple token smart contracts, e.g. non-fungible token (aka NFT). Namely, such a linear NFT contract would enforce its forward replication requirement (making it impossible to be transferred/spent otherwise) and at the same time guarantee its authenticity, namely the mere fact of a possibility of its UTXO being spent per se proves that it is being a descendant of specific genesis transaction (TXID of which is hardcoded immutably and persisted as part of the contract itself)-all governed natively on-coin.

The Code Example 3 demonstrates an off-chain creation of a SNARK/STARK proof, which must be provided in unlocking script as a parameter for smart-contract, which when being executed performs the verification process, which among other things, includes induction step of backward persistence, for which the proof constitutes the necessary parameter.

The Rust code of verification process implemented in RISC-Zero system in function receipt. verify (METHOD_NAME_ID), which must bere-written in (e.g. Bitcoin) scripting language in orderto be integrated into native on-coin code of smart contracts.

Note the verification is based on SHA256 hash function, for which majority (or all) of UTXO blockchains have a native opcode, allowing relatively compact in-script implementation of this particular STARK verifier code.

Note, since in-script enforcement of transaction linear form of single input and single output is known to all parties, SNARK/STARK circuit code must only check for the correct location of the public script parameter inside pre-preceding TX₋₁ and intermediate parameter of outpoint TXID of preceding TX₀.

While the location of these parameters is determined by the lengths of transaction fields and not by their values, except for some fields which value affect their or following fields length, called VarInt (variable integer) values; e.g. input-counter field, which occupies one byte only if its value is less than 0xfc or script-length field, prefix of which is checked in-circuit to be 0xfd (meaning next 2 bytes determine length of a field following them) since its value affects the length of the script-length field. Because the location of these public and intermediate parameters is determined only by the lengths of transaction fields (with some exceptions), there is no need to check in SNARK/STARK circuit for e.g. existence of more than one output in these transactions (by checking values of output-counter fields) as well as no need to check the number of inputs in preceding transaction (let alone values of constant-length fields as ‘version’, ‘nLocktime’ etc.).

However the value of ‘input-counter’ field of pre-preceding (TX₋₁) transaction is still checked in-circuit and that for the reason that this transaction may be the first after genesis (so-called issuance), in which case the in-script enforcement (of transaction 1-to-1 form) would start only from the transaction following it (which is the preceding transaction or TX₀), meaning that if the number of inputs in pre-preceding transaction (TX₋₁) would be more one, fields of those multiple transaction inputs would be needed to be considered while calculating length of w1 (for they would shift the location of the script public parameter), moreover if the number of inputs were more than 0xfc then the size of the input-counter field itself would be more than one byte, which would shift even further the location of the script public parameter and outpoint TXID fields inside that transaction (TX₋₁). Therefore, we enforce a single transaction input (by requiring the input-counter field to have value 1, even though more loose condition of having value less than 0xfd would satisfy too).

However the value of ‘output-counter’ field of pre-preceding transaction (TX₋₁) may not be checked, as in addition to being enforced in-script anyway, even if its value was somehow (e.g. auxiliary non-persisting standard output may be allowed) more than one (but less than 0xfd) it wouldn't matter since the script location is still determined (by checking the length of witness 1) in-circuit to be in its correct place inside the first output of transaction TX₋₁, whereas if the ‘output-counter’ value was bigger than 0xfc it would increase the actual length of witness 1 parameter and thus (due to failure of witness 1 length check) undermine the whole computational statement and its respective creation of a valid SNARK/STARK proof.

Note, in all today's UTXO blockchains the location of fields inside transaction by definition is always determined in a left-to-right direction (parsing transaction starting from its left end), since this is how variable-length fields are defined, therefore this is how the correct location of the script (public input) TX₋₁ and its TXID inside TX₀ are determined and validated.

### Sideward Sequential Interaction:

We will describe the sideward sequential interaction first in terms of its sideward persistence type, then we will demonstrate how the technique may easily be also applied for sideward non-persistent sequential interaction (through the script-hash/SH technique described further below). Sideward persistence may be demonstrated most palpably through merging use-case example namely, merging of multiple UTXOs with identical or similar (partially identical) BPSC smartcontracts into one (or more than one, if re-splitting occurs at the same transaction) UTXO/s with the same (or similar-partially the same) BPSC smart contract. Thus the merging embraces combination of all-forward, sideward and backward persistence. Yet will use the merging and sideward-persisting terms interchangeably.

The described backward induction process of the linear chain form may be extended to funnel-shaped one by simply re-iterating the whole backward induction process among inputs of the same transaction (in other words, combining backward and sideward sequential/persistent interactions), that is to prove that multiple (more than one) UTXOs being spent by current transaction are traced back to specific genesis transaction, while these UTXOs may have either completely separate or intersecting (in some past transactions) paths tracing back to the genesis transaction over the blockchain DAG.

As already explained above, a transaction may have multiple inputs, while through each of the inputs occur spendings of distinct UTXOs, legitimacy of each spending must be validated by executing locking script of UTXO (being spent through that input) with parameters passed for the execution in unlocking script (residing in corresponding input of spending transaction). Only if all UTXOs spendings by transaction were validated to be legit, the whole transaction is considered legit and is inserted/accepted by miners into the next block of a blockchain ledger.

Every such per-input validation of UTXO spendings happens in completely separate execution context, whereas each execution context is corresponding to specific input pointing (by outpoint field the input contains) to the UTXO which script is being executed and which is spent through that input by the spending transaction.

The only linkage between the executions happening in separate contexts (each corresponding to its specific input) are the parameters of the series of all outpoints of UTXOs spent by transaction.

When the sighash preimage, pushed into unlocking script, is validated to be identical to actual current spending transaction preimage (through OP_PUSH_TX technique), it is further parsed for extraction of all relevant fields, among which are the outpoints of all previous outputs/UTXOs or hash of their series (depending on legacy or optimized sighash preimage respectively), which (outputs/UTXOs) are spent through current transaction inputs.

While in legacy version of sighash preimage the outpoint values for all inputs of transaction are provided in preimage as they are, in optimized version of sighash preimage only hash of the series of all outpoints (transaction IDs concatenated with output indices inside the transaction) concatenated together is available—hashPrevouts (by definition: the double SHA256 of the serialization of the outpoints (transaction IDs and output indices) being spent by this transaction).

Therefore, in case of optimized sighash preimage version, the series of all outpoints (which include these TXIDs) of UTXOs being spent through transaction inputs (apart from the outpoint of UTXO spent through the input in context of which execution happens) should be (1) passed/provided as additional parameter in unlocking script (in addition to sighash preimage parameter) in order first to get concatenated with current (being executed) input's self-outpoint (extracted from sighash preimage) and then be validated (after OP_PUSH_TX validation of the whole sighash preimage) against hashPrevouts (double SHA256 of concatenation of all the outpoints being spent by transaction) field of sighash preimage and then (2) parsed for extraction of these TXIDs from the series of outpoints (instead of extraction from sighash preimage, as in case of legacy sighash preimage), and that in order to use them as public parameters in verification process of correctness of sideward interactions (usually combined with backward tracing).

For sideward sequential interactions e.g. merging of backward persisting smart contracts (in the meantime ignoring a token feature), the public SNARK/STARK parameters (used in-circuit) are the script and the series of TXIDs (unlike in the linear induction case, where the public parameter was single TXID of its own input) of UTXOs spent through inputs participating in merge (sideward persistence). And that is, because these parameters are the only information that is available (due to OP_PUSH_TX) inside context of execution of one input about UTXOs spent by other inputs (mate-inputs that have separate execution contexts) of the same transaction. Specifically, the script (in case of merging of persistent smart contracts) is common among all the UTXOs spent by inputs participating in sideward interaction, and the TXIDs are distinct but are available/verifiable due to OP_PUSH_TX.

### As a Short Recap:

The linear induction (elaborated above) results in a proof that the current UTXO being spent belongs to a transaction that spent a UTXO which was either direct or subsequent descendant of the genesis transaction or otherwise this current UTXO cannot be spent.

Specifically, a UTXO cannot be spent if the preceding UTXO is not the same (except for specific fields that are allowed to be variable, e.g. owner address). Because the method has applied the same BPSC rule in the preceding UTXO, and enforced by that the preservation to its corresponding pre-preceding UTXO, and so on, the self-preservation of the BPSC traces back to the very first BPSC UTXO in the transaction chain, which transaction was preceded by genesis transaction. Combining implementations of such induction step case with initial base case conditions ensures furtherthat the very first backward pers isting UTXO was “born” legitimately aka spent some UTXO that belongs to genesis transaction. Thus Back-to-Genesis persistency is guaranteed.

Therefore, for a method to provide full funnel-shaped (many-to-one) persistence, meaning an induction in backward and sideward directions combined together, it may enforce a BPSC code of a locking script of UTXO, being spent through specific transaction input (in context of which the UTXO script is being executed), to be the same BPSC code in locking scripts of parallel UTXOs-to be defined as UTXOs spent through so-called mate inputs of the same transaction participating in sideward sequential interaction. And that for the reason that, if such a parallel BPSC UTXOs code is guaranteed to be the same, this in turn guarantees (1) for these parallel UTXOs their own backward persistence (since their script is BPSC) and, since it's combined with sideward persistence (SPSC) it (2) guarantees the same script code in all the parallel past UTXOs of all their past steps along each of their own corresponding backward persisting chains of UTXOs, and (3) each of the BPSC-SPSC script past outputs in such a parallel past UTXOs guarantee again their own backward persistence and so on and on, creating multiple induction paths of backward persistence all converging in a funnel-shape manner into parallel BPSC-SPSC UTXOs spent by current transaction; and that while every such a path is guaranteed to be initiated at genesis transaction (which TXID is hardcoded in the mergeable BPSC-SPSC script code carried in all those UTXOs).

Therefore each funnel-shaped induction step takes place at each script execution occurring in a context of one of the inputs (participating in sideward persistence), whereas it is satisfying for each such induction step to enforce backward persistence onto its parallel UTXOs and onto its corresponding past output of pre-preceding transaction TX₋₁.

Generally, in order to achieve this combined sideward and backward persistence in smart contract at first sight it could be sufficient for a SNARK/STARK circuit to be configured to apply the functionality of the linear induction from Code Example 3 multiple times (iterations), specifically to apply it per each input participating in sideward interaction persistence (meaning persisting the same BPSC script to be in parallel UTXOs spent by the same transaction) or to be precise, the same linear induction code (as in linear case) should be applied each time with two public parameters (as in linear case), which are (1) script public parameter that remains the same for all the per-input iterations and (2) the public output parameter of TXID (of TX₀) that is distinct per each iteration and corresponds to TXID of UTXO being spent by that particular input, each such public TXID parameter value is obtained from outpoint of an input corresponding to its iteration of applying linear backward persistence module of SNARK/STARK circuit code. As stated above the outpoints themselves are extracted either from parsed sighash preimage directly (legacy case) or (for optimized case) provided separately as an outpoint series in unlocking script in order to be validated first against hashPrevouts field of sighash preimage parameter (provided in unlocking script too for OP_PUSH_TX).

Note, the order of concatenation of outpoints (for hashing and successful validation against hashPrevouts through OP_PUSH_TX) is identical to the order of inputs in the transaction, and should be identicalto the order of in-circuit iterations (one per TX input) of the process of SNARK/STARK proof creation in order to coordinate it with the process of proofs verification. Note, this fact of accordance of the order of concatenation of outpoints (used for validation against hashPrevouts) with the order of inputs in the transaction may be used (when it's needed) inside smart contract script executions to determine the transaction input in context of which the execution happens.

Moreover, (to save transaction size) SNARK/STARK techniques which PCS (polynomial commitment scheme) is hashing-based, such as FRI, DEEP-FRI etc. may have their proofs be divided into smaller proofs, verification of which may be assigned into specific transaction inputs contexts executions according to the same order of outpoints/inputs-of-transaction. And that due to the FRI queries (being FRI's proof building blocks) independency nature which allows dispersion/distribution of FRI proof queries over unlocking scripts of inputs of the same transaction, avoiding transaction size growth as a function of a number of its inputs. Namely, instead of reassignment of the whole proof in unlocking script of every input of the same transaction, the proof is divided into a number of groups of its queries corresponding to a number of inputs of that same transaction, and that in order to achieve as equal as possible number of queries verified by execution of UTXO script being spent through that particular input. Then according to the order of Fiat-Shamir (used to generate non-interactive proof queries) each input may determine which group of queries it has to process/verify by running, corresponding to its location in transaction, number of iterations in Fiat-Shamir order of chain of randomness generation chain over initial source of entropy.

The same may be asserted for methods as Breakdown, Orion, and Virgo and similar.

Furthermore, UTXO scripts (constituting smart-contracts) inherently include possibility of usage of hashing opcodes suiting naturally implementations of hashing-based commitment schemes and avoiding other implementations that include e.g. non-native arithmetic, pairing-based elliptic-curve logic, or any elliptic curve logic at all etc., which makes them very/too sizable for implementations in script residing within UTXOs.

However there is a missing conceptual element in linear induction of backward persistence of Code Example 3 in order to be sufficient to be used (as a module) in each per-input sideward persistence iterations.

That is, since linear case has only single input in transaction, when the only (in the whole transaction) script execution occurs in the context of that single input, that only script of the only UTXO being spent by the transaction may be extracted from sighash preimage parameter (passed into unlocking script of the single input), and therefore there was no need to check for correct script parameter to be present and correctly located inside preceding TX₀ transaction, since all that was provided and validated through OP_PUSH_TX, and therefore it was sufficient for the SNARK/STARK circuit configuration to provably have the script parameter in its correct location only in pre-preceding transaction TX₋₁ (as presence and correct location of the script parameter within TX₀ was verified through OP_PUSH_TX).

But if presence and correct location of persisting smart contract script parameter has to be enforced for preceding TX₀ transactions of all UTXOs, being spent by current transaction and participating in sideward persistence, then using the same linear induction case circuit configuration (of having the script parameter in its correct location only in pre-preceding transaction TX₋₁) as a module for each per-input iteration may make the whole proof be easily forged by using UTXOs of all pre-preceding transactions TX₋₁ with the same common script, but not necessarily having the same script in parallel UTXOs (that belong to corresponding preceding transactions TX₀) spent through mate inputs (participating in sideward persistence) of current transaction.

As a result correct persisting smart contract script appearance is enforced in UTXOs of transaction TX₀ only in execution occurring in its current input context and that owing to OP_PUSH_TX technique, while in scripts executions in contexts of other mate inputs there is no guarantee of having the same persisting smart contract scripts in their corresponding UTXOs (being spent through these mate inputs) that belong each to their own corresponding transactions TX₀; and that because there is no enforcement of format onto those persisting smart contract scripts (of UTXOs spent through mate inputs) from within current context execution of a current UTXO script, therefore if linear induction case SNARK/STARK circuit configuration (Code Example 3) is used as a module for each sideward per-input iteration—the only enforcement of persisting smart contract script (presence and correct internal location) is on scripts of outputs (of TX₋₁ transactions) that were spent by TX₀ transactions corresponding to UTXOs spent by each of mate inputs of current transaction. Simply put, the scripts of parallel UTXOs may be different, while only the scripts in outputs preceding these UTXOs, each in its corresponding outputs chain, are enforced (by SNARK/STARK circuit configuration) to be identical.

For example, a token persisting smart contract that just went through redemption, may have a standard locking script (P2PKH) at its freshly redeemed UTXO, while the output preceding this UTXO included the last in a chain token persisting smart contract, therefore such a redeemed UTXO may be used to successfully forge the sideward persistence interaction, since execution of combined sideward and backward (of previous linear induction Code Example (3) used as a module for sideward iterations) persisting smart contract occurring in the context of other mate input would be satisfied according to this SNARK/STARK circuit configuration, and that while the own execution (occurring in the context of its own input) of the standard script of the UTXO of just-redeemed token is not “aware” of and hence doesn't require any persistence at all (for being just a standard, non-persisting script); therefore such a transaction may be successfully processed and transmitted by miners, while sideward persistence in it was compromised.

Thus previous linear case of Code Example 3 clearly cannot be used as a module for each per-input iteration to provide trustworthy sideward persistence.

On the other hand, as a recap, sideward persistence implementation described above in “A necessity of an ability of sideward interactions” based on OP_PUSH_TX is not practically feasible, as it requires that the whole data (or significant fragments-majority of transaction data) of preceding transactions of UTXOs being spent through “mate” inputs of that same transaction to be pushed into unlocking script of an input, in context of which execution takes place. Therefore the complexity of a total size (of memory) of such a transaction grows parabolically as a function of a number of its inputs (n) participating in such a sideward activity, and is multiplied by a size of preceding transactions and if the sideward interaction direction is combined with a forward one, the growth becomes exponential.

Therefore the solution is to use SNARK/STARK circuit configuration of linear induction (as in Code Example 3), but with modification which enforces presence and correct location of smart contract script of the only UTXO being spent in its preceding transactions TX₀, and that despite the fact that the script may instead be extracted from sighash preimage (during OP_PUSH_TX procedure) and as a result keep the implementation/configuration simpler (more effective/optimized). The modification results in using the same two public parameters (the persisting script code and the final TXID of TXotransaction of the only UTXO being spent) for SNARK/STARK circuit configuration, but using the script code parameter in two places namely, in TX₋₁ (as in Code Example 3) and additionally in its correct location inside TX₀ transaction, which in turn requires five private witness parameters (instead of four in the unmodified version), since the previous fourth witness (w4) parameter is now split in two by the public script code parameter inside of it.

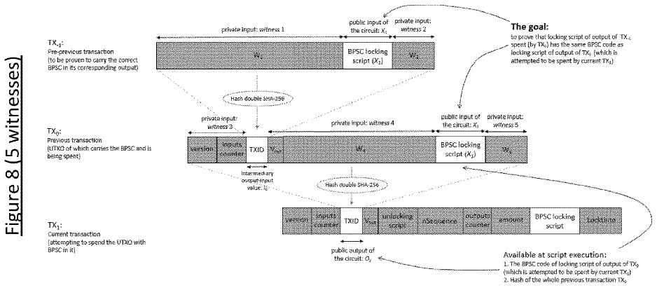

FIG. 8 makes perceptible demonstration of modified construction of parts of the two preceding transactions (TX₀ and TX₋₁), from which the new modified SNARK/STARK circuit configuration is derived.

Code Example 4 presents this modified version of SNARK/STARK circuit configuration which functionality is basically identical to the one implemented in Code Example 3 when used for linear induction, but (despite being slightly less effective) the version suits for being used as a module for each sideward per-input iteration described above.

More precisely, the modified smart contract in-circuit implementation should be as following (looking at FIG. 8): Alice can prove a statement that-she knows (1) some data (W₁) that if concatenated to (2) known constant BPSC/SPSC script code from the left side and she knows (3) another data (W₂) that if concatenated to the previous concatenation result from the right side, then passed through double SHA256 to get (4) some intermediary (I₀) result (which is not necessary for her to know in advance), then if in addition she knows (5 & 6) some third and fourth data (W₃) and (W₄) that if concatenated to the intermediary result from the left and right respectively, and then its concatenation result in turn is followed by concatenation of (as 2) exactly the same (from the first step) constant BPSC/SPSC script code string from the right and finally the result is concatenated from the right side with (7) some other fifth data (W₅) and when passed again through double SHA256-results in public (from outpoint of UTXO being spent and known to verifier) TXID string.

In the light of everything explained above, for smart contract to reliably enforce sideward persistence (e.g. for merging of similar/identical smart contracts), it must apply in a loop for every transaction input (participating in merging/sideward interaction) the modified SNARK/STARK circuit configuration of linear induction example, which modification enforces persistence of the same (FPSC-)BPSC-SPSC script in locking scripts of all parallel UTXOs spent by transaction and participating in sideward-persistence/merging (that in addition to previous enforcement of backward persistence onto all corresponding outputs of pre-preceding transactions TX₋₁ of these UTXOs).

And that while the script code (which constitute the same locking script for all the UTXOs spent by these inputs) and a TXID corresponding to transaction of UTXO being spent through that particular input (which is extracted through OP_PUSH_TX either directly from sighash preimage or from series of TXIDs of UTXOs spent through inputs participating in merge, provided next to sighash preimage) are the two public SNARK/STARK circuit parameters used for each such per-input specific iteration of applying (in the loop) of the modified linear induction SNARK/STARK circuit configuration.

Obviously, the public parameters for the whole such a re-iterating circuit configuration are the single script code and a series of TXIDs of the UTXOs being spent through the inputs participating in sideward persistence.

Since in such a re-iterating (of applying modified linear induction circuit configuration) SNARK/STARK circuit configuration the common parameter of script code is enforced to constitute locking script of all UTXOs (that belong to their corresponding transactions TX₀) spent through inputs of current transaction that participate in merging/sideward persistence, an adversary event of forging sideward persistence (e.g. by using UTXOs of freshly redeemed tokens, as explained above) becomes impossible and the enforcement of sideward persistence is not compromised.

The Code Example 5 demonstrates sideward persistence of merging of two UTXOs with backward persisting smart contracts, therefore it implements a combination of backward and sideward persistence (BPSC-SPSC), while sideward persistence size is 2. We use a minimal number of persisting interactions (2), as it's sufficient to demonstrate the method, but this number of interactions is not limited by any means and may be trivially technically increased to any desired number and doesn't require additionally to invent any specific techniques forit. As stated, the combination of backward and sideward persistence (sequential interactions) demonstrates a funnel-shaped induction.

Note, because the feature is of merging BPSC smart-contracts is of persistent type, it itself is of BPSC persistence feature creating a combination/amalgamation of both SPSC and BPSC, therefore when witness parameters (reflecting parts of previous TX₀ and TX₋₁ transactions) are parsed (for checking their lengths) possibility of multiple inputs (two in our minimal multiple case) of previous TX₀ and TX₋₁ transactions must be considered for consistency of assurance of merging backward persistence. Which also means that UTXO of pre-preceding transaction TX₋₁ may be spent by transaction TX₀ through any of its two inputs, or in other words, the index/location of TX₀ input, through which output of TX₋₁ carrying BPSC-SPSC persisting smart contract is spent, becomes non-constant (in comparison to both previous linear examples where it was always first) and may be either first or second—the fact that must be reflected in a circuit code implementing merging of BPSC-SPSC persistent smart contracts. Inside SNARK/STARK circuit configuration this index/location of TX₀ input (through which BPSC-SPSC output of TX₋₁ is spent) may be determined by the structure of private witness 3 (w3) parameter, which in case of the input being the first input of transaction TX₀ would constitute only the version and input-counter transaction fields (thus its length would be 5 bytes as in previous Code Examples 3 and 4), otherwise it would include the whole first input fields in addition to version and input-counter.

### Tokens Merging (Sideward Sequential Interaction) Feature:

Note in linear induction examples, as it's single input vs single output and thus has no merging or splitting features, a token feature (if present) is either integral part of the contract itself (e.g. being defined in data fields of the contact and persisted alone with the rest of the contract code and data) or may be irrelevant at all (the contract scriptitself, e.g. its data attachment, may solely constitute some NFTtoken, while und erling native tokens are only used as a motion means for paying for NFT's transfer to miners on a blockchain) or if required to be of NTB nature may be implemented as in “WO 2022/118263”.

But If particular token feature (of NTB, DFB or both implementation types) requires an ability of merging of tokens (or similar sequential sideward interaction), as in case of e.g. fungible tokens, then in order to provide practically feasible realization or token-merging for any required number (in practice, any number more than two) of UTXOs with tokens to be merged, it must be separately implemented in-circuit and that due to requirement of realization of sequential (sideward) interaction; which is in contrast with other vertical permissioned and permissionless features, which are possible to be realized in-script through OP_PUSH_TX technique.

To be specific, the parameter of total amount of tokens (from inputs participating in merging) must be calculated in-circuit and then configured as (and attached to) the SNARK/STARK circuit additional public parameter. That in order to be first validated by part of on-coin smart contract performing SNARK/STARK verification, and then to be used by another part of the smart-contract to enforce/require the same total amount of tokens in altogether newly created persisting output/s by spending transaction, thus implementing merging into either single or (case of splitting event, see below) multiple outputs of spending transaction.

Note, in contrast with smart-contract merging which is persistent sequential sideward interaction feature, token-merging is a feature of sideward sequential interaction of non-persistent type, but being embedded into the feature of persistent merging of smart-contract.

Splitting Feature of Smart-Contracts in General and their Tokens Features in Particular:

We disclose here the method of merging of smart-contracts/tokens, while the method of splitting of smart contracts and tokens in particular, may easily be achieved in-script through OP_PUSH_TX is described in previous works and thus will not be re-described here. See previous in-script examples with splitting of NTB-Substantiated Tokens “WO 2022/118263” and DFB—https://xiaohuiliu.medium.com/utxo-based-layer-1-tokens-on-bitcoin-sv-f5e86a74c1e1.

All these in-script examples of the smart-contract splitting feature realize it only in the context of forward persistence.

However when the splitting feature must be implemented in the context of persistence in combination of forward and backward (and potentially sideward) directions, meaning one (or potentially multiple) input/s vs multiple outputs engaged in persistence process, it requires an in-circuit implementation of strict enforcement of concordance/mapping of the output indices (Vₒᵤₜ) from outpoints of preceding TX₀ with actual index/location of the outputs (spent through these outpoints inputs) inside TX₋₁, since because of the splitting feature the location of output in TX₋₁ is not fixed to be always the first anymore (as described above in “Additional technical requirements”).

Moreover, if the splitting is a token-splitting feature (and not smart-contract splitting in general) and is combined with token-merging feature, then a modification of the in-script above examples (of splitting through OP_PUSH_TX in context of forward persistence) is required, namely-taking its input parameter of the total amount to be split from the additional public parameter (of total amount) configured in-circuit and attached to the SNARK/STARK proof, instead of extracting it from sighash preimage fields (or in case of legacy sighash preimage, instead of using the described above technique for value/amount transfer described earlier).

Combining merging and splitting turns into full DAG (direct acyclic graph) induction (unlike linear or funnel shapes of induction of previous Code Examples). Usage of the full DAG induction allows us to avoid implementations based on Proof-Carrying Data (PCD), which is a generalization of IVC for an arbitrary DAG, whereas in IVC the steps are linked in a simple path.

Code Example 6 demonstrates addition (to Code Example 5) of realization (of in-circuit part of smart contact) of both token-merging and splitting features, while token-merging feature is implemented for both implementation types (presuming use-case requires combination of both of them in the same implementation) and splitting feature in-circuit modification is implemented for both token and non-token smart-contracts. The code changes are in Guest code only, thus only this single file code is provided.

Note, adding splitting feature implementation affects checking consistency of w1 length (if TX₋₁ output may be second, w1 should additionally include all the fields of first output-its value/amount and its locking script).

Or to be specific, index (Vₒᵤₜ) of output of pre-preceding TX₋₁ must be parsed from the outpoint of input of preceding TX₀, if it turns out to be second output, length of the whole first output must be considered when calculating length of w1 (see Code Example 6).

### Other Notes for Code Examples 5 and 6

1. if w3 length is 5 bytes (only version and input-counter fields)—it constitutes only version and input-counter TX fields, then past UTXO of pre-preceding TX₋₁ must be necessarily spent through the 1st input by preceding TX₀, otherwise it is spent through the 2nd TX₀ input and then w3 must additionally contain all the fields of the 1st input too, meaning the consistency of w3 length must be checked in order to validate correct location of intermediate TXID parameter inside preceding transaction TX₀.
2. w3 length is verified to be legitimate in order to validate correct position of intermediate TXID parameter inside the preceding transaction TX₀;
3. In case where smart contract has only backward persistence (without its combination with sideward persistence) the correct location of the UTXO (and particularly, of its locking script fields inside that UTXO) inside preceding transaction TX₀ is guaranteed by blockchain software itself (run by the blockchain validators/miners) and that since the UTXO is being spent through inputs of current transaction TX₁.
   But if sideward persistence is combined with the backward one, the script parameter locations inside all preceding TX₀ transactions must be verified to be legitimate and that is achieved by verification of correct length of w4 (in addition to verification of correct length of w3). This modification enforces backward persistence of correct location of (FPSC-) BPSC-SPSC script parameter inside all preceding transactions TX₀ which UTXOs are spent by current transaction TX₁ and are participating in sideward-persistence/merging.
   Namely, an adversary event of forging correct location of (FPSC-) BPSC-SPSC script parameter inside any of preceding transactions TX₀ becomes impossible and the enforcement of sideward persistence is not compromised.
4. For the sake of simplicity we use constant 2 inputs (that is, transactions are always merging). Even though two is minimal (for being defined as multiple), it is sufficient to demonstrate the concept of the method, while it's obviously not complicated to make modification of merging being optional (a choice of 1 or 2 inputs)—this modification is purely technical and does not require additionally to invent any specific techniques for it.

Highly important, due to the sideward persistence implementation of the general re-iterating SNARK/STARK circuit (where each iteration assures backward persistence), it's enough for (FPSC/)BPSC/SPSC smart contracts to show backward persistence of only own UTXO (meaning UTXO, which script is being currently executed in the context of current input) of TX₀, whereas all other UTXOs (participating in sideward interaction, e.g. merging) spent through other inputs of the same transaction will be verified as being backward persisting by executions of their corresponding UTXOs scripts, in the context of their corresponding inputs executions. Therefore, if any of the BPSC/SPSC UTXOs participating in sideward interaction (such as merging) will not be proven as backward persistent (meaning its script execution in context of its input will fail) the whole transaction validation will result in failure (and hence the transaction will not be transmitted and not be included in the next block of a blockchain).

Meaning, the method is scalable even for funnel-shaped and full-DAG induction cases. Specifically, while the number of (FPSC/)BPSC/SPSC UTXOs that are participating in sideward interaction may be big, each such UTXO script execution verifies only: 1) correctness of sideward persistence with other mate-UTXOs (participating with it in sideward interaction) of the spending transaction and 2) its own backward persistence.

In other words, there is no need for each UTXO to check backward persistence for each of the other mate-UTXOs participating in sideward interaction. Meaning, during the whole process of transaction validation, forn number of UTXOs participating in sideward interaction in this transaction, in total there are only n backward and n sideward persistence verifications taking place.

Considering the nature of separate per-transaction-input contexts of UTXOs scripts executions, the maximum scalabity of number of sequential/persistent interactions verifications as a function of number of transaction inputs (participating in those interactions) is linear, which is exactly the scalability that the disclosed full-fledged smart contract method provides for any form of induction of sequential interactions-linear, funnel-shaped, full-DAG.

### Non-Persistent Sequential Interactions:

A sequential interaction occurs between smart contracts which are adjacent to each other in the sequence of interaction events on a blockchain. For interaction to be sequential the code of adjacent smart contract must be known (at least partially) by the contract being executed, or stating alternatively, the executed smart contact must know what format it enforces on script of adjacent outputs, otherwise the interaction is an arbitrary one (just like with standard blockchain events, e.g. Bitcoin regular spending). As example, persistent type of a sequential interaction smart contact requires the adjacent smart contract to have the same code as its own, in order to fulfil the requirement smart contract compares the code of adjacent smart contract to its own, which is available (known) at the time of execution through OP_PUSH_TX. However smart contract may be non-persisting which means, they may require the code of such an adjacent in a sequence smart contract to be other than its own, while obviously still “knowing” what it should be (at least partially). In order to be sequential smart contract, at the very least, must enforce the part of a code responsible for sequential interactions (including verification parameters/keys, such as MethodID/ImageID in case of RISC-0), or in other words, the contract must know and require such (known to it) part of a code to be present in adjacent smart contracts (at the very start of smart contract, to avoid earlier script execution termination).

The simplest compact way of implementation of checking other smart contract being some specific expected script code is to store in advance hash of that smart contract script code and then at the time of execution when the code of other smart contract is available to hash it and compare with the stored in advance script hash. In other words, scripts are identified by their hash values-script hashes (SH), which may be used for enforcement of specific distinct (than own) smart contract script code in adjacent smart contracts in the sequence of interaction events on a blockchain.

Script-hash (SH) check technique is widely used in various UTXO blockchains and may be applied on adjacent smart contracts in sequential interaction of any direction.

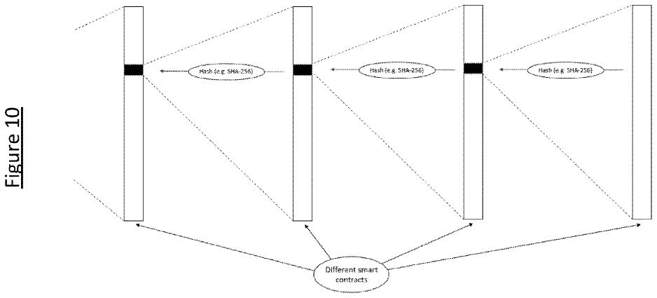

Moreover, it may be applied in chain as shown in FIG. 10 and the chain may be required to be initiated from some specific genesis transaction, just like with persisting sequential interactions features. As example—delegation of computation, an abundant computation may be divided in parts/phases, whereas correctness of off-chain execution of each specific phase is verified succinctly on-coin by various smart contracts (corresponding to their part of computation), while each such a smart contract is checking for preceding smart contract to be the expected one through hashing it and comparing the hash result (a digest) to be matching a specific hash value (SH) known in advance. Furthermore, when it's possible the computation parts may be executed in parallel and then compound/combine/merge the results of their partial computations through sideward sequential interaction with a help of script-hash technique for identification of corresponding parallel smart contracts. While all of the partial computation smart contracts may be e.g. enforced to be traced backward to some specific genesis transaction, which keeps the terms and conditions (including payments to executors) of the delegated computation order made by its sponsor.

In case of sideward non-persisting sequential interaction, for some cases, each smart contract script execution may determine transaction input in context of which the execution occurs (as showed in WO 2022/118263) and use it for enforcement of some specific smart contracts for specific transaction inputs. For example, smart contract A is required to be executed only in the context of first input, while smart contract B only in the context of the second input (simply put, UTXO carrying smart contract A may be spent only through first input of spending transaction, while UTXO spent through second transaction input must carry smart contract B).

Other smart contracts, in case of sideward non-persisting sequential interaction, may not need to be bound to specific inputs and instead, may carry a list of hash-values (corresponding to specific smart contracts) and allow any smart contract, which hash digest fits any of the hash values from the list, to constitute locking script of UTXO spent through any of their mate-inputs of transaction. Which is correct in the same manner for backward and forward sequential interactions.

The script code of the distinct preceding and/or distinct parallel smart contract scripts are public input parameters of SNARK/STARK circuit, thus they must be passed next to the SNARK/STARK proof in unlocking script (for the SNARK/STARK proof verification) of the current input, which allows to implement trivially the script-hash comparison check in-script (since the distinct script are available for hashing and comparing the result), which in turn allows the SNARK/STARK circuit configuration to be independent of specific script and their corresponding hash results. Although, the same script-hash comparison check may be implemented in-circuit, it's not desirable as it would cause the circuit (and as a result, the verification side code) to be different for every such a different script and its hash result (meaning, different preceding/parallel smart contract); even though in the case of using ZK-VM (as RISC-0) the verifier-side code wouldn't be affected, yet the “Method ID/Image ID” would be different for every such a different hash digest. Therefore the reasonable way of its implementation should be purely in-script, to avoid any impact/effect on SNARK/STARK circuit configuration (which then may be identical over all the chain/interactions-sequence of distinct smart contracts, interacting and identifying each other through script-hash technique). Even though the Code Example 7 demonstrates how such a script-hash check could have been implemented in-circuit for a preceding past UTXO script (enabling two options for such a script), this is only for the sake of clearer elaboration of the method and not how it should be implemented in practice (which is in-script). While in practice it may be trivially achieved by number of script commands (opcodes) similar to the following:
<script> OP_DUP OP_SHA256 <pre-determined result of SHA256 hash of script> OP_EQUALVERIFY

Therefore everything described in the document with relation to abilities of the feature of persisting sequential interactions of full-fledged smart contract is applicable for non-persisting sequential interactions through script-hash technique.

In other words, the full-fledged smart contract method disclosed herein is equally implementable forfeatures of sequential interactions for both persisting and non-persistingtypes and their various combinations in the same smart contract (as with Code Example 6 describing token-merging feature being “combined with”/“embedded into” (FPSC/)BPSC/SPSC).

Interactions with Unknown-In-Advance Sequential Smart Contracts:

The disclosed method of full-fledged smart contract, in addition to its ability of features of sequential interactions of persisting and non-persisting types, has a feature of interaction between various sequential smart contracts, while the counterparty sequential smart contract is not known in advance on a script level.

The simplest palpable example of such interaction could be an atomic (done in a single transaction) swap, where in the single transaction some NFT could be swapped atomically for some amount of FT, e.g. cinema ticket (NFT) being bought for some amount of USD-pegged fungible tokens (FT). Where smart contracts of both parties are sequentially persisting backward to their corresponding genesis transactions.

Even though each of the smart contracts always knows its own adjacent (in its corresponding backward sequence) smart contracts format, none of them is “aware” of the counterparty sequential smart contract, e.g. the USD-pegged FT implementation must have an ability to be swapped for any other FT or NFT, thus its implementation must include an ability of a generic swap with smart contracts “unknown” to it in advance.

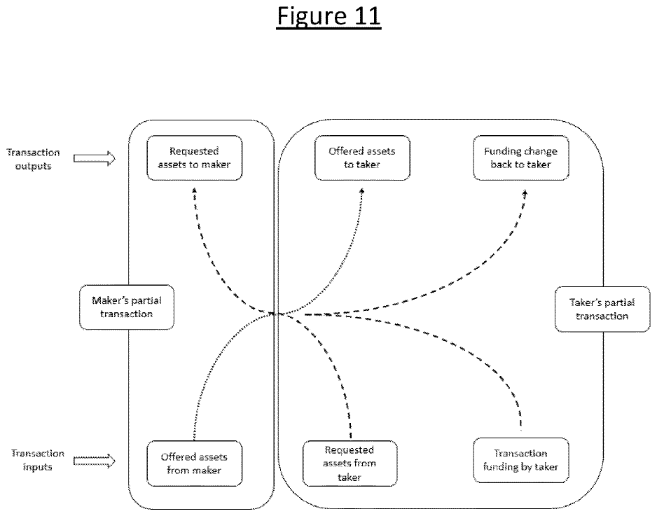

WO 2022/118263 demonstrates a method of on-chain (but no on-coin) implementation of atomic (done in a single transaction) swap between forward persisting sequential smart contracts. It implements logic flow of an atomic swap between inputs and outputs, depicted in FIG. 11.

But since it's based on only forward persistence (through OP_PUSH_TX technique) and lacks proper sideward interaction ability (of current disclosed method), this past method is practically limited by its sideward interaction technique to only a few steps/inputs (two inputs in the WO 2022/118263 example); moreover, due to lack of backward sequential persistence ability—the atomic swap between two parties (1) requires authenticity verification of tracing back to genesis transaction on the level of blockchain transactions DAG and as a result (2) consists of three steps handshake (instead of two steps) for construction of the atomic swap transaction (for details see WO 2022/118263).

Recap, for a previous/past (preceding this full-fledged smart contract method) techniques of sideward interactions, in order to enforce any spending conditions from smart contract execution in context of one input of transaction onto execution of other smart contract in context of another input (within the same transaction), the whole data (or significant fragments-majority of transaction data) of preceding transactions of UTXOs being spent through “mate” inputs of that same transaction should have been pushed into unlocking script of the input, in context of which execution was taking place. As already explained above, the pushing of preceding transactions (or majority of their data) into unlocking script of an input is performed for every input participating in the past sideward interaction process within the same transaction; therefore for n such a participating (in the past sideward interaction technique) inputs in total n(n−1) of preceding transactions are embedded in a current transaction, spending the corresponding UTXOs of those embedded preceding transactions. Note, the past sideward interaction technique may be performed with known or unknown (as with any atomic swap case, e.g. of WO 2022/118263) in advance smart contracts, while the ‘pushing of preceding transactions process’ is equally necessarily required in both cases.

The method of WO 2022/118263, apart for being non-native, due to its ‘authenticity verification’ feature which is compensating for lack of native backward persistence solution, in order to be combined with sideward interactions, is additionally compound of native limited-in-practice ‘pushing the whole data (or significant fragments) of preceding transactions’ method.

But due to the ability of the full-fledged smart contracts of practically-feasible (scalable) sideward sequential interaction, the full-fledged smart contracts avoid pushing the whole data (or significant fragments) of preceding transactions into mate-inputs unlocking scripts (which causes space/memory complexity of transaction size grow parabolically and even exponentially if combined with forward persistence, as described above) and therefore are not limited by the number of inputs participating in any sideward sequential interaction (in contrast with the case of the past technique).

Moreover, since full-fledged smart contracts are also capable of practically-feasible backward sequential interaction, they avoid tracing back to genesis transaction on the level of blockchain transactions DAG and involve minimal interaction between parties participating in such a smart contracts interactions with unknown counterpartys' sequential smart contracts (e.g. avoiding extra steps as the third step in three-step handshake example in atomic swap of WO 2022/118263).

Therefore in order to achieve scalable and on-coin implementation of an interaction with unknown in advance (on the script level) counterpartys' sequential smart contracts (for which atomic swap serves as a simple palpable examples), a forward sequential interaction based implementation of smart contract (similar to atomic swap in WO 2022/118263) must be combined with sideward and backward sequential interaction abilities. Or in other words, current disclosed method of full-fledged smart contracts includes all the components required in order to be applicable for implementation of interaction with completely unknown in advance (on the script level) counterparty sequential smart contracts, whereas the implementation may be of any logic flow of interaction between any required number of parties, through any required number of participating inputs and outputs of transaction (the atomic swap was only a minimal trivial example). While the unknownin advance counterparty sequential smart contracts may be of a (fully or partially) persistent or in the same manner non-persistent types at all, while in turn the non-persistent type of sequential interaction may be fully or partially script-hash based. We omit the explanation of modification required in order to make the (WO 2022/118263) in-script implementation of atomic swap (working for persistent smart contracts) to be suitable for non-persistent smart contracts, for the reason of it being solely technical and not requiring additionally to invent any specific techniques for it.

Moreover, full-fledged smart contract may be restricting for some extent the interaction with unknown in advance counterparties' sequential smart contracts, making them partially known in advance (on the script level), e.g. atomic swap with a requirement of smart contracts of counterparty being of backward persistent type.

Code Example 8 demonstrates the SNARK/STARK circuit part, which on-coin verification script code, if combined with implementation described in WO 2022/118263, results in implementation of the same functionality of atomic swap smart contract as in WO 2022/118263, but in a scalable and fully on-coin native manner (as per full-fledged smart contract definition).

### SUMMARY

As elaborated above, the previous/past techniques of sideward and backward sequential interactions are limited for practical implementation to only (at most) a few steps/interactions in their sequence, and that for the reason of their necessity of the process of ‘pushing of preceding/adjacent transactions’ (entirely or significant fragments of such a transactions) into unlocking scripts of inputs. For some cases of sequential interactions, in order to avoid the pushing of preceding transactions data ‘authenticity verification’ as described in WO 2022/118263 may be applied, which is a requirement of tracking transactions history over blockchain DAG and therefore makes the smart contract not fully native (still on-chain since all the required information is residing on the blockchain, but not on-coin as with native inherent spending-only).

The full-fledged smart contract method uses SNARK/STARK-based mathematical induction (combining SNARK/STARK technology with mathematical induction) process for realization of sideward and backward (and forward-when needed) sequential smart contracts interactions, which avoids the necessity in both ‘pushing of preceding/adjacent transactions’ into unlocking script of spending transaction and ‘authenticity verification’, therefore allowing the smart contract to (1) be native and (2) avoid the size of transactions throughout the sequence of their interactions on the blockchain to be growing.

Additionally and critically, the combination of (1) usage of SNARK/STARK techniques with (2) mathematical induction process allows to avoid any SNARK/STARK IVC techniques, usage of which makes implementation of sequential interactions of funnel-shape or full-DAG types extremely-complex or simply impossible, as well as causing several unnecessary computational overheads, most problematic of which is the excessive off-chain time of creation of SNARK/STARK proof parameter. Thus the combination allows the smart contract realization to be practically-feasible today and minimal (avoiding significant overheads) in the future.

In UTXO-based blockchains, if a script of UTXO being spent doesn't carry any implementation of enforcement of rules/conditions onto the format of smart contracts of the next UTXOs newly created by its spending transaction, then any script (code and data) may be assigned into these newly created UTXOs of the spending transaction, in other words, any available smart contract script may be copied into such a newly created UTXOs. Specifically, considering that UTXO blockchains are mostly public, which mean all their transactions including their outputs/UTXOs with their smart contracts are transparently open to the public, any smart contract which was at least once used is ‘seen’ and may be copied for creation of other completely unrelated UTXO but with identical smart contract code and data.

Which in turn means that in case of a UTXO constituting/representing an asset, which is required to have some provable backward (and optionally sideward) sequential interaction (e.g. persistence back to genesis past UTXO/transaction), the fact of presenting such a UTXO to receiver per se is not sufficient, since any once-published (or available through other ways) UTXO/output asset smart contract script may be used for creation of a forgery UTXO; which would carry identical to the original smart contract code and data, but not fulfilling backward (and optionally sideward) interaction conditions of the original UTXO.

Authenticity verification described in WO 2022/118263 prevents such a forgery of UTXO smart contracts by introducing an additional requirement of checking past transactions history on the blockchain DAG for correct tracing back to genesis past UTXO/transactions path, but unfortunately this additional requirement turns the whole solution into non-native, which repercussions are described above in the document.

Note, for such a forged UTXO (which doesn't fulfil the backward/sideward sequential interaction conditions) the non-native solution of ‘authenticity verification’ doesn't have a protection in form of ability of blocking further spending of the UTXO for being a forgery. Thus when the adversary tries to deceit someone by presenting the forged counterfeit UTXO, the UTXO may take its origin from some forged past UTXO which might had been spent in the past any number of times (e.g. even by the adversary to himself) since its first forgery event. Thus upon obtaining such a UTXO in order to be convinced that the UTXO is not a forgery it is not sufficient to validate its spendability, e.g. by checking its future spendability or that the preceding already-spent past output (adjacent in the backward sequence of interactions events) was carrying the same backward/sideward persisting smart contract, but rather an additional non on-coin actions are required (e.g. checking history of transactions on a blockchain up to genesis/initiation of the sequence of interactions).

Whereas, in case of all the methods of native solutions of sideward/backward sequential interactions; which are either practically feasible (as the (i) disclosed full-fledged smart contract method) or not (either (ii) ‘pushing preceding/adjacent transactions data’ that have transaction size growing fast through the sequence, or instead of combination of SNARK/STARK techniques with mathematical induction (iii) using SNARK/STARK IVC which have a relatively constant size of transaction through the sequence, but the size is too big to be practical); the “spendability” per se of UTXO carrying FPSC-(BPSC-)SPSC in its locking script, which is known to correctly implement the initial and induction steps of the process of both backward (optionally combined with sideward) and forward sequential interactions (e.g. persistence), constitutes a proof of its correct traceback path (or multiple paths in case of funnel-shaped induction) on the blockchain to its genesis past UTXO or past transaction (identifying parameters of which are immutably hardcoded in the FPSC-BPSC-SPSC). Meaning that the counterfeit UTXO, which was forged by just copying the smart contract code and data, will not be spendable at all for the reason of not really fulfilling the sideward/backward sequential interactions conditions.

If one can show a “proof of spendibility” of UTXO with smart contract carrying correct implementation of the two induction conditions (step and initialization), it's enough to conclude for the whole sequence preceding this UTXO as being legit (having ‘without interruption’ e.g. token smart contract in all past UTXO in the chain up to token legitimate issuance aka genesis) no matter how long the sequence is (how many times the token switched hands).

More in detail, since there are only two ways to spend the UTXO (as smart contract requires fulfilment of one the two induction conditions, otherwise it's impossible to spend): first, through the ‘step case’ of induction implemented in smart contract which demands adjacent (preceding) UTXO to have the same smart token format; second, being the only alternative, through fulfilling the condition of ‘initialization case’ of induction implemented in the smart contract as well, demanding for the UTXO to be spent to have in its adjacent (e.g. preceding) UTXO legit issuance/genesis (e.g. made from address, known to be controlled only by specific known entity-only this entity is able to make an issuance, as it demand knowledge of e.g. private key corresponding to such an address). In the latter case, the chain just started (was initiated) in preceding (direct ‘father’) past UTXO; while in the former case, it means the ‘father’ past UTXO had the same smart contract, and since it was spent already in the past, means that it in turn fulfilled one of the same two induction conditions relatively to the ‘grandfather’ past UTXO and so on, as long as it can get through the sequence up to genesis/issuance (which necessarily happened at some point in the past, since otherwise it would be impossible to initiate such a chain as the very first single UTXO created without legit issuance would be impossible to spend).

Such a “proof of spendibility” is provided by submitting unlocking script (which in case of full-fledged smart contracts, is including the specific SNARK/STARK ‘proof’ parameter among other parameters), which may be successfully evaluated against the locking script of the UTXO (which spendability is being proven), in other words, returns TRUE at the end of execution of locking script when unlocking script is passed to it as parameter. Note, such evaluation may be done off-chain in order to validate spendability without transmission of transaction to the blockchain-user receiving a payment (which is always in a form of UTXO) may check its legitimacy off-chain by running a piece of software of the same functionality as miners/nodes do during their validation; or may be submitted to nodes/miners which do the evaluation and if it is successful (in addition tc other checks) transmit the transaction. Alternatively, if a fresh receiver of UTXO, carrying such a native solution of e.g. persistent smart contract for sideward/backward sequential interactions, may see/witness that at least a single past spending of an output that was preceding this UTXO in the backward sequence of interaction events was spending of UTXO with identical/similar (if it's a sequential interaction of a persisting or partially persistent types) smart contract, it would be sufficient to consider that the currently received UTXO fulfils the backward (and optionally sideward) sequential conditions and is a genuine asset (to be precise, is genuinely constituting/representing physical or digital asset/s), and that for the reason that the spending of the preceding UTXO per se proves the genuineness/authenticity of the current one, and that is correct only if the UTXO is carrying FPSC-(BPSC-)SPSC in its locking script, which is known to correctly implement the initial and step cases of mathematical induction of the process of both backward (and optionally sideward) and forward sequential interactions (e.g. persistence).

Simply put, for native solutions, a forged UTXO may always be created (as there is no restriction in standard simple script UTXO on what locking script code may be assigned into the next one, as it's not e.g. FPSC), but it is impossible to spend it (if the mathematical induction method is properly implemented in its smart contract), and that forthe reason that any of the two (mathematical induction) conditions of its smart contract are now become impossible to fulfil, since the conditions are ether to have ‘father’ past UTXO of the same format (which is not in case of forgery) or to have genesis/issuance father UTXO (which is also not in case of forgery).

In other words, induction allows us to know that the chain is uninterrupted up to the legit issuance (corresponding to implemented initialization case) otherwise the UTXO is impossible to spend or, in other words, impossible to provide any proof parameter/s that would cause nodes/miners to verify and allow the transaction through into next block of the blockchain (aka transmission).

The following is an elucidating sorting of existing (forward-) sideward/backward sequential interactions smart contract methods:

### Non-Native.

‘Authenticity verification’—apart for being non-native compensation for lack of native backward persistence solution, in order to be combined with sideward interactions, it is usually additionally compound of native limited-in-practice ‘pushing the entire (or considerable fragments) data of preceding transactions’ method (e.g. tokens atomic swap, tokens merging etc.).

### Native:

### Practically Non-Feasible:

‘Pushing into unlocking scripts parameters that constitute data of entirety or substantial fragments of adjacent in the sequence transactions’—causes parabolic/exponential growth of transaction size through the sequence of interactions, making the method extremely limited for practical applications (the methods consist of mathematical induction, but not combined with SNARK/STARK technology).
SNARK/STARK IVC—non-growing transaction size through the sequence of interactions, but makes implementation of sequential interactions of funnel-shape or full-DAG types extremely-complex or simply impossible, as well as causing several unnecessary computational overheads, most problematic of which is the excessive off-chain time of creation of SNARK/STARK proof parameter.

### Practically Feasible:

Current full-fledged smart contract method—combining SNARK/STARK technology with mathematical induction which avoids the parabolic/exponential growth of transaction size through the sequence of interactions, as well as allowing simple flexible implementation of sequential interactions of funnel-shape or full-DAG types, additionally (due to bypassing usage of SNARK/STARK IVC) avoiding excessive off-chain time of creation of SNARK/STARK proof parameter and other unnecessary computational overheads. Therefor constitutes the only practical and unlimited method.

Simply put, the difference between native and non-native solutions is that native solutions have on-coin protection which makes a forged counterfeit UTXO impossible to spend by any means, since the backward (and optionally sideward) sequential conditions/requirement that such a forged counterfeit UTXO smart contract (residing in its locking script) enforces, are impossible to fulfil.

For example, in case of current full-fledged smart contract, the sequential conditions/requirements, that such a forged counterfeit UTXO smart contract enforces, are impossible to fulfil because there is no known pre-preceding transaction (TX₋₁) for the current counterfeit UTXO that carries identical smart contract in location corresponding to locking script of an output spent through specific correct input (or, in case of combination with sideward interaction, one of specific inputs) of preceding transaction TX₀ (to which the UTXO belongs), while hashing the TX₀ transaction would result in the value identical (if it's a sequential interaction of a persisting type) to the value of TXID of outpoint (TXID+index) of this forged UTXO. Or more specifically, there are no known transactions TX₀ and TX₋₁, which may be parsed into correct 4 (or 5, if modified version of Code Example 4 is used) private witness parameters, so that the witness parameters w1 and w2 may be concatenated with the same locking script of the forged counterfeit UTXO then (double) hashed, so that the hash result may be concatenated with the rest of witness parameters w3 and w4 (and optionally again with the script of the forged UTXO and w5) so that when (double) hashed would result in hash value identical to TXID of outpoint (TXID+index) of this same forged counterfeit UTXO. And since (1) there are no such known transactions TX₀ and TX₋₁ and (2) due to usage of hash functions with collision resistance feature, it's impossible to come up with a false w1-w5 witness parameters to construct a false SNARK/STARK proof according to the SNARK/STARK circuit configuration/flow depicted in FIGS. 7-8 so that it would satisfy the sequential conditions of backward (and sideward) induction steps (initial case or step case) of a FPSC-(BPSC-)SPSC smart contract, thus-meaning the counterfeit UTXO carrying copied smart contract script is unspendable.

Whereas, the difference between the native full-fledged smart contracts method and other native methods is in being practically feasible and unlimited (meaning, implementable for any required length of sequential interactions, in any direction, in any combination of directions-forming linear, funnel-shaped or full-DAG structures) or not (respectively); and that for the reasons stated above of:
1. Usage of SNARK/STARK IVC-makes implementation of sequential interactions of funnel-shape orfull-DAGtypes extremely-complexor simply impossible, as well as causing several unnecessary computational overheads, most problematic of which is the excessive off-chain time of creation of SNARK/STARK proof parameter.
2. Usage of ‘pushing into unlocking scripts parameters that constitute data of entirety or substantial fragments of adjacent in the sequence transactions’-causes parabolic/exponential growth of transaction size through the sequence of interactions, making the method extremely limited for practical realizations of sideward/backward sequential interactions.

Hence ultimately, it may be asserted that, the current disclosed full-fledged smart contracts method is (1) practically feasible and unlimited for implementation of sequential interactions of any required length, direction or combination of directions, while at the same time (2) it has a “safety measure” of making counterfeit UTXO (carrying in its locking script field full-fledged smart contract which are known to be correctly-implementing required sequential interactions, but not really fulfilling the sequential conditions of the smart contract) impossible to spend by any means.

Therefore the only addition to the processing (by e.g. wallet, app etc.) of UTXO, which contains in its locking script full-fledged smart contract with correctly-implemented FPSC-(BPSC-)SPSC functionality, is a requirement of access for each such a UTXO to its corresponding two past transactions TX₀ and TX₋₁, and that for two purposes:
1. Future spending of this UTXO involves (among other things) SNARK/STARK proof creation, which in turn requires access to corresponding two preceding transactions TX₀ and TX₋₁ and that in order to determine the necessary witness parameters (which due to usage of collision-resistant hash functions are impossible to come up with without preliminary knowledge of TX₀ and TX₋₁ data) for a given public parameters of (1) FPSC-(BPSC-)SPSC script and (2) TXID of the UTXO, all according to SNARK/STARK circuit configuration (depicted in FIGS. 7-8).
2. Upon reception of the UTXO, determination of its “genuineness” (which usually means its fulfilment of its sequential interactions conditions) requires only checking the locking script of the preceding-in-the-sequence output, which belong to pre-preceding transaction TX₋₁, to be identical/similar to smart contract in the locking script of the freshly received UTXO.

Note, for the particular special case of initial-case of induction process:
a) either this determination of “genuineness” (by e.g. wallets, apps etc.) should be expanded to coverthe specific case by allowing pre-preceding transaction TX₋₁ to be corresponding genesis transaction (identified by its TXID, hardcoded in the smart contract script) or genesis past UTXO (identified by e.g. its address and standard locking script form, hardcoded in the smart contract script),
b) or the FPSC-(BPSC-)SPSC UTXO issuer, as part of its issuance to the first receiver, must have two consequent transactions in the row (e.g. the first to himself, the second to the first receiver): first transaction-to spend UTXO that belongs to genesis transaction and create the very first new FPSC-(BPSC-)SPSC UTXO in the traceback transactions/outputs chain; second transaction-to spend the very first FPSC-(BPSC-)SPSC UTXO in the traceback and by that cause running initial case of induction and as a result spare from wallets, apps etc. extra implementation of the expansion of determination of “genuineness” to cover the initial case of induction.

Also note, for the sake of simplicity, in this chapter the explanation of unspendability of forged counterfeit UTXO and of UTXO genuineness check, is given with regard to persistent (or partially persistent) type of sequential smart contract (FPSC-(BPSC-)SPSC), namely describing requirement of smart contract script of preceding-in-the-sequence output to be identical/similar to smart contract script in the locking script of current UTXO. However, the same explanation is valid for non-persistent type of sequential smart contract, meaning the adjacent in the sequence smart contracts may be completely distinct from each other, but as long as the current smart contract (of UTXO being spent) “knows” what is the form/format of adjacent ones, the same genuineness check (check of preceding output being spent) may be easily applied with a slight modification of validating that the smart contract script of adjacent preceding in the sequence output is some specific (distinct) one, instead of checking it for being identical/similar to the current.

Moreover, when additionally (to backward) sideward sequential interaction is required, the same genuineness check (check of preceding output being spent) may be easily expanded by checking that for all the parallel UTXOs' (participating in sideward interaction) past spending of all their corresponding preceding in backward sequences outputs (which obviously belong to corresponding pre-preceding transactions TX₋₁ of each of these parallel UTXOs), were spending of UTXOs with identical/similar (to the current) FPSC-(BPSC-)SPSC smart contract script (in case of persistent or partially persistent type of sequential interaction of the full-fledged smart contract) or some specific (distinct) “known-in-advance” smart contract script (in case of non-persistent type of sequential interaction of the full-fledged smart contract).

To be specific, due to scalability (described above) of the current method, for each such a parallel UTXO (participating in sideward interaction), only 2 transactions TX₀ and TX₋₁ are required for spending and genuineness check of such UTXO. For example, for n parallel UTXOs being spent by the same transaction, so that each of these UTXOs own past transactions also spent n number of past parallel UTXOs, there is no need to process all n² total number of past preceding transactions; instead only 2n previous past transactions are required to accomplish creation of the current spending transaction, and that because for each of the parallel UTXOs being spent only its own corresponding past transaction TX₀ and one of any of its pre-preceding TX₋₁ n transactions are required in order to process the transaction spending and/or genuineness check of the UTXO.

### Specific Features:

The disclosure relates to a computer-based method of implementing a native full-fledged smart contracts (FFSC) realization which doesn't require any base-protocol/core-design changes in UTXO blockchains, and therefore suits all the UTXO blockchain categories of policies of protocol modification and introduction of new features to it.

In addition to that, importantly, for a method to be rightfully defined as full-fledged it is typically ‘practically feasible’.

For smart contracts to be native, it has to be of on-coin nature.

In order for smart contract to be full-fledged, it must have an ability of:
1. on-coin and practically feasible realization of the two features of “compression”/“succinctness” and of zero-knowledge,
2. practically feasible on-coin implementation of propagation of a logic enforcement in any sequence (and of any sequence length) of outputs/transactions to/from any direction (forward, backward, sideward), namely an ability of realization of sequential interactions (and importantly, including of its persistent type) in any desired direction and any needed combination of directions,
3. on-coin and practically feasible implementation of any required vertical/orthogonal features (importantly, including various token features),
4. freely combining without hindrance any desired composite of any of the above features

Aspects of the disclosed methods combine SNARK/STARK technology and smart-contract scripts (locking scripts, residing in transaction outputs) with “smart” parameters (residing in unlocking scripts of transaction inputs) provided to the smart contracts for their execution during script validation by miners. The “smart” script and their “smart” parameters usually involve OP_PUSH_TX technique realization.

The full-fledged smart contract method implementation may combine in-script and in-circuit (SNARK/STARK) parts, whereas usually what is possible to implement in-script in a feasible manner should be realized in-script (while it is usually involves OP_PUSH_TX technique), whereas only the parts that are impossible to implement in practically feasible manner in-script should be implemented in-circuit.

Being based on the SNARK/STARK feature, the method inherently provides the ability of succinctness/compression, embedded in it. Moreover, since every SNARK/STARK algorithm/protocol inherently coupled with zero-knowledge feature as an option, therefore the option of the zero-knowledge feature (ZK) is naturally supplied by the method as well.

To achieve realization of sequential interactions (and importantly, of its persistent type) in any desired direction and any needed combination of directions, the disclosed method is utilizing a mathematical induction.

Usage of combination of SNARK/STARK techniques with simple mathematical induction allows to avoid the parabolic/exponential growth of transaction size through the sequence of interactions as well as allows simple flexible implementation of sequential interactions of funnel-shape or full-DAG types. It avoids usage of SNARK/STARK IVCs (recursion or folding), and that while still realizing and achieving everything SNARK/STARK IVCs on-coin solutions are capable of, but without unnecessary redundant computational overheads of SNARK/STARK IVCs (specifically, the excessive time required for proof creation by SNARK/STARK IVC solutions), therefore the disclosed method is achieving today's practically-feasible implementation of sequential interactions of any length (and in any direction and combination of directions—not limited to form any sequential interactions structure) and is also a minimal-overhead solution for this implementation in the future.

The initial step of induction may be implemented either in-scriptor through (ZK-)SNARK/(ZK-)STARK, while the induction step usually is implemented in-circuit, involving SNARK/STARK technology.

Any (ZK-)SNARK/(ZK-)STARK system with its own corresponding arithmetization type (e.g. R1CS, PLONK-ish, AIR) and its Polynomial Commitment Scheme (PCS) type could be used, although some of them are very sizable for implementation of verifier side on-chain/on-coin and wouldn't be very practical, resulting in (FPSC/)BPSC/SPSC locking scripts of a very large size.

In short, the method is applicable for any (ZK-)SNARK/(ZK-)STARK system, which may be any combination of IOP/IOPP (Interactive Oracle Prove (Proximity) and PCS (Polynomial Commitment Scheme).

A detailed elaboration of the (mathematical) induction method may be found in various sections of the body of this document.

The induction may be of a linear, funnel-shaped or full-DAG form (as described above).

Note, the following rules may be enforced for sequential interactions of the method (FIGS. 7-8):
1) Internal location of outpoints TXIDs of TX₀ and (FPSC/)BPSC/SPSC code of outputs of TX₋₁ (in non-linear cases, that includes (FPSC/)BPSC/SPSC code of outputs of TX₀ too) participating in persistence—may be enforced to be located in their corresponding transaction fields, which are their specific input outpoints and output locking scripts fields (respectively). This involves concordance/mapping of the output indices (Vₒᵤₜ) from outpoints of preceding TX₀ with actual index/location of the outputs (spent through these outpoints) inside TX₋₁ (should be enforced through SNARK/STARK circuit configuration).
2) To prevent from adversary appending unplanned functionality code to known BPSC/SPSC code (e.g. adding more functional code to smart-contract script of TX₋₁, while relating code-addition in SNARK/STARK circuit to private parameter witness 2 (from FIG. 7) instead of ‘script’ public parameter, thus deceiving the verifier with successful proof that TX₋₁ script may be the same as in TX₀, while in reality its functionality was extended), the execution termination of code carried by ‘script’ public parameter must be validated inside the SNARK/STARK circuit.

For more complex forms of transaction (e.g. with multiple inputs/outputs) and configurations of the trace of chain of (FPSC/)BPSC/SPSC UTXOs (allowing merging and/or atomically swapping of (FPSC/)BPSC/SPSC UTXOs), depending on their requirements, more sophisticated rules enforcement may be needed in order to coordinate and locate the desired input/s and/or output/s inside the previous TX₀ and pre-previous TX₋₁ transactions (respectively), which in vast majority of cases coming down to parsing the transactions through their fields, such as script (locking and unlocking) length, “inputs/outputs counters” and some of the fields which have fixed specific lengths and values (e.g. “input counter” to cany the value not bigger than two if maximum number of inputs in transaction is not allowed to exceed it).

These rules should be used together with usage of collision-resistant hash function providing the desired security for the method.

If (FPSC/)BPSC/SPSC is not monolithic and carrying inside its code part variable fields, e.g. current owner address etc., then further additional input parameters should be used in the circuit configuration to introduce that variable fields as additional witnesses. Note, such a witness inputs (if are not located at the very edge of (FPSC/)BPSC/SPSC) may be dividing the (FPSC/)BPSC/SPSC into constant code parts surrounding these witness inputs (e.g. of variable owner address etc.), in this case all surrounding code parts must be defined as separate public inputs of the circuit and therefore used for both proof creation and verification, FIG. 9.

Everything described in the document with relation to abilities of the feature of persisting sequential interactions of full-fledged smart contract is applicable for non-persisting sequential interactions through script-hash technique (or any other technique achieving determination of one smart contract form from within another). In other words, the disclosed full-fledged smart contract method equally implementable for features of sequential interactions for both persisting and non-persisting types and their various combinations in the same smart contract (see Code Example 6, describing token-merging feature being inside (FPSC/)BPSC/SPSC).

Also note, non-sequential (singleton) interactions are just a special case of sequential ones.

The full-fledged smart contract method includes all the components required in order to be applicable for implementation of interaction between completely unknown in advance (on the script level) counterparty sequential smart contracts, whereas the implementation may be of any logic flow of interaction between any required number of parties, through any required number of participating inputs and outputs of transaction (even though the example provided in the disclosure was minimal-atomic swap of two parties only). While the unknown in advance counterparty sequential smart contracts may be of a (fully or partially) persistent or non-persistent types in the same manner, while the non-persistent type in turn may be fully or partially script-hash based.

Considering the nature of separate per-transaction-input contexts of UTXOs scripts executions, certain methods disclosed herein provide maximum scalability of a number of sequential/persistent interactions verifications as a function of a number of transaction inputs (participating in those interactions) for any form of induction of sequential interactions-linear, funnel-shaped, full-DAG.

The full-fledged smart contract method described herein, if combined with systems working on constant arithmetic circuits (as AIR or rv32im circuit of the “RISC Zero” zkVM) with a short smart-contracts identifiers (as Image-ID, in case of RISC-Zero), may constitute a basis for a whole smart-contracts-based industry, where the smart contracts consistency allows:
1. wallets, blockchain browsers, (D) apps etc. have a ‘common language’ used to interact with each other
2. specific smart contracts (or their parts), that their wide common usage turn them into accepted “standard”, to be grouped into a single (or several) newly defined opcode/s (by UTXO blockchains which policy allows it)
3. development of hardware FPGA/ASIC accelerations for such a common widely accepted standard scripts (which are sets of commands/opcodes);

The disclosed method/technique is independent of any specific signing/verification algorithm such as ECDSA, and could use any other algorithm e.g. Schnorr, as BTC blockchain currently does (see BIP 340).

Also, the method may use any of sighash preimage variations-legacy, optimized or any other. The lack of inclusion of value/amount from spent UTXO may be easily implemented in the way described above in the document.

The method is not limited to any specific sequential (of persisting or non-persisting type) interactions use-case, but rather may realize any required initial and/or step (subsequent) induction features.

The method is not limited to SHA256 or any other specific hash function and may be applicable to any existing hash function as long as it is collision-resistant (the probability of collision is low enough in order to make, in a practically feasible manner, an attack of forging hash result). Even though SHA256 is naturally used in the examples for being the hash function used in the very first blockchain of Bitcoin by Satoshi Nakomoto.

Optimization: Due to parallel-ability of FRI-based (hashing-based) PCS proofs (as it's based on multiple separate queries) it may be used for transaction size optimization through dispersing queries over transaction inputs (when each input's corresponding script execution determines the sample points of group of queries it must verify by running, corresponding to its location in transaction, number of iterations in Fiat-Shamir order of chain of randomness generation over initial source of entropy). Furthermore, UTXO blockchain scripts (constituting smart-contracts) inherently include possibility of usage of hashing opcodes suiting naturally implementations of hashing-based commitment schemes.

Note, for some modified UXTO-based blockchain models, the script being executed may partially constitute part of unlocking script spending that UTXO (e.g. P2SH, P2WSH, P2TR of BTC modified UTXO blockchain model). Even though the disclosed methods of providing full-fledged smart contracts was described through the course of the document with relation to original model where executable script code resides only in locking script of an output (and parameters being passed to its execution through unlocking script), it may trivially be adjusted to this modification.

The disclosed concept/method of full-fledged smart contracts may be natively used for any of existing UTXO-based blockchains/cryptocurrencies, e.g. BTC, BCH, ZCash, BSV, Dogecoin, Litecoin, Cardano, LTC, Dodge, namely, without any requirement of their base-protocol redesign/modifications.

### Alternatives and Modifications:

Various possible modifications will be apparent to those skilled in the art. In this regard, It will be understood that the present invention has been described above purely by way of example, and modifications of detail can be made within the scope of the invention. Furthermore, Reference numerals appearing in the claims are by way of illustration only and shall have no limiting effect on the scope of the claims.

### Code Examples

Below are provided the code examples that have been referred to in the description above.

### Code Example 1

In-script smart-contract implementation example of initial step case of induction:

// double hash pre-preceding TX to get intermediate TXID result
OP_SHA256 OP_SHA256
// contract preceding TX
OP_CAT OP_SWAP OP_CAT
// double hash preceding TX to get final TXID result
OP_SHA256 OP_SHA256
// compare the final TXID to TXID from spent UTXO (available at execution
due to OP_PUSH_TX)
OP_EQUAL

While the above code constitutes the locking script, the structure of corresponding unlocking script passing to it parameters for execution is as following (from highest item on the stack to the lowest):
1) The complete pre-preceding transaction (X₋₁)
2) The first 5 bytes of preceding transaction (X₀), which is version and input-counter fields
3) All the data of preceding transaction (X₀) after first 37 bytes (which are version, input-counter and 32 bytes of TXID from the outpoint field)
4) TXID of preceding transaction (X₀)

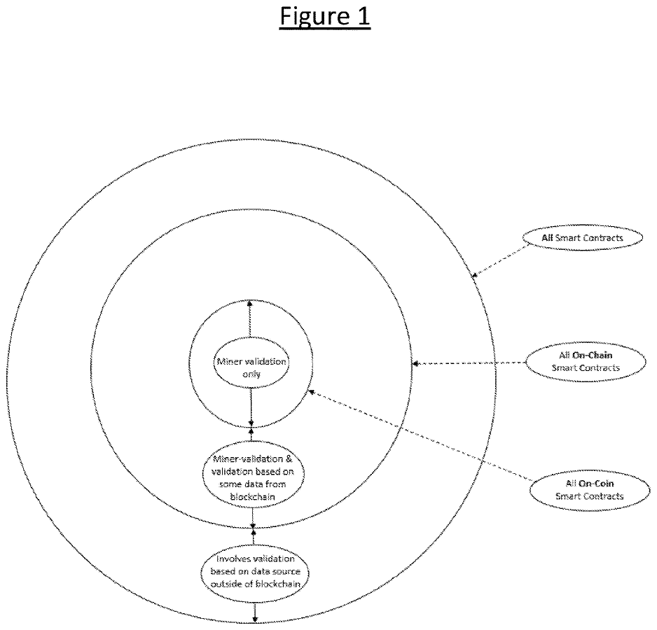

Check FIG. 1 for palpable comprehension.

The first three upper parameters are passed as they are in unlocking script of spending transaction input, while the last was parsed/extracted (during script execution) from sighash preimage (which was passed to unlocking script too) after OP_PUSH_TX validation of authenticity of its fields.

In general, if the second parameter (of 5 bytes) has a constant value (e.g. 0100000001; constant for a single input only enforced transaction form and constant version value of 01000000 LE) it may be hardcoded in locking script instead of passing it each time in unlocking one. Even though it would be in effective, since instead of passing the parameter only when it's needed—at the very first spending after genesis, it would be carried by the persisting script along all the chain of transaction events, always increasing the size of the persisting locking scripts involved.

Note, Bitcoin scripting language version in this example uses OP_SPLIT opcode, while other versions use OP_SUBSTR, OP_LEFT, and OP_RIGHT opcodes instead.

### Code Example 2

```
// P2PKH with addition of 'OP_VERIFY' - ownership relay by address (hash of public key)
  OP_DUP OP_HASH160 2f2ec98dfa6429a028536a6c9451f702daa3a333 OP_EQUALVERIFY
OP_CHECKSIG OP_VERIFY
// keep a copy of sighash preimage for parsing, after it will be validated through OP_PUSH_TX
  OP_DUP
// OP_PUSH_TX validation of sighash preimage fields
  OP_HASH256 OP_16 OP_SPLIT OP_15 OP_SPLIT OP_SWAP OP_14 OP_SPLIT OP_SWAP
  OP_13 OP_SPLIT OP_SWAP OP_12 OP_SPLIT OP_SWAP OP_11 OP_SPLIT OP_SWAP
  OP_10 OP_SPLIT OP_SWAP OP_9 OP_SPLIT OP_SWAP OP_8 OP_SPLIT OP_SWAP OP_7
  OP_SPLIT OP_SWAP OP_6 OP_SPLIT OP_SWAP OP_5 OP_SPLIT OP_SWAP OP_4
  OP_SPLIT OP_SWAP OP_3 OP_SPLIT OP_SWAP OP_2 OP_SPLIT OP_SWAP OP_1
  OP_SPLIT OP_SWAP OP_CAT OP_CAT OP_CAT OP_CAT OP_CAT OP_CAT OP_CAT
  OP_CAT OP_CAT OP_CAT OP_CAT OP_CAT OP_CAT OP_CAT OP_CAT OP_SWAP OP_15
  OP_SPLIT OP_SWAP OP_14 OP_SPLIT OP_SWAP OP_13 OP_SPLIT OP_SWAP OP_12
  OP_SPLIT OP_SWAP OP_11 OP_SPLIT OP_SWAP OP_10 OP_SPLIT OP_SWAP OP_9
  OP_SPLIT OP_SWAP OP_8 OP_SPLIT OP_SWAP OP_7 OP_SPLIT OP_SWAP OP_6
  OP_SPLIT OP_SWAP OP_5 OP_SPLIT OP_SWAP OP_4 OP_SPLIT OP_SWAP OP_3
  OP_SPLIT OP_SWAP OP_2 OP_SPLIT OP_SWAP OP_1 OP_SPLIT OP_SWAP OP_CAT
  OP_CATOP_CAT OP_CAT OP_CAT OP_CAT OP_CAT OP_CAT OP_CAT OP_CAT OP_CAT
  OP_CATOP_CATOP_CATOP_CATOP_CAT 1F OP_SPLIT OP_TUCK OP_CAT 00 OP_CAT
  OP_BIN2NUM 414136D08C5ED2BF3BA048AFE6DCAEBAFE 00 OP_15 OP_NUM2BIN
  OP_INVERT OP_CAT 00 OP_CAT OP_DUP OP_2 OP_DIV OP_ROT OP_3 OP_ROLL
  OP_DUP ff OP_EQUAL OP_SWAP 00 OP_EQUAL OP_BOOLOR OP_TUCK OP_NOTIF
  OP_1ADD OP_ELSE OP_2 OP_PICK OP_ADD OP_ENDIF OP_3 OP_ROLL OP_TUCK
  OP_MOD OP_DUP OP_4 OP_ROLL OP_GREATERTHAN OP_IF OP_SUB OP_ELSE OP_NIP
  OP_ENDIF
  3044022079BE667EF9DCBBAC55A06295CE870B07029BFCDB2DCE28D959F2815B16F8179
  80220 OP_SWAP OP_16 OP_SPLIT OP_15 OP_SPLIT OP_SWAP OP_14 OP_SPLIT
  OP_SWAP OP_13 OP_SPLIT OP_SWAP OP_12 OP_SPLIT OP_SWAP OP_11 OP_SPLIT
  OP_SWAP OP_10 OP_SPLIT OP_SWAP OP_9 OP_SPLIT OP_SWAP OP_8 OP_SPLIT
  OP_SWAP OP_7 OP_SPLIT OP_SWAP OP_6 OP_SPLIT OP_SWAP OP_5 OP_SPLIT
  OP_SWAP OP_4 OP_SPLIT OP_SWAP OP_3 OP_SPLIT OP_SWAP OP_2 OP_SPLIT
  OP_SWAP OP_1 OP_SPLIT OP_SWAP OP_CAT OP_CAT OP_CAT OP_CAT OP_CAT
  OP_CAT OP_CATOP_CAT OP_CAT OP_CAT OP_CAT OP_CAT OP_CAT OP_CAT OP_CAT
  OP_SWAP OP_15 OP_SPLIT OP_SWAP OP_14 OP_SPLIT OP_SWAP OP_13 OP_SPLIT
  OP_SWAP OP_12 OP_SPLIT OP_SWAP OP_11 OP_SPLIT OP_SWAP OP_10 OP_SPLIT
  OP_SWAP OP_9 OP_SPLIT OP_SWAP OP_8 OP_SPLIT OP_SWAP OP_7 OP_SPLIT
  OP_SWAP OP_6 OP_SPLIT OP_SWAP OP_5 OP_SPLIT OP_SWAP OP_4 OP_SPLIT
  OP_SWAP OP_3 OP_SPLIT OP_SWAP OP_2 OP_SPLIT OP_SWAP OP_1 OP_SPLIT
  OP_SWAP OP_CAT OP_CAT OP_CAT OP_CAT OP_CAT OP_CAT OP_CAT OP_CAT
  OP_CAT OP_CAT OP_CAT OP_CAT OP_CAT OP_CAT OP_CAT OP_CAT OP_CAT 41
  OP_CAT OP_SWAP OP_NOTIF
  038ff83d8cf12121491609c4939dc11c4aa35503508fe432dc5a5c 1905608b9218 OP_ELSE
  023635954789a02e39fb7e54440b6f528d53efd65635ddad7f3c4085f97fdbdc48 OP_ENDIF
  OP_CHECKSIGVERIFY
// Parse sighash preimage (get here only if OP_PUSH_TX validation succeeded)
  // cut the version, hashPrevouts, hashSequence and outpoint - total “4+32+32+36”=104 (0x68)
bytes
68 OP_SPLIT OP_NIP
  // read VarInt (1 byte prefix, then following 2 or 4 bytes pushdata ‘length’)
  // We know the script size is bigger than 0xfc, so its VarInt's highest bit is always up (either 0xfd
or 0xfe).
  // We ingnore 0xff VarInt as it's for too big scripts (upto ¬4GB) and not practical at the moment
anyway.
  OP_1 OP_SPLIT OP_OVER 00 OP_CAT FD00 OP_GREATERTHAN OP_IF OP_4 OP_ELSE
OP_2 OP_ENDIF OP_SPLIT
  // read the script
  // in the ranges [32768 - 65535] AND [2,147,483,648 - 4,294,967,295] data size¬s highest bit is
up,
  // to keep it positive addition of ‘00 OP_CAT OP_BIN2NUM’ is needed.
  OP_OVER 00 OP_CAT OP_BIN2NUM OP_SPLIT
  // stick VarInt's prefix with its value and cut part of P2PKH sub-template (23 bytes) from the script
  OP_2SWAP OP_CAT OP_ROT 17 OP_SPLIT OP_NIP OP_ROT
  // save the redemption address (0x1702 Little-Endian, is 535 bytes offset)
  // offset from after first 23 bytes of the script (which include P2PKH address),
  // upto redemption address (20 bytes), therefore: 578-23-20=535 bytes
  OP_SWAP OP_DUP 1702 OP_SPLIT OP_NIP 14 OP_SPLIT OP_DROP OP_ROT
  // read ‘value’ (amount)
  OP_8 OP_SPLIT
  // cut/delete nSequence, read hashOutputs, delete the rest of sighash preimage
  OP_4 OP_SPLIT OP_NIP 20 OP_SPLIT OP_DROP
// Construct amount+varint+‘locking-script’ for the single output
  // put the amount on top, and put output address.
  OP_SWAP OP_5 OP_ROLL
  // is newly created output address equal to a redemption address? (redemption address doesn't
exist from here and on)
  OP_DUP OP_4 OP_ROLL OP_EQUAL
  OP_NOTIF
    OP_4 OP_PICK 76a914 OP_CAT OP_SWAP OP_4 OP_PICK // construct identical
persisting with the new address
  OP_ELSE
    1976a914 OP_SWAP 88ac // construct P2PKH with the address
  OP_ENDIF
  OP_CAT // stick the last part of the locking script with address
  OP_CAT // stick the result with the first part of the script (including VarInt)
  OP_CAT // stick output amount with constructed locking script
  // validate the only output script and its amount correctness (through hashOutputs field of sighash
preimage)
  OP_HASH256 OP_EQUAL
// clean the stack
  OP_NIP OP_NIP
// constant data fields (after OP_RETURN command) - redemption address (20 bytes)
  OP_RETURN 22ed5442ab151b32db1b583d 435879d84af 33977
```

While the above code constitutes the locking script, the structure of corresponding unlocking script passing to it parameters for execution is as following (from highest item on the stack to the lowest):
1. Public key (for unlocking P2PKH part of UTXO)
2. Signature (for unlocking P2PKH part of UTXO)
3. Sighash preimage (for OP_PUSH_TX)
4. Raw address for the newly created output by the spending transaction

Note, Bitcoin scripting language version in this example uses OP_SPLIT opcode, while other versions use OP_SUBSTR, OP_LEFT, and OP_RIGHT opcodes instead.

1. A method of implementing a full-fledged smart contact on unspent transaction output, UTXO, based blockchains, the method relying on a combination of mathematical induction with Succinct Non-interactive Argument of Knowledge, SNARKs, and/or Scalable Transparent Argument of Knowledge, STARK, technology.

2. The method of claim 1, wherein the induction is of a linear, funnel-shaped, or full-DAG shape/form.

3. The method of any preceding claim, comprising implementing sequential interactions of smart contracts of any sequence length and in all possible directions and in all possible combinations of directions.

4. The method of any preceding claim, wherein the smart contract is on-coin.

5. The method of any preceding claim, wherein the sequential interactions are of a persistent type, preferably a fully persistent type.

6. The method of any preceding claim, wherein the sequential interactions are of a non-persistent type.

7. The method of any preceding claim, comprising providing constant verifier code through using a constant arithmetic circuits, such as “Algebraic Intermediate Representation” (AIR) type of arithmetizaion or more complex zero-knowledge virtual machine, ZK-VM, to create a plurality of smart contracts and/or verification scripts of a common form/format.

8. The method of any preceding claim, wherein the full-fledged smart contracts (or their parts) can be grouped into a single (or several) newly defined opcode/s.

9. The method of any preceding claim, comprising issuing the smart contract and/or initiating the smart contract.

10. The method of any preceding claim, wherein the smart contract is associated with a token.

11. The method of claim 10, wherein the token comprises a fungible token.

12. The method of any preceding claim, wherein the usage of SNARK/STARK techniques with mathematical induction allows to avoid the unnecessary implementation complexity and computational overheard of any SNARK/STARK IVC techniques (recursion, folding or any other).

13. The method of any preceding claim, wherein the method comprises implementing a backward persisting smart contract.

14. The method of any preceding claim, wherein the SNARK/STARK techniques use a polynomial commitment scheme, PCS, that is hashing-based, e.g. wherein the techniques use FRI and/or DEEP-FRI technology.

15. The method of any preceding claim, wherein the smart contract(s) are associated with a termination condition.

16. The method of any preceding claim, wherein the smart contracts have a compounding ability with vertical features.

17. The method of any preceding claim, wherein the smart contract enable interaction between unknown in advance smart contracts and/or enable atomic swaps.

18. The method of any preceding claim, wherein the smart contract is a part of a locking script and/or an unlocking script.

19. The method of any preceding claim, comprising using a signing and/or verifying algorithm, preferably an elliptic curve digital signature algorithm, ECDSA, and/or a Schnorr algorithm.

20. The method of any preceding claim, comprising using a hashing algorithm, preferably a SHA256 algorithm.

21. The method of any preceding claim, wherein the smart contract enables wallets, blockchain browsers, (D) apps etc. to have a ‘common language’ used to interact with each other.

22. The method of any preceding claim, wherein the method enables development of hardware FPGA/ASIC accelerations for common widely accepted standard scripts (which are sets of commands/opcodes).

23. The method of any preceding claim, comprising validating a transaction comprising the smart contract.

24. A method of providing constant verifier code through using a constant arithmetic circuits, such as “Algebraic Intermediate Representation” (AIR) type of arithmetizaion or more complex zero-knowledge virtual machine, ZK-VM, to create a plurality of smart contracts and/or verification scripts of a common form/format.

25. An unspent transaction output, UTXO, based blockchain comprising a full-fledged smart contact, the issuing, validating, and/or spending of the smart contract relying on a combination of mathematical induction with Succinct Non-interactive Argument of Knowledge, SNARK, and/or Scalable Transparent Argument of Knowledge, STARK, technology.

26. An apparatus arranged to view, access, and/or store the blockchain of claim 25.
